(19) United States
(12) Patent Application Publication
(10) Pub. No.: US 2026/0160118 A1
(43) Pub. Date: Jun. 11, 2026

(54) VIG UNIT PRODUCTION COMPRISING USE OF A DISPENSER COMPRISING A COLLECTION SHEET

(71) Applicant: VKR Holding A/S, Hørsholm (DK)

(72) Inventors: Simon Johnsen, Hørsholm (DK); Henrik Aslak Jensen, Hørsholm (DK)

(21) Appl. No.: 19/122,836

(22) PCT Filed: Oct. 6, 2023
(86) PCT No.: PCT/EP2023/077728

§ 371 Date: Apr. 21, 2025

(30) Foreign Application Priority Data
Oct. 19, 2022 (EP) 22202420.0
Oct. 19, 2022 (EP) 22202423.4
Oct. 19, 2022 (EP) 22202427.5
Oct. 19, 2022 (EP) 22202431.7
Feb. 27, 2023 (EP) 23158700.7

(51) Int. Cl. E06B 3/673; E06B 3/66; E06B 3/663; E06B 3/677

(52) U.S. Cl. CPC E06B 3/67326; E06B 3/6612; E06B 3/66304; E06B 3/6775

(57) ABSTRACT

The present disclosure relates to a method of manufacturing a vacuum insulating glass unit (VIG). A plurality of spacers (2) are dispensed on a major surface (3a) a first glass sheet (3) by means of a dispenser (10) of a spacer dispensing system (200). The dispenser (10) comprises a housing (12) comprising a guidance space (13) placed opposite to an upper part (12a) of the housing (12) and a bottom part (12b) of the housing (12), a spacer outlet (16) arranged at the bottom part (12b) of the housing (12), and a collection sheet (15). The collection sheet (15) comprises at least one collection hole (15a) extending between opposing major surfaces (15b, 15c) of the collection sheet (15). The collection sheet (15) is arranged in the guidance space (13). Therein the method moreover comprises the steps of: providing a relative rotational movement between the collection sheet (15) and the housing (12) around a rotation axis (RAX) by means of a drive motor (18) so that the collection hole (15a) collects a spacer (2) from a spacer supply, and providing a further, relative rotational movement between the collection sheet (15) and the housing (12) around the rotation axis (RAX) to align the collected spacer (2) in the collection hole (15a) opposite to the spacer outlet (16) to deliver the collected spacer (2) to the spacer outlet (16) and towards the surface (3a) of the glass sheet (3). Each of the plurality of spacers (2) in the spacer storage compartment (11) may have a spacer height (H 1) extending between the contact surfaces (2a, 2b). Each of said spacers (2) may have a spacer width (W1), wherein the guidance space (13) has a height (H2) which is less than 1.4 times the spacer height (H1). The height (H2) of the guidance space (13) may be smaller than the spacer width (W1).

The present disclosure relates to a method of manufacturing a vacuum insulating glass unit, and to use of a dispenser for dispensing spacers.

### BACKGROUND

Vacuum insulating glass (VIG) units are generally known to provide an insulating glass unit with desirable features such as a space saving unit with good heat insulating capabilities. Such VIG units may comprise spacers distributed in an evacuated gap between two glass sheets of the VIG unit. These spacers may be very small, such as below 0.5 mm in height. This may result in issues when providing automation equipment such as a spacer dispensing solution, since a spacer dispensing solution for use in larger scale VIG unit manufacturing should preferably be both reliable and robust. Moreover it should also preferably be fast.

Different spacer dispensing solutions in VIG unit manufacturing have been disclosed. For example, WO2019218901 discloses a dispenser solution for spacers for VIG units where a vibration arrangement may line up and convey the spacers. WO21208628 discloses a solution for separating spacers for VIG units. A vibrator is used and a separation chamber component is arranged obliquely to the horizontal plane. Other types of spacer dispensing solutions comprises a radial drum solution as disclosed in CN 205258287U, where a radial drum having a horizontal rotation axis collects spacers from a spacer storage and the drum is rotated around the horizontal axis so the collected spacers are delivered. U.S. Pat No. 11,396,477 discloses a solution where spacers are arranged stacked in a spacer column of a magazine, and pushed horizontally to leave the magazine from the bottom of the magazine to the glass sheet surface. CN106045286 discloses a further VIG unit spacer dispensing solution comprising a reciprocating collection member, or a rotating collection member with a collection opening for receiving a spacer.

The above solutions may suffer from different drawbacks such as being mechanically complex, risk inaccurate spacer placement, may be less reliable, may be space consuming and/or the like. The present disclosure provides a solution that may e.g. help to reduce or avoid one or more of the above mentioned drawbacks.

### SUMMARY

The present disclosure relates to a method of manufacturing a vacuum insulating glass unit. The method comprises providing a first glass sheet, and dispensing spacers comprising predefined, pre-shaped contact surfaces on a major surface of the provided glass sheet by means of a dispenser of a spacer dispensing system. The dispenser comprises: a spacer storage compartment, comprising a plurality of said spacers, a housing comprising a guidance space placed between a first housing surface of an upper part of the housing and a second housing surface of a bottom part of the housing. The dispenser moreover comprises a spacer outlet arranged at the bottom part of the housing. The dispenser additionally comprises a collection sheet providing a bottom part of the spacer storage compartment, wherein the collection sheet comprises at least one collection hole extending between opposing major surfaces of the collection sheet. The collection hole is a through hole and the collection sheet is arranged in the guidance space. The dispensing of spacers comprises:
providing a relative rotational movement between the collection sheet and the housing around a rotation axis by means of a drive motor so that the collection hole is arranged at the bottom of the spacer storage compartment and thereby collects a spacer from the bottom of the spacer storage compartment, and
providing a further, relative rotational movement between the collection sheet and the housing around the rotation axis to align the collected spacer in the collection hole opposite to the spacer outlet to deliver the collected spacer to the spacer outlet and towards the major surface of the glass sheet.

Each of the plurality of spacers in the spacer storage compartment has a spacer height extending between the contact surfaces, and each of said spacers has a spacer width. The guidance space may in some embodiments of the present disclosure have a height which is less than 1.4 times the spacer height. Additionally or alternatively, the height of the guidance space may in some embodiments of the present disclosure be smaller than the spacer width. The method further comprises providing a second glass sheet, and sealing together the first glass sheet and the provided second glass sheet at the periphery of the glass sheets with the plurality of dispensed spacers arranged between major surfaces of the glass sheets so that a gap is provided between the first and second glass sheets. The method also comprises evacuating the gap.

This may e.g. provide a solution where a more consistent result of selecting spacers one by one and having the desired orientation is obtained.

When the guidance space height is less than 1.4 times the spacer height, this may e.g. help to reduce the likelihood of a spacer clogging the dispenser and/or prevent spacer damage and/or dispenser damage when collecting spacers from the spacer storage.

Additionally or alternatively, since the height of the guidance space is smaller than the spacer width, it may be assured that a spacer is collected with a desired orientation such as so that a collected spacer is arranged with one of the contact surfaces to support on a support surface, such as a surface of the housing, while the collection hole is moved towards the spacer outlet or the spacer outlet is moved towards the collection hole to have the collected spacer dispensed. This may e.g. help to reduce the likelihood of the spacer misplacing upon dispensing, such as dropping, it towards the glass sheet surface.

An edge or surface of the housing proximate the guidance space may due to the said guidance space height retain/detain spacers in the spacer storage compartment so that only one spacer at the time is allowed to enter into the guidance space, and that spacer is the spacer collected in the collection hole.

In one or more embodiments of the present disclosure, the relative rotational movement between the collection sheet and the housing may be provided by keeping the housing un-rotating/stationary (with respect to at least rotation) and rotating the collection sheet, such as by means of a shaft and the motor. In other embodiments of the present disclosure, the relative rotational movement between the collection sheet and the housing may be provided by keeping the collection sheet un-rotating/stationary (with respect to at least rotation) and instead rotate the housing and hence the spacer outlet.

The rotation axis may in embodiments of the present disclosure extend substantially vertical, such as differ less than 10°, such as less than 5°, such as less than 1° from vertical, or may be fully vertically extending.

The planes comprising the respective major surfaces of the collection sheet may be perpendicular to the rotation axis.

The said height (less than 1.4 times the spacer height) of the guidance space may be a minimum height such as a substantially constant height. In some embodiments, the said height may be obtained by an edge or wall part abutting the spacer storage compartment.

The evacuation of the gap may in embodiments of the present disclosure be provided by means of one or more one or more of: a vacuum chamber, such as a vacuum chamber containing the entire VIG unit assembly therein, one or more vacuum pumps in communication with the gap, for example by means of a suction cup, a getter arranged in the gap and/or the like.

The sealing together of the first and second glass sheets may comprise use of an edge seal material such as a solder glass edge seal or a solder metal edge seal, or it may comprise fusing the glass sheets directly together. In some embodiments, the sealing may comprise heating at least the edge seal, or the entire VIG unit assembly to a desired temperature.

The spacer storage contains bulk spacers and the dispensing system may need very swift and reliable feeding since one VIG may contain for example between 500 and 3000 spacers dependent on glass sheet surface area, spacer distance and/or the like. Industrial scale VIG production may require excellent spacer feeding and placement with low or virtually eliminated stops or errors.

The predefined, pre-shaped contact surfaces are shaped so that when the dispenser dispenses the spacer, the spacer will generally land on the glass sheet surface and support on one of the first and second contact surface.

In some embodiments, one or both contact surfaces may be substantially flat such as substantially plane.

In one or more embodiments of the present disclosure, the spacer may comprise a first side surface and a second opposite side surface when seen in a cross section of the spacer, where said convex side surfaces extends between the predefined, pre-shaped contact surfaces. The side surface extending around the spacer between the contact surfaces hence extends between facing, opposite major surfaces in the VIG unit.

In one or more embodiments of the present disclosure, one of the contact surfaces of the collected spacer may supports on and slides on a surface of the dispenser in the guidance space during the further rotational movement. This surface may in embodiments be the second housing surface.

This may e.g. provide a reliable and mechanically simple solution.

The surface on which the collected spacer may support and slides may in embodiments of the present disclosure be an integrated, upwardly facing surface of the bottom part. This may e.g. provide a mechanically simple solution. Alternatively, it may e.g. be another surface of the dispenser, such as of the dispenser housing, for example a sacrifice member that may be replaced in the housing.

It is understood that the housing may help to ensure that the dispenser, the collection sheet and/or spacers are not contaminated or that contamination is reduced. Even dust or dirt may cause malfunction or reduce reliability of the dispenser if entering into the spacer.

In some embodiments of the present disclosure, the dispenser and its housing, with regard to having foreign objects entering into the guidance space, may at least comply with an IP5X rating, or even IP6X rating, according to for example the international standard IEC 60529. Hence, the collection hole may be the intended means for objects to enter the guidance space.

In one or more embodiments of the present disclosure, the collection sheet may comprise an upwardly facing first major surface and a downwardly facing, oppositely directed second major surface, wherein the second housing surface covers at least 90%, such as at least 98% of the surface area of the second major surface (15c). Additionally or alternatively, in one or more embodiments of the present disclosure, the first housing surface may cover at least 40%, such as at least 60%, such as at least of the surface area of the first major surface of the collection sheet.

This may help to improve reliability and/or provide advantages with respect to providing protection of the collection sheet and/or providing proper guidance of the collection sheet.

Additionally or alternatively, if the first housing surface covers at least 40%, such as at least 60%, such as at least 75% of the surface area of the first major surface of the collection sheet, this may provide more space and material for holding various equipment such as one or more of monitoring equipment, spacer movement means such as vacuum channel, pressurized air outlet for discharging the collected spacer into the spacer outlet, one or more monitoring sensors and/or the like.

In one or more embodiments of the present disclosure, the spacers in the spacer storage compartment are randomly intermixed and/or randomly orientated. This may be provided by loading, pouring or the like the spacers into the storage compartment.

This may enable fast and/or easy supply of spacers in the spacer storage compartment.

When the collection hole enter through the bottom of the spacer storage, this movement may help to provide that one of the randomly intermixed and randomly orientated spacers enters into the collection hole, e.g. by means of one or more of the relative movement between the housing and the collection sheet, by means of gravity, by means of vibrations provided by a vibrator vibrating the housing and/or the collection sheet, by means of a vacuum path/duct and/or the like.

In one or more embodiments of the present disclosure, the collection sheet has an outer maximum disc diameter, and wherein the housing has a width, such as a diameter, that is larger than the disc diameter.

This may in embodiments of the present disclosure provide a solution where more space and material may be provided for holding various equipment such as one or more of monitoring equipment, spacer movement means such as vacuum channel/path, pressurized air outlet for blowing the collected spacer into the spacer outlet, one or more monitoring sensors and/or the like.

In one or more embodiments of the present disclosure, the housing encloses at least 80% such as at least 95% of the outer boundary, such as an outer periphery, of the collection sheet. In certain embodiments, the housing may fully enclose the outer boundary of the collection sheet. This may be provided by means of a wall part, such as an annular wall part, arranged opposite to the outer boundary, such as outer periphery, of the collection sheet. This may e.g. provide a more resistant dispenser and/or provide a more dust proof dispenser.

The wall part may in further embodiments of the present disclosure e.g. be provided by, such as integrated in/unitary with, the bottom part of the housing. Alternatively, the wall part may be provided by, such as integrated in/unitary with, the upper part of the housing.

In one or more embodiments of the present disclosure, the dispenser housing has a maximum width, such as a maximum outer diameter, that is 50 mm or less, such as 40 mm or less, for example 30 mm or less.

This enables providing a dispensing system comprising several of said dispensers aligned close together, such as in a pattern, such as a substantially straight line, with a distance that enables dispensing adjacent spacers on the glass surface with a distance that is less than 50 mm, such as less 40 mm. Dependent on the used glass sheet type, the mutual distance between the spacers may vary. Annealed, unhardened glass sheets for VIG units may require spacers arranged closer together, whereas hardened, such as thermally tempered glass sheets for VIG units may enable providing a larger spacer distance/pitch distance. For the latter, (thermally tempered glass sheets) the spacer distance may be allowed to be above e.g. 30 mm or above 40 mm, depending on the glass sheet thickness of the hardened/tempered glass sheet.

In one or more embodiments of the present disclosure, the dispenser comprises a vacuum path, such as one or more vacuum channels, connected to a vacuum pump. The vacuum pump provides suction in the vacuum path so as to help a spacer of the spacer storage compartment to enter into the collection hole.

This vacuum path/duct may help to increase the spacer dispensing success rate and reduce the number of times where a spacer is not collected from the storage as intended and/or it may help to enable increasing the manufacturing speed of glass sheets with a full set of spacers as the reliability of the dispenser may be improved.

In one or more embodiments of the present disclosure, the collection sheet may comprise a part of the vacuum path integrated therein, such as a channel extending from the collection hole and towards the periphery of the collection sheet.

In one or more embodiments of the present disclosure, the housing may comprise a vacuum space, such as a vacuum channel, arranged opposite to a major surface of the collection sheet, wherein the vacuum space provide a suction at the collection hole when the collection hole is arranged at the bottom of the spacer storage compartment to collect a spacer from the bottom of the spacer storage compartment.

In one or more embodiments of the present disclosure, the housing comprises a part of the vacuum path, such as a recessed channel, such as an elongated, curving channel, arranged to abut the guidance space to provide a fluid communication between the collection hole of the collection sheet and a suction outlet of the housing connected to the vacuum pump when the collection hole is arranged at the bottom of the spacer storage compartment to collect a spacer from the bottom of the spacer storage compartment.

In one or more embodiments of the present disclosure, a part of the vacuum path is arranged in the upper part and/or at the bottom part of the housing.

In one or more embodiments of the present disclosure, the housing may comprise a part of the vacuum path, such as a recessed channel, providing a fluid connection between a channel or the like of the collection sheet and a suction outlet of the housing when the collection hole is arranged at the bottom of the spacer storage compartment and to collect a spacer from the bottom of the spacer storage compartment.

It is understood that in some embodiments of the present disclosure, the vacuum path may be designed so that when the collection hole is not arranged at the bottom of the spacer storage compartment, but e.g. is arranged in the guidance space opposite the spacer outlet or in the guidance space between opposing surfaces of the bottom part of the housing and the upper part, the vacuum/suction in the collection hole may be reduced or omitted.

In one or more embodiments of the present disclosure, the vacuum path may comprise an elongated, curved vacuum channel extending around the rotation axis, such as at least 45° around the rotation axis, for example at least 80° around the rotation axis. In one or more embodiments of the present disclosure, the vacuum path comprises an elongated, curved vacuum channel extending less than 270° around the rotation axis, such as less than 190° around the rotation axis.

In one or more embodiments of the present disclosure, the dispenser may comprise a sensor system comprising one or more sensors, such as one or more optical sensors, configured to detect if a collected spacer is present in the collection hole, and wherein the sensor system provides one or more sensor outputs comprising information of if a collected spacer is present in the collection hole.

This may e.g. enable detecting if a spacer has been collected in the collection hole, and/or enable detecting if a collected spacer has left/been unloaded through the spacer outlet of the dispenser and towards the glass sheet surface.

In one or more embodiments of the present disclosure, the sensor system may comprise a spacer sensor, such as an optical sensor, wherein the spacer sensor detects if a collected spacer is present in the collection hole, such as prior to the collection hole being arranged opposite to the spacer outlet, for example during the further rotational movement, and wherein the spacer sensor provides a sensor output comprising information of if a collected spacer is present in the collection hole.

In one or more embodiments of the present disclosure, the sensor system may comprise an unloading sensor, such as an optical sensor, wherein the unloading sensor detects if a collected spacer is present in the collection hole, such as subsequent to the collection hole being arranged opposite to the spacer outlet, and wherein the unloading sensor provides a sensor output comprising information of if a collected spacer is present in the collection hole.

In one or more embodiments of the present disclosure, output from the sensor system may be used by a counter for counting the number of spacers dispensed by the dispenser.

In one or more embodiments of the present disclosure, the sensor or sensors of the sensor system is/are arranged in and/or supported in the upper part, such as in a bore or channel arranged opposite to a major surface of the collection sheet facing away from the spacer outlet.

In one or more embodiments of the present disclosure, wherein a data processing arrangement determines whether a spacer has been collected from the spacer storage compartment and/or has been unloaded at the spacer outlet based on the output from the spacer sensor and/or the output from the unloading sensor.

In one or more embodiments of the present disclosure, the spacer height of the spacers in the spacer storage compartment may be less than 0.4 mm, such as less than 0.25 mm, for example 0.2 mm or less.

This spacer height may be desirable as it enables maintaining a desired distance of between opposing surfaces of glass sheets of the VIG unit of less than 0.4 mm, such as less than 0.25 mm, for example 0.2 mm or less when the space/gap between the glass sheets is evacuated.

In one or more embodiments of the present disclosure, the height of the spacers may be between 0.1 mm and 0.4 mm, such as between 0.15 mm and 0.25 mm.

It is generally understood that all spacers in the spacer storage may have substantially the same height.

In one or more embodiments of the present disclosure, the tolerances for/of the spacers 2 in the spacer storage 11 and/or for the distributed spacers may in embodiments of the present disclosure may be ±30 micron, such as ±20 micron, or ±10 micron or less. Dimensions of the spacers may be relevant to ensure the good final thermal performance of the VIG unit. Consequently, the tolerance on spacer dimensions may be important as well.

In one or more embodiments of the present disclosure, the spacer width, such as spacer diameter, is larger, such as substantially larger, than the spacer height.

In some embodiments of the present disclosure, each spacers may be a circular, cylindrical shaped structure, having a height significantly less than its maximum width.

In one or more embodiments of the present disclosure, the maximum width, such as the maximum diameter, of the spacers is at least 2 times larger, such as at least 2.5 times larger than the height of the spacers. In some embodiments of the present disclosure, such as wherein the maximum width, such as the maximum diameter, of the spacers is between 2 times and 5 times, such as between 2 times and 4 times larger than the height of the spacer 2.

In one or more embodiments of the present disclosure, the height of the guidance space may be less than 0.5 mm, such as less than 0.3 mm.

In one or more embodiments of the present disclosure, the height of the guidance space may be less than 1.5 times, such as less than 1.3 times or less than 1.1 times the thickness of the collection sheet.

In one or more embodiments of the present disclosure, the thickness of the collection sheet may be within ±15%, such as within ±10%, such as within ±5% or within ±3% of the spacer height.

In one or more embodiments of the present disclosure, the thickness of the collection sheet may be between 1 and 1.4 times the spacer height, such as between 1 and 1.3 times the spacer height.

In one or more embodiments of the present disclosure, the collection sheet may be disc shaped. This may e.g. provide space optimization and/or help to reduce spaces that may gather contaminants such as dust or unwanted particles.

In one or more embodiments of the present disclosure, the disc shaped collection sheet may comprise/describe an outer circular shape.

In some embodiments, the collection sheet may have another shape than circular, e.g. a polygonal shape, such as a symmetric polygonal shape.

In one or more embodiments of the present disclosure, one or more side wall surfaces enclosing the spacer storage compartment may narrows in a direction towards collection sheet. For example, in some embodiments, the spacer storage compartment may be funnel shaped.

This may e.g. help to provide an increased pressure by gravity on the collection disc, and may hence e.g. help to increase the chance of collecting a spacer in the collection hole.

In one or more embodiments of the present disclosure, the length of the traveling path of the collection hole at the bottom of the spacer storage compartment may be at least 0.9 times, such as at least 1.2 times, such as at least 1.8 times, the distance between the rotation axis and the outer boundary/periphery of the dispenser housing.

This may e.g. enable providing a space saving dispenser with a long traveling path for the collection hole at the spacer storage compartment bottom. This may e.g. enable increasing the chance of a spacer being collected by the collection hole. Additionally or alternatively, it may enable providing a space saving dispenser with a larger spacer storage capacity.

The storage compartment may e.g. in embodiments of the present disclosure contain more than 20000, such as more than 30000, such as more than 40000 spacers, and may hence e.g. enable longer manufacturing time between spacer storage refilling.

In embodiments of the of the present disclosure, the length of the travel/traveling path of the collection hole in the storage bottom 11 may be more than 90° such as more than 140° such as more than 170°.

In one or more embodiments of the present disclosure, the spacer storage compartment may be elongated and extend partly around the rotation axis. For example, in some embodiments, the spacer storage compartment may be arc shaped.

In one or more embodiments of the present disclosure, the spacer storage compartment may be defined/placed between opposing side wall surfaces of the housing. At least a side wall surface enclosing and facing a part of the spacer storage compartment and which is placed proximate the rotation axis may in embodiments of the present disclosure be convexly shaped. For example, at least a part of the convexly shaped side wall surface may be coaxial with the rotation axis.

This may e.g. enable providing a larger dispenser storage.

In one or more embodiments of the present disclosure, the spacer storage compartment may be arranged in, such as integrated in, such as milled into, the upper part.

In one or more embodiments of the present disclosure, the rotational movement around the rotation axis from the spacer storage compartment to align the collected spacer in the collection hole opposite to the spacer outlet may be at least 85°, such as at least at least 120°, for example at least 170°.

The spacer may hence have provide a travel of at least 85°, such as at least at least 120°, for example at least 170° from the spacer storage compartment to the spacer outlet.

This may e.g. provide more room for sensors and/or hoses for pneumatic and/or vacuum or other equipment to be arranged in appropriate location(s) of the dispenser.

In one or more embodiments of the present disclosure, the distance between the glass sheet surface for receiving a collected spacer from the dispenser and the spacer outlet may be less than the spacer height, at least while the spacer is dropped towards the glass sheet surface.

In one or more embodiments of the present disclosure, the collection sheet may be arranged at the lower fourth, such as the lower sixth, such as the lower eighth of the housing, proximate the bottom wall of the housing.

In one or more embodiments of the present disclosure, the distance between the glass sheet surface and the major surface of the collection sheet facing the glass sheet surface may be less than 10 mm, such as less than 3 mm, such as less than 1 mm, at least while the spacer is dropped towards the glass sheet surface.

This may e.g. provide a solution that may be reliable and mechanically simple, and/or provide a solution where improved control of the collected spacer during dispensing may be obtained.

In one or more embodiments of the present disclosure, the dispenser may comprise a fluid outlet for pressurized gas, such as an outlet arranged opposite to the spacer outlet. This pressurized gas may in embodiments be provided in order to obtain a blowing force onto the collected spacer in the collection hole to help the collected spacer leave the collection hole. This may e.g. help to increase the chance that a spacer is dispensed through the spacer outlet from the collection hole.

In one or more embodiments of the present disclosure, the glass sheet comprising the glass sheet surface may be a tempered, such as a thermally tempered, glass sheet.

In some embodiments of the present disclosure, the outlet for the pressurized gas such as air is arranged in the upper part.

The pressurized gas and/or vacuum path may help to increase the chance of successful spacer dispensing.

In one or more embodiments of the present disclosure, the spacer outlet and/or the collection hole may be chamfered.

This may e.g. help to increase the chance of a collected spacer entering through the spacer outlet and/or to increase the chance of spacer collection in the spacer storage.

In one or more embodiments of the present disclosure, a vibrator may be configured to vibrate at least a part of the dispenser, such as the housing and/or the collection sheet.

This may e.g. help to increase the chance of successfully collecting a spacer in the collection hole and/or help to release the collected spacer from the collection hole to the spacer outlet. The vibrator may e.g. comprise a movable, unbalanced mass or another type of controllable vibrator.

In one or more embodiments of the present disclosure, the spacers comprises a side edge surface extending between the contact surfaces, wherein the side edge surface is curved and convexly extending, such as bulging, between the contact surfaces.

Experiments with spacers comprising outwardly curved side edge surfaces in a dispenser of the dispenser type as described in the present disclosure indicated good chance of successful collection of a spacer from the spacer storage of the dispenser. Additionally or alternatively, it may provide advantageous with regards to reducing risk of spacer damage or dispenser malfunction.

In some embodiments, the spacers may comprises a first convex side surface and a second opposite, convex side surface when seen in a cross section of the spacer, where said convex side surfaces extends between the contact surfaces.

Such spacers may e.g. be cost efficient spacers that may have been pre-compressed or in other ways processed from an initial substantially spherical shape which may e.g. provide a cost efficient and/or precise solution.

In one or more embodiments of the present disclosure, the convex side edge surfaces may, when seen in cross section, each describe minor circular arcs having non-coinciding centres.

In one or more embodiments of the present disclosure, the housing of the dispenser may be attached to a dispenser holding part of the dispenser system by means of a locking system, such as quick release locking system. The locking system may in embodiments comprise an actuation member to be operated to actuate the locking system.

This may e.g. enable fast exchange of a defect dispenser and/or enable easy and fast inspection of the dispenser in tight spaces.

The locking system may in some embodiments configured for tool-less mounting and dismounting of the dispenser.

The locking system may in embodiments be a spring loaded locking system.

In one or more embodiments of the present disclosure, the locking system may comprise one or more movable locking parts, such as spring loaded locking parts. This/these locking parts may be configured to be moved between a locking position and an unlocking position. The one or more movable locking parts in the locking position provides an attachment of the housing of the dispenser to the dispenser holding part by engaging an engagement member such as a strike part. The one or more movable locking parts in the unlocking position disengages the engagement member and thereby provides an release of the housing of the dispenser to enable removing the dispenser from the dispenser holding part.

The actuation member may be configured to be displaced, such as pushed and/or rotated, by means of a force, such as by hand or hand held tool, to move the one or more movable locking parts, between the locking position and the unlocking position.

In one or more embodiments of the present disclosure, the quick release locking system comprises three or less fastening parts such as two or less fastening parts or just one fastening part. This may e.g. enable faster dispenser housing release and/or replacement.

In one or more embodiments of the present disclosure, actuation member 64 of the locking system may require a rotation of the actuation member less than 360°, such as less than 180°, for example less than 90° degrees around a rotation axis in order to either lock the dispenser housing in place by means of the locking system, or release the dispenser for e.g. dispenser maintenance, spacer storage filling and/or dispenser replacement.

In one or more embodiments of the present disclosure, the housing of the dispenser may be attached to a dispenser holding part of the dispenser system. The dispenser holding part may in further embodiments be separate to a shaft for rotating the collection sheet or the dispenser housing around the rotation axis.

In one or more embodiments of the present disclosure, said height of the guidance space may at least be provided/present at the entrance for the collection hole from the spacer storage compartment to the guidance space. For example, in some embodiments, the height may be defined between an edge of the housing at said entrance of the collection hole and towards the surface of the collection sheet facing the spacer storage compartment.

In one or more embodiments of the present disclosure, the guidance space height at the collection hole entrance to the guidance space from the spacer storage compartment may be less than 1.4 times the spacer height, and the height of the guidance space at the entrance may be smaller than the spacer width.

In one or more embodiments of the present disclosure, the spacers may be dispensed by the dispenser while the relative humidity of the ambient air surrounding the dispenser is controlled to be above 40%, such as above 50%, for example between 40% and 70%.

The dispenser may perform less good/reliable if the relative humidity is low. Hence, maintaining the relative air humidity of the air around/ambient to the dispenser 10 may reduce issues caused by electrostatic charges.

In one or more embodiments of the present disclosure, said housing and the collection sheet may be made from metal. In one or more embodiments, the dispenser, such as the housing and/or collection sheet, is/are connected to ground by means of a grounding connection.

The inventor has tested an (ungrounded) metal dispenser comprising a disc shaped collection sheet made from a metal, and a housing made from a metal, where the collection sheet was rotated relative to the housing in the guidance space by means of a shaft connected to a motor. The result was that sometimes a spacer was not successfully loaded into the collection hole or unloaded at the spacer outlet. The inventor then provided a grounding connection by galvanic connection to the housing to reduce static electricity, and this increased the spacer dispensing success rate significantly.

Hence, the grounding connection may increase the spacer dispensing success rate significantly thereby reducing the number of times where topping up with spacers at the glass surface is necessary due to an uncollected or un-dispensed spacer from the dispenser and/or it may enable increasing the manufacturing speed of glass sheets with a full set of spacers.

In one or more embodiments of the present disclosure, a charge modulation system reduces and/or maintains a difference in electrostatic charge potential between the glass sheet and the dispensing system, such as between the between the glass sheet and the dispenser to be below 10 kV, such as below 5kV, such as below 2 kV.

Providing a control, such as reduction, of the electrostatic charge potential at the dispenser and glass sheet may e.g. help to reduce issues with dispensing reliability.

In one or more embodiments of the present disclosure, a charge modulation system comprises one or more of:
A grounding connection
One or more ionizer devices, such as one or more ionizer bars providing a flow of ions with controlled polarity towards the dispensing system such as towards the dispenser(s), and/or towards the glass sheet
A humidity control system maintaining the relative humidity of the ambient air surrounding the dispenser (10) above 40%, such as above 50%, for example between 40% and 70%,
   wherein the charge modulation system reduces and/or maintains a difference in electrostatic charge potential between the glass sheet and the dispensing system, such as between the between the glass sheet and the dispenser.

In one or more embodiments of the present disclosure, said predefined, pre-shaped contact surfaces may be flat, such as plane.

Said predefined, pre-shaped contact surfaces are oppositely directed to face and contact a major surface of opposing glass sheets in the gap of the VIG unit.

The spacers to be dispensed may in embodiments of the present disclosure have a shape different from spherical.

In one or more embodiments of the present disclosure, said opposite flat contact surfaces may have a surface shape, such as a surface roughness, that varies less than ±30 micron, such as less than ±10 micron of the spacer height relative to a mean line or mean plane defined by the respective contact surface.

In one or more embodiments of the present disclosure, a displacement motor provides a relative movement between the glass sheet surface and the spacer outlet in a direction along the glass sheet surface.

In one or more embodiments of the present disclosure, the dispensing of spacers may comprise providing a spacer placement sequence to place a plurality of spacers at the major glass sheet surface by means of the dispenser, wherein the spacer placement sequence comprises providing relative movement between the glass sheet surface and the spacer outlet in a direction along the glass sheet surface by means of a displacement motor, and distributing a plurality of spacers from the spacer storage with a mutual spacer distance on the glass sheet surface by means of the dispenser through the spacer outlet.

In one or more embodiments of the present disclosure, a distance controller controls a distance adjustment motor to move the spacer outlet towards and/or away from the glass sheet surface during the spacer placement sequence based on output from a distance sensor.

This provides a solution where improved spacer placement precision and/or consistency of spacer placement may e.g. be obtained. The movement of the spacer outlet towards and/or away from the glass sheet surface based on the distance monitoring during the spacer placement sequence may provide that the distance between the spacer outlet and the part of the glass sheet surface arranged opposite to the outlet is individually adapted for each individual glass sheet one or a plurality of times during the spacer placement sequence. This may e.g. reduce the risk of (or magnitude of) the dispensed spacers bouncing on the glass sheet surface and/or rolling on the glass sheet surface when dispensed by the dispenser to drop onto the glass sheet surface, and hence reduce the risk of spacer misplacement.

Hence, when/if the dispenser is used for consecutively dispensing a group of spacers one at a time at the same glass sheet surface during the spacer placement sequence, individual distance adaption when placing/dispensing each spacer may be provided according to the individual surface topology of the glass sheet surface at the location of the glass sheet surface to receive the spacer.

In one or more embodiments of the present disclosure, distance sensor may comprise an optical sensor, such as a fibre optic sensor, or an ultrasonic sensor.

The distance controller may comprise one or more hardware processors, such as one or more microcontrollers, Field-Programmable Gate Arrays (FPGA), Programmable Logic controllers (PLC), microprocessors and/or the like. For example, the hardware processor may comprise one or more general-purpose hardware processors.

Generally, according to one or more embodiments of the present disclosure, a system controller comprising one or more hardware processors (such as one or more of the above mentioned types) may based on a computer implemented software program and control circuitry control the movement and/or movement speed of the displacement motor and the dispensing of spacers, e.g. in order to time the spacer dispensing and start/stop and/or movement speed of the displacement motor.

In some embodiments of the present disclosure, the distance controller and the system controller may be the same controller or may be provided by means of different hardware controllers, such as distributed hardware controllers.

For example, in some embodiments, the distance adjustment motor, such as a servo motor, may comprise a hardware controller and regulation circuitry, and may handle the distance control based on direct sensor input or sensor input suppled from another hardware controller. Such a controller may e.g. receive distance setting input supplied from e.g. a separate hardware controller.

The spacers may generally be placed one by one, consecutively, at the glass sheet surface by means of the dispenser. A relative movement between the glass sheet surface and the spacer outlet in a direction along the glass sheet surface by means of a displacement motor may be provided between each consecutive placement of a spacer by means of the dispenser.

In one or more embodiments of the present disclosure, the distance sensor may be attached to, such as arranged in, the housing of the dispenser.

In one or more embodiments of the present disclosure, the distance controller controls the distance between the glass sheet surface and the spacer outlet to be less than a spacer height of the spacers, at least while the spacers are delivered to, such as dropped onto, the glass sheet surface by the dispenser.

This enables reducing the risk of too large spacer misplacing during spacer dispensing. A surface, such as a wall surface or an edge/corner, of the dispenser enclosing the dispenser outlet may hence prevent the spacer from rolling, bouncing or the like beyond the outer periphery described by the dispenser opening. Hence it may be assured that the spacer outlet opening size and/or shape may define the maximum limit for a possible spacer movement and displacement of the spacer during dispensing the spacer and until the spacer rests as desired on the glass sheet surface.

The spacer outlet may comprise an outermost outlet surface facing the glass and being proximate the glass (e.g. provided by a dispenser bottom or by a spacer nozzle outlet having an outer diameter that is less than the diameter of a housing of the dispenser), and the distance between the spacer outlet and the glass sheet surface may be defined between that outermost outlet surface and the glass sheet.

In one or more embodiments of the present disclosure the distance controller monitors a distance representative of a distance between the glass sheet surface and the spacer outlet based on the output from the distance sensor and a distance setting during the spacer placement sequence, and controls the distance adjustment motor based thereon during the spacer placement sequence.

In one or more embodiments of the present disclosure, the distance controller provides closed loop distance control, such as by means of one or more of Proportional, Integral and/or derivative control. This may e.g. provide improve precision and/or distance control. In one or more embodiments of the present disclosure, a distance control may be based on one or more distance setting comprising one or more distance set points such as a distance target setting or a distance range setting.

In one or more embodiments of the present disclosure, a spacer dispensing array comprises a plurality of said spacer dispensing system, wherein a distance controller provides an adjustment, such as an individual adjustment, of the spacer outlet of the respective spacer dispensing system of the dispensing array in a direction towards and/or away from the glass sheet surface based on output from a plurality of distance sensors during the spacer placement sequence, such as by moving the dispenser housing towards and/or away from the glass sheet surface.

This may e.g. enable a faster manufacturing of glass sheets comprising a desired, full set of distributed spacers arranged at desired spacer positions at the glass sheet surface. The individual distance adaption provides precise spacer placement across the glass sheet surface, such as in a row, despite possible glass surface variation.

The dispensing array may e.g. enable that a row of spacers at a time may be arranged at the glass sheet surface, and the relative movement between the glass sheet surface and the spacer outlet in a direction along the glass sheet surface by means of a displacement motor is provided in order to provide a plurality of spaced apart rows of spacers. Hence, each distance controller may provide distance adjustment during and/or after a relative movement between the glass sheet surface and the spacer outlet in a direction along the glass sheet surface by means of a displacement motor.

In some embodiments, the individual adaption may be provided on order to adapt to surface variations of the glass sheet surface.

In one or more embodiments of the present disclosure, a spacer dispensing array comprises a plurality of said dispensers, such as a plurality of said spacer dispensing system. This may e.g. help to increase manufacturing speed.

In one or more embodiments of the present disclosure, the spacer outlets of the dispensers of the array may be distributed in a direction transverse to a direction of movement between the glass sheet and the spacer dispensing array along the glass sheet surface provided by a displacement motor along the glass sheet surface.

In one or more embodiments of the present disclosure, one or more dispensers of the array may be displaced horizontally relative to one or more adjacent dispenser of the array by means of a displacer, such as in a direction transverse to the direction of the first movement. This may e.g. enable adaption of spacer distance on the glass sheet surface, and hence help to e.g. adapt spacer distances to different glass sheets sizes. Hence, it may e.g. help to adapt the compressive loads acting on the respective spacer.

In one or more embodiments of the present disclosure, the glass sheet(s) is/are a thermally tempered glass sheet, for example a thermally tempered glass sheet. The thermally tempered glass sheet may in further embodiments of the present disclosure comprising a glass sheet surface unevenness of at least 0.1 mm, such as at least 0.2 mm, for example at least 0.3 mm.

In some embodiments, the glass sheet surface unevenness may even be equal to or larger than the spacer height.

Thermally tempered glass sheets may suffer from surface unevenness originating from the thermally tempering process to obtain the tempered glass sheet. Such surface unevenness, also called distortion, may e.g. comprise unevenness originating from one or more of roller waves, glass sheet bowing, glass sheet warp, glass sheet edge lift and/or the like.

Tempered glass sheets however provides advantages with regard to increased strength that enables using thinner glass sheets and/or providing larger distances between adjacent spacer, compared to if using annealed glass sheets in VIG units.

In one or more embodiments of the present disclosure, one or more magnets may attract a spacer into the collection hole from the spacer storage compartment. In certain further embodiments, the dispenser may comprise the one or more magnets, and the collection sheet may be placed between the one or more magnets and the spacer storage compartment.

In one or more embodiments of the present disclosure, a spacer maintaining arrangement comprising one or more magnets maintains the dispensed spacer in position at the glass sheet surface. In further embodiments, the one or more magnets of the spacer maintaining arrangement may be arranged opposite to the major surface of the glass sheet facing away from the dispenser so that the glass sheet is placed between the spacer outlet and the magnet.

In one or more embodiments of the present disclosure the distance between the glass sheet surface for receiving a collected spacer from the dispenser and the spacer outlet may be less than 0.6 mm, such as less than 0.3 mm, such as less than 0.2 mm, at least while the spacer is dispensed towards the glass sheet surface.

The present disclosure relates, in a second aspect, to a method of manufacturing a vacuum insulating glass unit. The method comprises providing a first glass sheet, and dispensing a plurality of spacers on a major surface of the provided glass sheet by means of a dispenser of a spacer dispensing system. The dispenser comprises a housing comprising a guidance space placed between a first housing surface of an upper part of the housing and a second housing surface of a bottom part of the housing. Moreover, the dispenser comprises a spacer outlet arranged at the bottom part of the housing. The dispenser additionally comprises a collection sheet, wherein the collection sheet comprises at least one collection hole extending between opposing major surfaces of the collection sheet. The collection sheet is arranged in the guidance space. The dispensing of spacers comprises:
providing a relative movement between the collection sheet and the housing by means of a driver so that the collection hole is arranged at the bottom of the spacer storage compartment and thereby collects a spacer from a spacer storage, and
providing a further, relative movement between the collection sheet and the housing to align the collected spacer in the collection hole opposite to the spacer outlet to deliver the collected spacer to the spacer outlet and towards the surface of the glass sheet.

The method further comprises providing a second glass sheet, and sealing together the first glass sheet and the provided second glass sheet at the periphery of the glass sheets with the plurality of dispensed spacers arranged between major surfaces of the glass sheets so that a gap is provided between the first and second glass sheets. The method also comprises evacuating the gap.

The present disclosure relates, in a third aspect to a method of manufacturing a vacuum insulating glass unit, where the method comprises providing a first glass sheet, and dispensing a plurality of spacers on a major surface of the provided first glass sheet by means of a dispenser of a spacer dispensing system. The dispenser comprises: a housing comprising a guidance space placed between an upper part of the housing and a bottom part of the housing, and a spacer outlet arranged at the bottom part of the housing. The dispenser additionally comprises a collection sheet wherein the collection sheet comprises at least one collection hole extending between opposing major surfaces of the collection sheet, and wherein collection sheet is arranged in the guidance space. The dispensing of a plurality of spacers comprises providing a relative rotational movement between the collection sheet and the housing around a rotation axis by means of a drive motor so that the collection hole collects a spacer from a spacer supply, and providing a further, relative rotational movement between the collection sheet and the housing around the rotation axis to align the collected spacer in the collection hole opposite to the spacer outlet so as to deliver the collected spacer to the spacer outlet and towards the surface of the glass sheet. The method according to the fourth aspects further comprises providing a second glass sheet, and sealing together the first glass sheet and the provided second glass sheet at the periphery of the glass sheets with the plurality of dispensed spacers arranged between major surfaces of the glass sheets so that a gap is provided between the first and second glass sheets. The method also comprises evacuating the gap.

In some embodiments of the present disclosure, the dispensed spacers may comprise predefined, pre-shaped contact surfaces. In other embodiments, the spacers may have a spherical outer shape.

It is generally understood that the method according to the second and/or third aspect, in further embodiments may comprise one or more of the previously described embodiments.

In one or more embodiments of the second and/or third aspect, the collection sheet may provide a bottom part of a spacer storage compartment of the dispenser.

In one or more embodiments of the second and/or third aspect, the spacers in the spacer storage compartment comprises predefined, pre-shaped contact surfaces.

In one or more embodiments of the second and/or third aspect, the spacers comprises opposing, such as plane, such as flat, contact surfaces.

In one or more embodiments of the second and/or third aspect, the collection hole is a through hole.

In one or more embodiments of the second and/or third aspect, each of the plurality of spacers in the spacer storage compartment may have a spacer height extending between the contact surfaces and wherein each of said spacers has a spacer width, wherein the guidance space has a height which is less than 1.4 times the spacer height, and wherein the height of the guidance space is smaller than the spacer width.

The present disclosure relates, in a fourth aspect, to use of a dispenser for dispensing spacers comprising opposing, predefined contact surfaces on a surface of a glass sheet during manufacturing of a vacuum insulating glass unit. The dispenser comprises:
a spacer storage compartment comprising a plurality of said spacers,
a housing comprising a guidance space placed between a first housing surface of an upper part of the housing and a second housing surface of a bottom part of the housing,
a spacer outlet arranged at the bottom part of the housing,
a collection sheet, such as a disc shaped collection sheet, providing a bottom part of the spacer storage compartment, wherein the collection sheet comprises at least one collection hole extending between opposing major surfaces of the collection sheet, wherein the collection hole is a through hole and wherein the collection sheet is arranged in the guidance space,
   wherein a relative rotational movement between the collection sheet and the housing around a rotation axis is provided, such as by means of a shaft, so that the collection hole is arranged at the bottom of the spacer storage compartment and thereby collects a spacer from the bottom of the spacer storage compartment, and
   wherein a further, relative rotational movement between the collection sheet and the housing around the rotation axis is configured to be provided to align the collected spacer in the collection hole opposite to the spacer outlet.

This may e.g. provide a n advantageous solution for dispensing spacers during VIG unit manufacturing. E.g. as previously described.

In one or more embodiments of the fourth aspect, each of the plurality of spacers in the spacer storage compartment has a spacer height extending between the contact surfaces and wherein each of said spacers has a spacer width, wherein the guidance space has a height which is less than 1.4 times the spacer height, and wherein the height of the guidance space is smaller than the spacer width.

In one or more embodiments of the fourth aspect, the spacers in the spacer storage compartment are randomly orientated.

In one or more embodiments of the fourth aspect, the collection sheet comprises an upwardly facing first major surface and a downwardly facing, oppositely directed second major surface, wherein the second housing surface covers at least 90%, such as at least 98% of the surface area of the second major surface,

In one or more embodiments of the fourth aspect, the first housing surface covers at least 40%, such as at least 60%, such as at least 75% of the surface area of the first major surface of the collection sheet.

In one or more embodiments of the fourth aspect, the collection sheet has an outer maximum disc diameter, and wherein the housing has a width, such as a diameter, that is larger than the disc diameter.

In one or more embodiments of the fourth aspect, the housing has a maximum width, such as a maximum outer diameter, that is 50 mm or less, such as 40 mm or less, for example 30 mm or less.

In one or more embodiments of the fourth aspect, the housing may enclose at least 80% such as at least 95 % of the outer boundary, such as periphery, of the collection sheet by means of a wall part, such as an annular wall part, arranged opposite to the outer boundary of the collection sheet. In one or more embodiments of the fourth aspect, the housing substantially fully encloses the outer boundary of the collection sheet. This may e.g. provide a more resistant dispenser and/or provide a more dust proof dispenser.

In one or more embodiments of the fourth aspect, the dispenser is used in a method according to any the first, second or third aspect.

The present disclosure relates, in a fifth aspect, to a dispenser for dispensing spacers comprising opposing, predefined contact surfaces on a surface of a glass sheet during manufacturing of a vacuum insulating glass unit. The dispenser comprises:
a spacer storage compartment comprising a plurality of said spacers,
a housing comprising a guidance space placed between a first housing surface of an upper part of the housing and a second housing surface of a bottom part of the housing,
a spacer outlet arranged at the bottom part of the housing,
a collection sheet providing a bottom part of the spacer storage compartment, wherein the collection sheet comprises at least one collection hole extending between opposing major surfaces of the collection sheet, wherein the collection hole is a through hole and wherein the collection sheet is arranged in the guidance space,
   wherein a relative rotational movement between the collection sheet and the housing around a rotation axis is provided, such as by means of a shaft, so that the collection hole is arranged at the bottom of the spacer storage compartment and thereby collects a spacer from the bottom of the spacer storage compartment, and
   wherein a further, relative rotational movement between the collection sheet and the housing around the rotation axis is configured to be provided to align the collected spacer in the collection hole opposite to the spacer outlet.

In some embodiments, of the fifth aspect, the dispenser may be for individually dispensing spacers on the surface of a glass sheet.

In one or more embodiments of the fifth aspect, the spacers comprises opposing, predefined contact surfaces.

In one or more embodiments of the fifth aspect, each of the plurality of spacers in the spacer storage compartment has a spacer height extending between the contact surfaces and wherein each of said spacers has a spacer width, wherein the guidance space has a height which is less than 1.4 times the spacer height, and wherein the height of the guidance space is smaller than the spacer width.

In one or more embodiments of the fifth aspect, the collection sheet may be disc shaped.

In one or more embodiments of the fifth aspect, the collection sheet may have an outer maximum width, such as a disc diameter, and wherein the housing has a width, such as a diameter, that is larger than a width, such as a diameter of the collection sheet.

In one or more embodiments of the fifth aspect, the collection sheet may comprise a first major surface and an oppositely directed second major surface, wherein the second housing surface covers at least 90%, such as at least 98% of the surface area of the second major surface. This may e.g. help to reduce issues with dust or dirt.

In one or more embodiments of the fifth aspect, the collection sheet may comprise a first major surface and an oppositely directed second major surface, wherein the first housing surface covers at least 40%, such as at least 60%, such as at least 75% of the surface area of the first major surface of the collection sheet. This may e.g. help to reduce issues with dust or dirt

In one or more embodiments of the fifth aspect, one or more side wall surfaces enclosing the spacer storage compartment may narrows in a direction towards the collection sheet.

In one or more embodiments of the fifth aspect, at least a part of the spacer storage compartment may be funnel shaped.

In one or more embodiments of the fifth aspect, the length of a traveling path of the collection hole at the bottom of the spacer storage compartment is at least 0.9 times, such as at least 1.2 times, such as at least 1.8 times, the distance between the rotation axis and the outer boundary/periphery of the dispenser housing.

In one or more embodiments of the fifth aspect, the spacer storage compartment may be elongated and extend partly around the rotation axis, such as wherein the spacer storage compartment is arc shaped.

In one or more embodiments of the fifth aspect, the rotational movement around the rotation axis from the spacer storage compartment so as to align the collected spacer in the collection hole (15a) opposite to the spacer outlet may be configured to be at least 85°, such as at least at least 120°, for example at least 170°.

In one or more embodiments of the fifth aspect, the dispenser is for use in a method according to any of the preceding aspects, such as any of the first, second, third or fourth aspect.

In one or more embodiments of the fifth aspect, the housing of the dispenser may be releasably attached to a dispenser holding part of a dispenser system by means of a locking system, such as a spring loaded locking system. The locking system may comprise an actuation member to be operated to actuate the locking system. In some embodiments, the locking system may be configured for tool-less mounting and dismounting of the dispenser.

In one or more embodiments of the fifth aspect, the dispenser comprises a sensor system comprising one or more sensors, such as one or more optical sensors, configured to detect if a collected spacer is present in the collection hole, and wherein the sensor system provides one or more sensor outputs comprising information of if a collected spacer is present in the collection hole.

In one or more embodiments of the fifth aspect, the thickness of the collection sheet may be within ±15%, such as within ±10%, such as within ±5% or within ±3% of the spacer height.

In one or more embodiments of the fifth aspect, the thickness of the collection sheet is between 1 and 1.4 times the spacer height, such as between 1 and 1.3 times the spacer height. In one or more embodiments of the fifth aspect, the thickness of the collection sheet may in embodiments of the present disclosure be less than 0.6 mm such as less than 0.35 mm, for example less than 0.28 mm or less.

In one or more embodiments of the fifth aspect, the thickness of the collection sheet may in embodiments of the present disclosure be between 0.05 mm and 0.8 mm, such as between 0.1 mm and 0.6 mm, for example between 0.1 mm and 0.3 mm

The present disclosure moreover relates to a use of a dispenser according to the fifth aspect, for dispensing, such as individually dispensing, a plurality of spacers on a major glass sheet surface, wherein said spacers are collected one by one from the spacer storage compartment.

Additionally, the present disclosure relates to a use of a dispenser according to the fifth aspect, wherein the spacers in the spacer storage compartment are randomly intermixed and/or randomly orientated.

Moreover, the present disclosure moreover relates to a use of a dispenser according to the fifth aspect, wherein the spacers in the spacer storage compartment comprises pre-shaped contact surfaces, such as substantially plane contact surfaces,

The present disclosure moreover relates to a use of a dispenser according to the fifth aspect wherein the spacers in the spacer storage compartment have a spacer width that is larger than the spacer height.

Moreover, the present disclosure relates to a use of a dispenser according to the fifth aspect, wherein the dispenser is used for collecting a spacer from the spacer storage compartment one by one and bring it into a predefined orientation prior to dispensing the spacer through the spacer outlet.

In one or more embodiments of the fourth or fifth aspect, said dispenser may be used so as to provide the method of any of the above mentioned embodiments and/or aspects.

It is generally understood that a method, use and/or dispenser according to the second, third, fourth or fifth aspect, or embodiments thereof, may provide one or more of the advantages as e.g. previously described.

### FIGURES

Aspects of the present disclosure will be described in the following with reference to the figures in which:

FIGS. 1a-2a: illustrates a dispenser for dispensing spacers according to embodiments of the present disclosure,

FIGS. 2a-2b: illustrates a spacer comprising predefined, pre-shaped contact surfaces according to embodiments of the present disclosure,

FIGS. 3a-3c: illustrates a spacer collection and dispensing process according to various embodiments of the present disclosure,

FIGS. 4a-4b: illustrates a dispenser comprising a vacuum path according to various embodiments of the present disclosure,

FIG. 5: illustrates a dispenser comprising a sensor system according to embodiments of the present disclosure,

FIG. 6: illustrates a repeated travel path of a collection hole of a dispenser according to embodiments of the present disclosure,

FIG. 7: illustrates a curved traveling path of a collection hole at the bottom of a spacer storage compartment according to embodiments of the present disclosure,

FIGS. 8-9: illustrates side wall surfaces enclosing a spacer storage compartment which narrows towards a collection sheet, according to embodiments of the present disclosure,

FIG. 10: illustrates a dispenser array according to embodiments of the present disclosure,

FIG. 11: illustrates a dispenser system according to embodiments of the present disclosure,

FIG. 12: illustrates a distance controller configured to control a distance adjustment motor according to embodiments of the present disclosure,

FIG. 13: illustrates a quick release locking system according to embodiments of the present disclosure,

FIG. 14: illustrates a dispenser comprising an outlet nozzle,

FIG. 15: illustrates an embodiment of the present disclosure wherein holes are chamfered, according to embodiments of the present disclosure,

FIG. 16: illustrates a spacer dispenser comprising a vibrator,

FIG. 17: illustrates a Vacuum Insulating Glass (VIG) unit according to embodiments of the present disclosure,

FIG. 18: illustrates a manufacturing line for manufacturing VIG units according to embodiments of the present disclosure,

FIG. 19: illustrates a glass sheet having a major glass sheet surface that has been subjected to a spacer placement sequence provided by means of one or more dispensers, according to embodiments of the present disclosure,

FIG. 20: illustrates one or more dispensers in a dispenser array configured to be displaced horizontally relative to an adjacent dispenser,

FIG. 21: illustrates static charge reduction, according to embodiments of the present disclosure,

FIG. 22: illustrates schematically a dispensing array comprising a plurality of dispensing systems according to further embodiments of the present disclosure,

FIGS. 23a-23b: illustrates a quick release locking system according to further embodiments of the present disclosure,

FIG. 24: illustrates a microscopic image of a spacer according to embodiments of the present disclosure,

FIG. 25: illustrates a collection sheet comprising a chickened centre part according to embodiments of the present disclosure,

FIGS. 26-27: illustrate various embodiments of predefined, pre-shaped, flat, such as plane, contact surfaces of a spacer, according to further embodiments of the present disclosure,

FIG. 28: illustrates a spacer maintaining arrangement configured to maintain a spacer 2 in position at a glass sheet surface according to embodiments of the present disclosure, and

FIG. 29: illustrates a magnet configured to attract a spacer from a spacer storage and into a collection hole, according to embodiments of the present disclosure.

### DETAILED DESCRIPTION

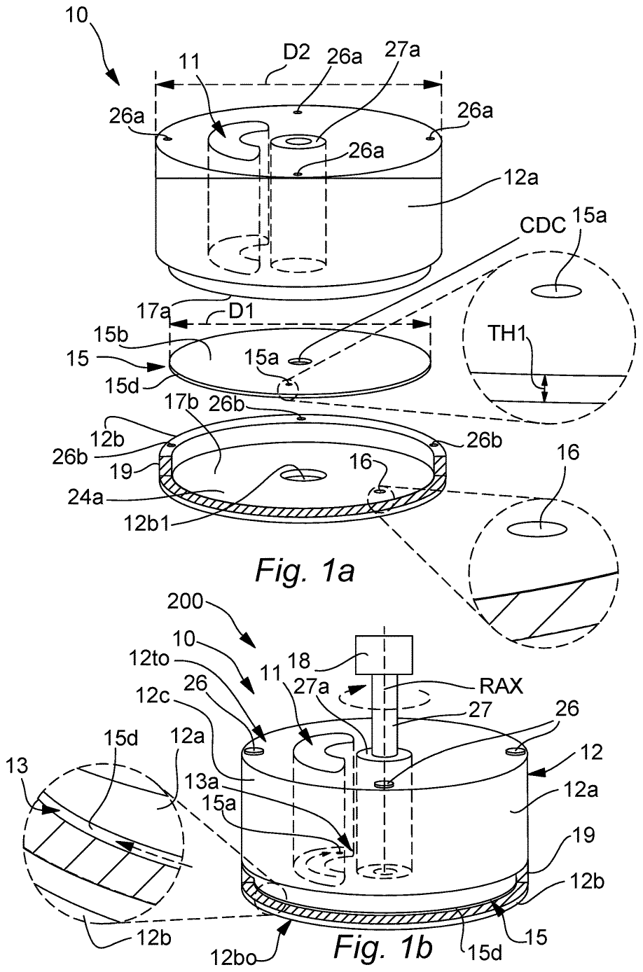

FIGS. 1a and 1b illustrates schematically and in perspective a dispenser 10 according to embodiments of the present disclosure for dispensing spacers 2 onto a glass sheet for use in a Vacuum insulating glass unit, also referred to as a VIG unit.

FIG. 1a illustrates an exploded, unassembled view of the dispenser 10, so that the different parts of the dispenser according to various embodiments can be seen. Both in FIGS. 1a and 1b, a bottom part of the housing 12b comprises a cut-out in a wall 19 for viewing purpose only, so that the structure of the lower part pf the dispenser 10 is more visible, also after assembling. Hence, it is understood that the wall 19 may be annular and substantially complete.

As can be seen, the dispenser comprises a housing 12. The housing 12 comprises an upper part 12a such as a body part 12a and a bottom part 12b. The upper body part 12a is configured to be attached to the lower body part 12b by mechanical fastening means 26, such as releasable fastening means such as one or more threaded bolts, screws, clips or the like.

The fastening means in FIGS. 1a and 1b comprises bolts, and the upper body part 12a comprises through going holes 26a through which the bolts extends, and the bottom part 12b comprises threaded holes 26b in the outer wall 19 for receiving and engaging with the bolts 12a. Thereby, the upper body part 12a can be attach to the bottom part 12b to form the dispenser housing 12 as seen in FIG. 1b.

The upper body part 12a comprises a spacer storage compartment. This storage compartment is configured to store a plurality of spacers 2 therein. The spacers for VIG units are small (ad explained in more details below), such as having a spacer height H1 less than 0.4 mm, such as less than 0.25 mm, for example 0.2 mm or less. More than 10.000, such as more than 20.000, for example more than 40.000 spacers may be stored in the storage at the same time.

A guidance space 13 is placed between the upper body part 12a of the housing 12 and the bottom part (12b) of the housing. In the embodiments of FIGS. 1 and 1a, the guidance space 13 is placed between a first housing surface 17a of the upper body part 12a of the housing 12 and a second housing surface 17b of the bottom part 12b of the housing 12. Hence, when the upper body part 12a and the bottom part are assembled, the guidance space is defined/provided.

As can be seen, the annular wall 19 of the bottom part 12b may extend around and encircle/enclose the guidance space when the dispenser is assembled.

The dispenser 10 also comprises a collection sheet 15. This collection sheet 15 may e.g. as illustrated in fig. la, in embodiments of the present disclosure, be disc shaped. The collection sheet 15 has an outer boundary 15d. In this embodiment, the collection sheet comprises/describes a circular outer periphery 15d. The collection sheet comprises a first major surface 15b facing the upper body part 12a and a downwardly facing, oppositely directed, major surface (not visible in FIGS. 1a and 1b) facing the bottom part 12b. The major surfaces of the collection disc are preferably parallel.

In some embodiments of the present disclosure (not illustrated), the collection sheet 15 may have another shape than disc shape. E.g., in some embodiments of the present disclosure, the collection sheet 15 may have a polygonal shape, such as a symmetric polygonal shape. The size such as the diameter and thickness TH1 of the collection sheet 15 is adapted so that the collection sheet 15 can be rotated around it's centre CDC in the guidance space 13, around a rotation axis RAX. Hence, the major surfaces of the collection sheet 15 comprises/defines a plane that are substantially perpendicular to the rotation axis RAX. The rotation axis RAX is preferably arranged to extend through the collection sheet centre CDC.

A shaft extends through the upper body part 12a and may be connected/attached to the upper body part by means of a bearing 27a such as roller bearing or another suitable type of bearing that enables relative rotation between the housing 12 and the shaft 27 around the rotation axis RAX. The rotation axis is in FIGS. 1a and 1b coincident with a centre axis of the housing, but in other embodiments, the rotation axis may be displaced relative to a centre axis of the housing.

The collection sheet 15a may as illustrated e.g. have hole or the like at the centre CDC, to enable fastening of e.g. a shaft or the like to the collection sheet 15. As can be seen, the bottom wall 24 of the bottom part 12b may be provided with a recess or a hole (the latter being illustrated in FIG. 1a) at the centre, so as to e.g. enable space for a fastening part (not illustrated) for fastening the collection sheet 15 to a shaft 27a at the centre CDC. The hole 12b1 may hence be arranged at the centre of the bottom wall 24a. It is understood that the bottom wall 24a in FIG. 1a comprises the major surface 17b for facing the guidance space 13 upon housing part 12a, 12b assembly.

As can be seen, the outer periphery of the housing 12 is circular and has an outer diameter D2, and the housing 12 may as illustrated be substantially cylindrical. Here, the outer sidewall 12c of the dispenser extending between top 12to and bottom 12bo of the dispenser housing is curved to provide the cylinder shape. However, in other embodiments, the outer side wall 12c of the housing 12 may have another shape (not illustrated in FIGS. 1a and 1b), e.g. rectangular, for example square shaped or the like and have a width that may also be referred to as D2.

The housing 12 may in embodiments of the present disclosure have a maximum width D2, such as a maximum outer diameter, that is 50 mm or less, such as 40 mm or less, for example 30 mm or less. The housing 12 may in embodiments of the present disclosure have a maximum width D2 that is between 20 mm and 70 mm, such as between 20 mm and 50 mm. such as between 25 mm and 45 mm for example 30 mm.

The width D2 may in an embodiment of the present disclosure be determined/defined along a plane extending in a direction transverse to, such as perpendicular to, the rotation axis RAX1.

The maximum width D2 may in an embodiment of the present disclosure be determined/defined in a direction transverse to, such as perpendicular to, the rotation axis RAX1, such as in a direction extending transverse to, such as perpendicular to, the rotation axis RAX1.

The bottom part 12b comprises a spacer outlet 16 for dispensing spacers one at a time towards a glass sheet surface. The spacer outlet is arranged in the major surface 17b facing towards the upper body part 12a and the collection sheet 15.

The as can be seen from FIG. 1b, the collection sheet 15 is arranged in the guidance space between 13 between the surfaces 17a, 17b. The collection sheet 15 comprises a collection hole 15a extending between the opposing major surfaces 15b, 15c (15 c not illustrated in FIGS. 1a and 1b) of the collection sheet 15. The collection hole 15a is a through hole allowing a spacer to enter through the collection hole 16. In FIG. 1, the collection sheet comprises a single collection hole 15a.

In other embodiments, the collection sheet 15 may comprise a plurality of collection holes 15a. In some embodiments, these 15a may be distributed with a mutual distance of e.g. π (pi), ½ π or less. For example, the collection sheet may comprise 3 collection holes arranged with 120° there between, four collection holes arranged with 90° there between or the like. The collection sheet 15 may comprise between one and ten collection holes15a, such as between one and six collection holes, such as between two and six collection holes (not illustrated). However, it is understood that the collection sheet 15 may also comprise just one collection hole 15a as illustrated.

It is understood that in embodiments of the present disclosure, one or both surfaces17a, 17b may be uncoated or coated. If the surface(s) 17a, 17b is/are coated, they may be coated e.g. by an electrically conducting layer or an electrically substantially electrically un-conducting layer. In additional or alternative embodiments, if the surface(s) 17a, 17b is/are coated, the coating may comprise a friction-reducing layer such as a polymer, such as Polytetrafluoroethylene (PTFE) or other suitable materials. It is understood that in embodiments of the present disclosure, one or both surfaces 15b, 15c of the collection sheet may be coated or uncoated. If these/this surface(s) 17a, 17b is/are coated, the coating may e.g. comprise a friction-reducing layer such as a polymer, such as Polytetrafluoroethylene (PTFE) or other suitable materials. In embodiments the coating may comprise a magnetic material.

The collection sheet 15 provides a bottom part of the spacer storage compartment 11, and hence a plurality of the spacers 2 in the storage compartment are configured to be in touch with and support on the major surface 15b of the collection sheet, such as due to gravity. Hence, the size and/or shape of the spacer storage compartment 11 proximate the collection sheet 15 provides that a plurality of spacers are in touch with the surface 15b. Hence, e.g. more than 50, such as more than 200, such as more than 500 or more than 1000 spacers may be in touch with the collection sheet surface 15b.

In FIG. 1b a relative rotational movement between the collection sheet 15 and the housing 12 is provided by keeping the housing 12 un-rotating/stationary (with respect to at least rotation). The disc shaped collection sheet 15 is rotated inside the guidance space 13 by means of the shaft 27 and a driver motor 18 such as an electrical motor 18, such as a servo motor, stepper motor or the like. In other embodiments of the present disclosure, the relative rotational movement between the collection sheet 15 and the housing 12 may be provided by keeping the collection sheet un-rotating/stationary (with respect to at least rotation) and instead rotate the housing and hence the spacer outlet 16 by means of a driver motor 18.

The relative rotation around the rotation axis RAX provides that the collection hole 15a enters into the bottom of the spacer storage compartment 11 with the spacers in the storage compartment resting on the surface 15b. Hence, a relative movement between the spacers 2 at the bottom of the compartment 11, which supports on the surface 15b of the collection sheet in the compartment 11, and the collection sheet surface 15b, is provided. Hence, a spacer 2 is collected in the collection hole 15a during the rotational movement when the collection hole 15a “moves through”/swipes the compartment 11 bottom. The collection hole 15a then leaves the spacer storage bottom (with a collected spacer therein) and enters the guidance space 13 again at a guidance space entrance 13a due to a further rotation around the rotation axis RAX.

The dispenser hence dispenses collected spacers consecutively through the spacer outlet 16. One or more of the housing top part 12a, bottom part 12b and/or the collection sheet 15 may in embodiments of the present disclosure be made from metal such as steel, such as stainless steel, brass or aluminium. In some embodiments, the entire housing 12 and the collection disc 15 may be made from the same metal material or from different metal materials.

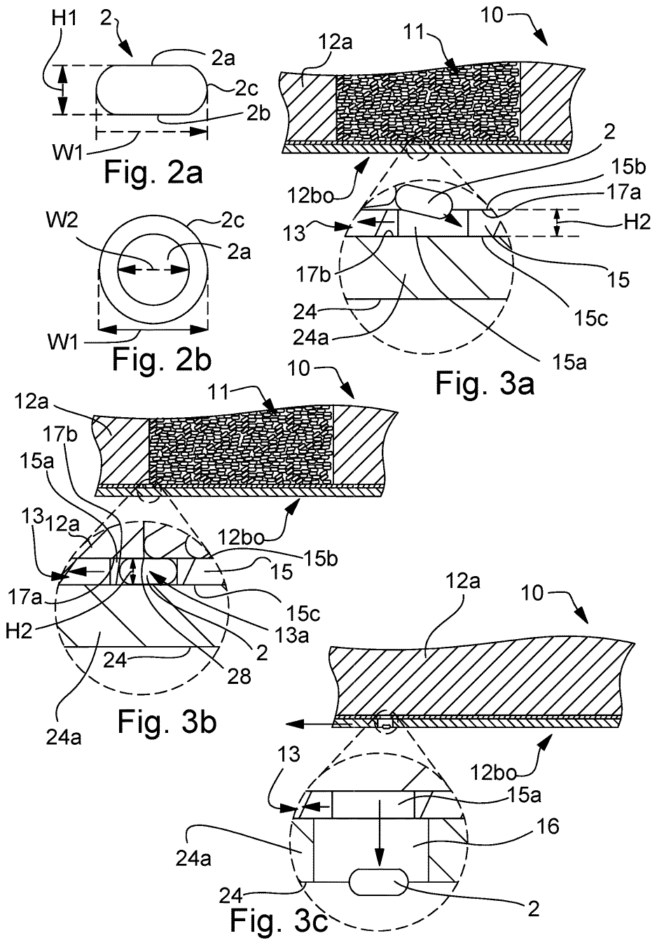

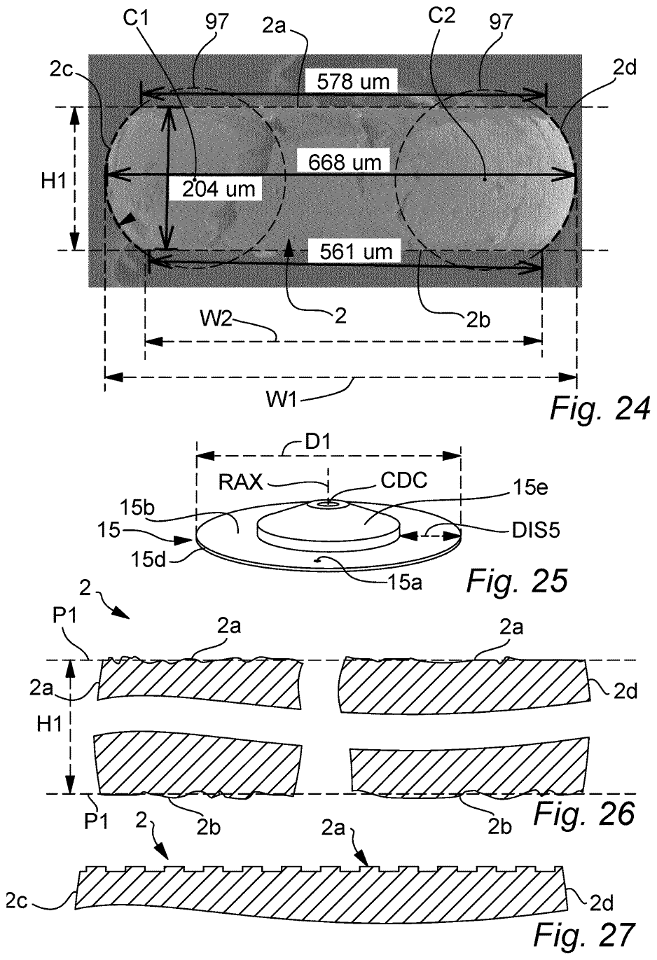

FIGS. 2a and 2b illustrates schematically a spacer 2 to be dispensed by the dispenser 10, according to embodiments of the present disclosure. Reference is also made to FIG. 24 where a microscopic picture of a spacer embodiment is illustrated.

The spacer 2 comprises opposing predefined, pre-shaped contact surfaces 2a, 2b which are the contact surfaces for contacting and separating glass sheet surfaces facing the evacuated gap of a VIG unit. In FIGS. 2a and 2b, the contact surfaces 2a, 2b are flat.

The spacer 2 has a spacer height HI extending between the predefined contact surfaces 2a, 2b. This height HI may in embodiments of the present disclosure be less than 0.4 mm, such as less than 0.25 mm, for example 0.2 mm or less.

As can be seen, the spacer have a width W1. As the spacer 2 in embodiments of the present disclosure may have an outer circular side periphery (see FIG. 2b) described by the side surface/side edge surface 2c extending between the contact surfaces 2a, 2b, the width W1 may be a diameter.

In embodiments of the present disclosure, the maximum width W1, such as the maximum diameter, of the spacer 2 may be larger than the height HI of the spacer 2, such as at least 1.3, times, such as at least 1.5 times or at least 1.8 times larger than the height HI of the spacer 2.

The spacer side surface 2c as illustrated extends between the contact surfaces 2a, 2b, and may as illustrated, in embodiments of the present disclosure, be curved and convexly extending, such as bulging, between the contact surfaces 2a, 2b. Hence, the width W2 (such as diameter) of the contact surfaces 2a, 2b may be less than the maximum width W1 (such as diameter) of the spacer 2. For example, the width (such as diameter) W2 of the contact surfaces 2a, 2b may be less than 0.95 times, such as less than 0.8 times, for example less than 0.6 times the maximum width W1 (such as diameter) of the spacer 2.

In some embodiments, the width W2 (such as diameter) of the contact surfaces 2a, 2b may be larger than 0.4 times, such as larger than 0.5 times, for example larger than 0.6 times the maximum width W1 (such as diameter) of the spacer 2.

In some embodiments, the width W2 (such as diameter) of the contact surfaces 2a, 2b may be less than 0.7 times, such as less than 0.6 times, for example less than 0.5 times the maximum width W1 (such as diameter) of the spacer 2.

The thickness TH1 of the collection sheet 15 may in embodiments of the present disclosure be within ±15%, such as within ±10%, such as within ±5% or within ±3% of the spacer height H1.

The thickness TH1 of the collection sheet 15 may in embodiments of the present disclosure be 1.4 times or less of the spacer height H1.

The thickness TH1 of the collection sheet 15 may in embodiments of the present disclosure be less than the spacer height H1. The thickness TH1 of the collection sheet 15 may in embodiments of the present disclosure be between 1 and 1.4 times the spacer height HI, such as between 1 and 1.3 times the spacer height HI, for example between 1 and 1.15 times the spacer height H1.

The spacer 2 may e.g. have spacer height HI extending between the predefined contact surfaces 2a, 2b that may be less than 0.4 mm, such as less than 0.25 mm, for example 0.2 mm or less.

The thickness TH1 of the collection sheet 15 may in embodiments of the present disclosure be less than 0.6 mm such as less than 0.35 mm, for example 0.28 mm or less.

The thickness TH1 may in embodiments of the present disclosure be between 0.05 mm and 0.8 mm, such as between 0.1 mm and 0.6 mm, for example between 0.1 mm and 0.3 mm The thickness TH1 may in embodiments of the present disclosure be less than the spacer width W1.

The spacer 2 may be made from a metal, such as steel, such as stainless steel, or iron, or a polymer material. The spacer may be made from a material that provides no or low outgassing in the evacuated gap of the VIG unit, in order to maintain the desired vacuum integrity of the VIG unit.

As can be seen, the collection sheet 15 comprises an upwardly facing first major surface 15b and a downwardly facing, oppositely directed second major surface 15c.

The second housing surface 17b facing towards the top 12to of the housing may in embodiments of the present disclosure cover a major part of the major surface of the collection disc. For example, the surface 17b may in embodiments of the present disclosure cover at least 85% or at least 90%, such as at least 98% of the surface area of the second major surface 15c of the collection sheet.

The first housing surface 17a facing the bottom part with the spacer outlet 16 may in embodiments of the present disclosure cover at least 40%, such as at least 60%, such as at least 75% of the surface area of the first major surface 15b of the disc shaped collection sheet 15.

One or more of the spacer storage compartment 11 and optional holes for sensors, pressurized air and/or the like may cause a reduced covering of the surface 15b by the surface 17a compared to the covering of the surface 15c by the housing surface 17b.

The collection sheet 15 has an outer maximum disc diameter (D1) and the housing 12 has a width D2, such as a diameter, which is larger than the collection sheet diameter D1.

The housing 12 encloses at least 80% such as at least 95 %, such as e.g. more than 99% of the outer boundary, such as periphery, 15d of the collection sheet 15. The housing may in embodiments of the present disclosure fully enclose the outer boundary 15d, such as outer periphery, of the collection sheet 15. This may be provided by means of the wall 19 part, such as an annular wall part, that is arranged opposite to the outer periphery 15d of the disc shaped collection sheet 15. The wall part 19 may be part of, such as unitary with the bottom part 12b as illustrated, or may be unitary with the upper body part 12a.

The guidance space 13 may be obtained upon assembly of the upper housing part 12a and the lower bottom part 12b.

FIGS. 3a-3c illustrates schematically a spacer collection and dispensing process according to various embodiments of the present disclosure. Here, a spacer collection is provided when the collection hole 15a moves through/swipes the storage 11 bottom to collect a spacer 2, see FIG. 3a. The collected spacer 2 enters the guidance space (see FIG. 3b) at an entrance 13a, and the collected spacer 2 is dispensed through the spacer outlet 16 at the dispenser bottom 12bo (se FIG. 3c), according to various embodiments of the present disclosure.

In FIG. 3a, the collection sheet 15 is rotated which provides that the collection hole 15 moves into the spacer storage compartment 11 at the bottom and moves relative to the plurality of spacers 2 in the storage compartment 11. This movement provides that a spacer 3 enters into the collection hole 15a. The collection hole has a width that enables only one spacer to move into the collection hole 15a, and a height that is 1.4 times the spacer height HI or less, such as substantially corresponding the spacer height.

The diameter/width of the collection hole (which may be a circular hole) is fitted to be larger than the spacer width W1 such as spacer diameter. However, not larger than preventing two spacers 2 from entering into the collection hole at once. For example, the collection hole 15a may have a width, such as a diameter that is between 1.01 and 1.6 times, such as between 1.1 and 1.5 times, for example between 1.2 and 1.4 times the spacer width W1.

In some embodiments of the present disclosure, the collection hole 15a may have a maximum width such as diameter that is between 0.01 mm-0.3 mm larger, such as between 0.05 mm-0.2 mm larger, for example between 0.08 mm-0.13 mm larger than the spacer width W1 such as spacer diameter. For example, for spacers with a diameter of 0.5 mm, the collection hole diameter may be 0.6 mm, i.e. 0.1 mm larger than the spacer diameter.

The spacers 2 in the spacer storage compartment 11 may in embodiments of the present disclosure be randomly intermixed and randomly orientated (e.g. as illustrated). This may be provided by loading, pouring or the like the spacers into the storage compartment. When the collection hole 15a enter through the bottom of the spacer storage 11, this movement may help to provide that one of the randomly intermixed and randomly orientated spacers 2 enters into/is collected by the collection hole.

The collection sheet 15 (and the collection hole 15a) moves due to the rotation around the rotation axis RAX (see FIG. 1b) further through the compartment 11 bottom, now with the collected spacer 2 preventing further spacers of the storage 11 from entering into the collection hole. A predefined, pre-shaped, such as flat, contact surface 2a or 2b of the collected spacer 2 supports on the bottom part surface 17b facing the collected spacer and being arranged opposite the major surface 15c of the collection sheet 15 and slides over the surface 17b.

In FIG. 3b, the spacer enters the guidance space 13 at a guidance space entrance 13a. The spacers 2 in the storage 11 has the maximum spacer width W1 and spacer height H1. The guidance space 13 has a height H2 that is less than 1.4 times the spacer height H1. Also, the height H2 of the guidance space 13 may be smaller than the spacer width W1, at least at the edge 28 at the entrance 13a.

In embodiments of the present disclosure, the guidance space 13 has a height H2 at the collection hole entrance 13a to the guidance space 13 from the spacer storage compartment 11 which is less than 1.4 times the spacer height H1, the height H2 of the guidance space 13 at the entrance is smaller than the spacer width W1. This height may be substantially constant for the entire guidance space 13 between the surfaces 17a, 17b, or may at least be the case/present for/at the collection hole entrance 13a to assure that only one spacer enters the guidance space. In some embodiments, the height H2 may be larger at other locations than at the entrance 13a.

The edge 28 of the housing 12 proximate the guidance space 13 (and the surface of the housing above the entrance 13a) at the entrance 13a will, due to the said guidance space 13 height H2, retain/detain spacers 2 in the spacer storage compartment 11. This helps to provide that only one spacer 2 at the time is allowed to enter into the guidance space, and that spacer 2 is the spacer collected in the collection hole 15a.

Hence, the distance between the surface 15b of the collection sheet 15 and the housing surface 17a is less than the spacer height H1, such as less than half of the spacer height.

In embodiments of the present disclosure, guidance space 13 has a height H2 that is between 1.05 and 1.4 times, such as between 1.1 and 1.3 times the spacer height H1.

It is understood that in embodiments of the present disclosure, the spacers 2 may have a spacer height H1 of less than 0.5 mm such as less than 0.3 mm, such as less than 0.25 mm. For example, the spacer height Hl may be 0.2 mm or less.

The surfaces 17a and 17b may help to maintain guidance of the collection sheet 15 and the collected spacer 2, and/or help to maintain collection sheet integrity and/or shape over time.

In embodiments of the present disclosure, the height H2 of the guidance space 13 is less than 0.5 mm, such as less than 0.3 mm, such as less than 0.25 mm.

In embodiments of the present disclosure, the height H2 of the guidance space 13 is less than 1.5 times, such as less than 1.3 times the thickness TH1 of the disc shaped collection sheet 15.

In FIG. 3c, the spacer has been moved to be aligned with/opposite to the spacer outlet 16 at the bottom part 12b in the bottom 12bo of the housing 12. This provides that the collected spacer 2 is dropped into the spacer outlet 16 from the collection hole 15a, and from there out of the spacer outlet. The spacer outlet 16 may in embodiments of the present disclosure be larger than the collection hole, which may increase the chance of the spacer 2 dropping into the outlet 16 from the collection hole 15a. The collection hole hence both provides a collection sheet inlet for a spacer at the spacer storage, and a collection sheet outlet at the spacer outlet 16.

Gravity may induce the dropping of the collected spacer into the spacer outlet, but one or more of applied vibrations, pressurized air and/or the like may in further embodiments of the present disclosure help the spacer 2 to drop into the outlet.

As can be seen, the spacer 2 is designed with the predefined, pre-shaped contact surfaces 2a, 2b. These 2a, 2b are shaped so that when the dispenser 10 dispenses the spacer 2, the spacer 2 will generally land on the glass sheet surface 3a and support on one of the first and second contact surface 2a, 2b.

In some embodiments, if the side edge surface (see e.g. FIGS. 2a and 2b and other figures described further below) are convexly shaped and extending between the contact surfaces, this may increase the chance of the spacer not staying at the side surface 2c when it is dispensed.

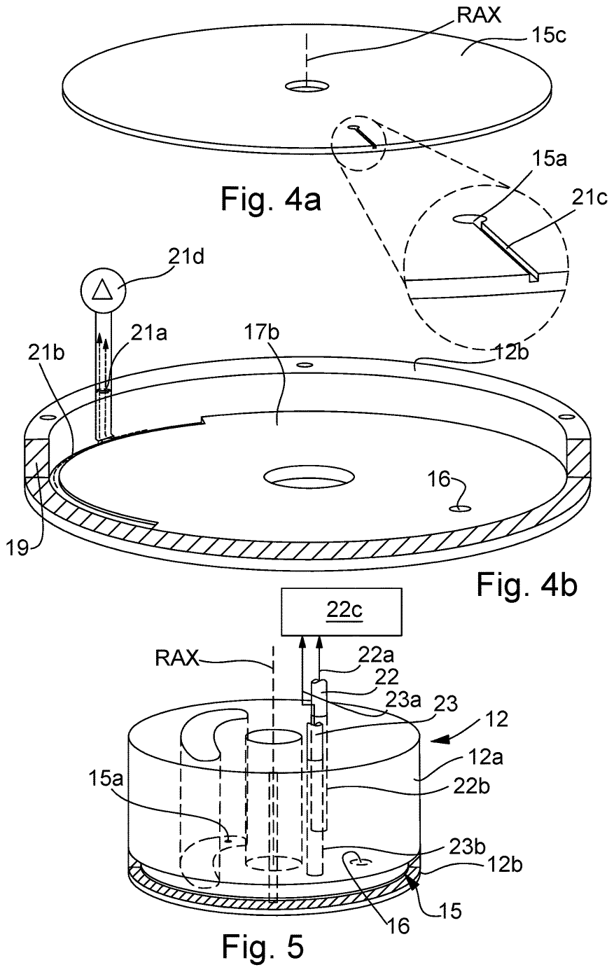

FIGS. 4a-4b illustrates schematically and in perspective the dispenser 10 comprising a vacuum path according to embodiments of the present disclosure.

The vacuum path 21a, 21b, 21c, such as one or more vacuum channels are connected to a vacuum pump 21d, and the vacuum pump provides suction in the vacuum path so as to help a spacer 2 of the spacer storage compartment 11 to enter into the collection hole 15a.

As illustrated in FIG. 4a, the collection sheet may comprise a part 21c of the vacuum path integrated therein, in the illustrated example a such as a channel, such as a recessed channel/slit extending from the collection hole 15a and towards the periphery 15d of the collection sheet. This channel may help to provide a suction in the collection hole when the hole is arranged to collect spacer from the spacer storage 11. In FIG. 4a, the collection sheet is turned upside down, and the surface 15c is the surface that will face away from the spacer storage 11 during dispenser operation.

In other embodiments, the vacuum channel in the sheet 15 may extend from the collection hole towards the centre portion of the collection sheet, and the vacuum path may hence e.g. be arranged together with and/or inside a shaft for rotating the sheet, or a stationary part extending from the centre of the sheet 26 dependent on the constitution of the dispenser.

FIG. 4b illustrates an additional or alternative embodiment of the present disclosure wherein the housing 12 comprises at least a part 21b of the vacuum path.

Here the housing bottom part 12b comprises a recessed channel 21b, in the illustrated example an elongated, curving channel, arranged to abut the guidance space 13. The channel 21b provides a fluid communication between the collection hole 15a of the collection sheet 15 and a suction outlet of the housing connected to the vacuum pump 21d when the collection hole 15a is arranged at the bottom of the spacer storage compartment 11 to collect a spacer 2 from the bottom of the spacer storage compartment 11. This channel 21b may additionally or alternatively be arranged at the upper part 12a.

The housing 12 may additionally or alternatively comprise a vacuum space, such as a vacuum channel, arranged opposite to a major surface of the collection sheet, wherein the vacuum in the vacuum space provides a suction at the collection hole 15a when the collection hole is arranged at the bottom of the spacer storage compartment to collect a spacer from the bottom of the spacer storage compartment.

It is understood that in some embodiments of the present disclosure, the vacuum path may be designed so that when the collection hole is not arranged at the bottom of the spacer storage compartment, but e.g. is arranged in the guidance space opposite the spacer outlet or in the guidance space between opposing surfaces of the bottom part of the housing and the upper body part, the vacuum/suction in the collection hole may be reduced or omitted/prevented.

The vacuum path may comprises an elongated, curved vacuum channel 21b extending around the rotation axis RAX, such as at least 45° around the rotation axis, for example at least 80° around the rotation axis RAX.

The vacuum path may comprise comprises an elongated, curved vacuum channel (21b) extending less than 270° around the rotation axis RAX, such as less than 190° around the rotation axis RAX.

FIG. 5 illustrates schematically an embodiment of the present disclosure, where the dispenser 10 comprises a part of a sensor system. The sensor system comprises one or more sensors. 22, 23. For example one or more optical sensors, ultrasonic sensor(s) and/or the like. The sensor(s) 22, 23 is/are configured to detect if a collected spacer 2 is present in the collection hole 15a, and the sensor system provides one or more sensor outputs 22a, 23a comprising information of if a collected spacer 2 is present in the collection hole 15a.

In FIG. 5, the spacer sensor 22 is configured to detect if a collected spacer 2 is present in the collection hole prior to the collection hole being arranged opposite to the spacer outlet 16. This may e.g. be provided during the further rotational movement provided in order to move the collected spacer from the storage 11 to the spacer outlet. The spacer sensor 22 provides a sensor output comprising information of if a collected spacer is present in the collection hole 15a.

In FIG. 5, the spacer sensor 23 is configured to detect if a collected spacer 2 is present in the collection hole 15a after the collection hole has been arranged opposite to the spacer outlet 16. The spacer sensor may also be considered/referred to as an unloading sensor. The unloading sensor 23 detects if a collected spacer 2 is present in the collection hole 15a subsequent to the collection hole 15a being arranged opposite to the spacer outlet 16.

The output 22a from the sensor 22 and/or the output 22a from the sensor 23 is received by a controller 22c, such as a hardware processor 22c, such as a micro controller, microprocessor, FPGA or the like. The controller 22c can hence, based on the sensor output 22, determine if a spacer should be dispensed dependent on if a spacer is present in the collection hole 15a or not.

If a spacer 22 was detected in the collection hole by sensor 22, but a spacer was not detected by sensor 23, it may be concluded that a spacer has been collected and dispensed.

If a spacer 22 was detected in the collection hole by sensor 22, but a spacer 2 is still detected by sensor 23, it may be concluded that a spacer has clogged the or the spacer outlet 16 (in the latter case a spacer or a foreign object may clog the spacer outlet 16).

If a spacer 22 was not detected in the collection hole by sensor 22, it may be concluded that the collection sheet did not succeed in collecting a spacer from the storage 11, and a further turn around the rotation axis may be needed to try to collect a new spacer.

Hence, the controller 12c may provide a warning, a control output and/or the like so that the glass sheet will not be moved further before a spacer 2 has been collected and dispensed, it may provide a warning that the glass sheet may not have received the desired number of spacers and/or the like.

In embodiments of the present disclosure, output from the sensor system 22, 23 may be used by a counter (e.g. a counter of the controller 22c) for counting the number of spacers 2 dispensed by the dispenser.

In FIG. 5, the sensor or sensors 22, 23 of the sensor system is/are arranged in and/or supported in the upper body part 12a, such as in a bore or channel 22b, 23b arranged opposite to a major surface 15b of the collection sheet 15 facing away from the spacer outlet 16. In other embodiments of the present disclosure, the sensor or sensors, or a part thereof, may be arranged in the bottom part 12b, such as in the bottom wall comprising the surface 17b (see e.g. FIG. 1a).

The sensor 22 and/or 23 may have a detection/monitoring zone and/or monitoring/detection direction. The sensor(s) 22, 23 may be arranged so that this detection/monitoring zone and/or monitoring/detection direction is placed opposite to the travel path of the collection hole 15a to be able to detect if a spacer is present in the hole 15a. Hence, when the hole 15a travels in it's travel path (or the housing is rotated dependent on the rotation solution), the hole enters in and out of the detection/monitoring zone of the sensor or sensors 22, 23. Hence, when the housing or collection sheet has rotated 360 degrees around the rotation axis RAX, it will have entered the detection zone of the sensor(s) 23, 22.

In some embodiments of the present disclosure, the sensor output may be correlated with information of the rotational position of the housing and/or collection sheet, for in order to determine when the collection hole should be within the monitoring zone.

In embodiments of the present disclosure, the sensor/sensors 22, 23 and/or a controller 22c may be calibrated or in other ways adapted to be able to distinguish between detecting the major surface 15b of the collection sheet and the surface 17b of the housing. In some embodiments, the sensor or sensors 22, 23 may be a distance sensor.

In embodiments, the sensor or sensors 22, 23 may e.g. be sensor(s) configured to provide different sensor output 22a 23a dependent on the characteristics of the surface 15b, 17 and or contact surface 2a/2b. Here, at least two of these surfaces may provide/comprise different surface characteristics that will trigger the sensor(s) to provide different output 22a, 23a. For example based on difference in surface structure, surface colour, surface reflection properties and/or the like. For example one of the surfaces 2a/2b, 17b, 15b may be configured so that it will return an optical sensor signal, such as a changed polarization, when compared to the returned another of the surfaces.

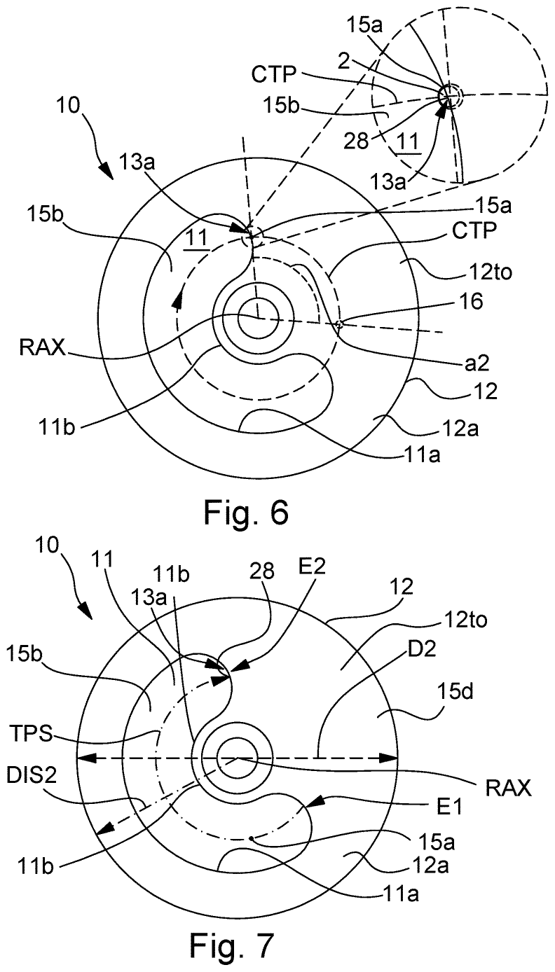

FIG. 6 illustrates schematically a dispenser 10 according to embodiments of the present disclosure, seen towards the housing 12 top 12to. In FIG. 6, the continuous/repeated travel path CTP of the collection hole 15a is illustrated by a dashed circle. The circle continuous/repeated travel path/travelling path CTP has the center coinciding with the rotation axis RAX. In FIG. 6, the collection hole 15 is illustrated at the position where the collection hole 15a with a collected spacer enters into the guidance space 13. See also FIG. 3b. The rotational angle a2 between the collection sheet 15 and the housing 12 around the rotation axis RAX from the storage 11 (may be measured from edge 28) to align the collected spacer 2 in the collection hole 15a opposite to the spacer outlet 16 may in embodiments of the present disclosure be at least 85°, such as at least at least 120°, for example at least 170°.

FIG. 7 illustrates schematically a dispenser 10 according to embodiments of the present disclosure, seen towards the housing 12 top 12to. In this embodiment, the length of the curved traveling path TPS of the collection hole 15a at the bottom of the spacer storage compartment 11 is illustrated.

The length of this travel path TPS is a subset of the continuous/repeated travel path CTP for the collection hole 15 illustrated in FIG. 6.

The length of the travel path TPS in the storage 11 may in embodiments of the present disclosure be at least 0.7 times, such as 0.9 times, such as at least 1.2 times, such as at least 1.8 times, the distance DIS2 between the rotation axis RAX and the outer periphery of the dispenser housing 12. For example, in FIG. 7, as the housing 12 is here depicted as having a circular outer periphery, the length of the collection hole 15b travel path TPS in the storage 11 may be at least 0.9 times, such as at least 1.2 times, such as at least 1.8 times, the housing 12 radius, i.e. D2/2.

In embodiments of the of the present disclosure, the length of the travel path TPS of the collection hole 15a in/across the storage bottom 11 may be more than 90° such as more than 140° such as more than 170°.

It is generally understood that the spacer storage compartment 11 in embodiments of the present disclosure may be integrated in, such as milled into, the upper part, and the storage compartment 11 comprises a loading opening spacer inlet at the dispenser housing 12 top.

In FIGS. 6 and 7, side wall surfaces 11a, 11b of the upper body part 12a abuts and faces the spacer storage compartment 2. The spacer storage compartment 11 is defined between the opposing side wall surfaces 11a, 11b, and the side wall surface 11b facing and enclosing a part of the spacer storage compartment 2, and which is placed proximate the rotation axis RAX is convexly shaped. In the example of FIGS. 6 and 7, a part of the convexly shaped side wall surface 11b is shaped to be coaxial with the rotation axis RAX, in other embodiments, a part of the convexly shaped side wall surface 11b may be shaped to be non-coaxial with the rotation axis RAX. The opposing surface 11a is concavely shaped, it 11a may be shaped to be coaxial with the rotation axis RAX (as illustrated), but in other embodiments it 11a may not be coaxial with the axis RAX.

As can be seen from among others FIGS. 6-7, the wherein the spacer storage compartment may in embodiments of the present disclosure be elongated and extend partly around the rotation axis RAX, and this may provide that the spacer storage compartment 11 is arc shaped, and may be longer (e.g. defined by length of the travel path TPS) than it is wide. The opposing side walls are connected at end parts of the storage 11.

In embodiments of the present disclosure, the storage 11 may as e.g. illustrated in FIGS. 6 and 7 be shaped and placed so that the collection hole 15a enters the compartment at one storage compartment 11 end E1. The hole 15a then leaves the storage at the other/another storage compartment 11 end E2 below/opposite to the edge 28 with a collected spacer therein.

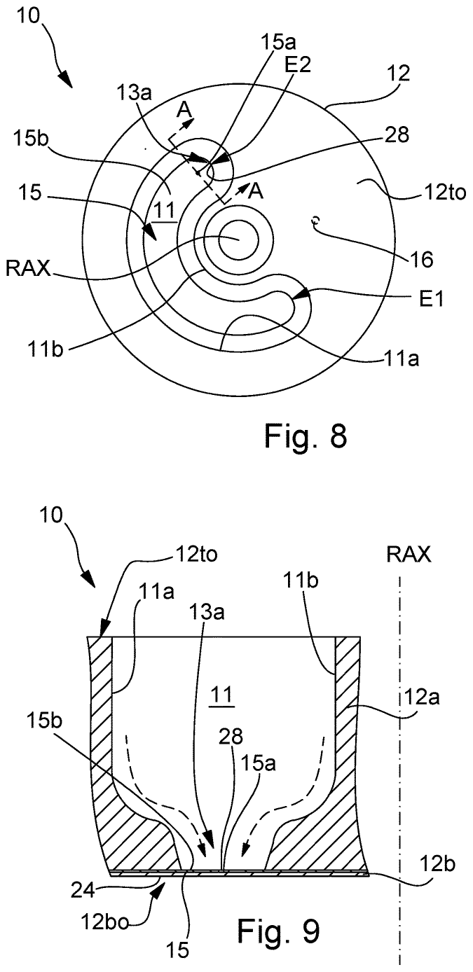

FIGS. 8 and 9 illustrates schematically embodiments of the dispenser according to embodiments of the present disclosure, where the side wall surfaces 11a, 11b enclosing the spacer storage compartment 11 narrows in a direction towards the disc shaped collection sheet 15 surface 17b. Hence, the distance between the surfaces 11a, 11b may reduce, such as gradually reduce, towards the collection sheet 15. This may e.g. provide a funnel shaped storage compartment 11.

FIG. 8 illustrates the dispenser seen towards the dispenser housing top 12to, and FIG. 9 illustrates schematically a cross sectional view A-A of a part of the housing 12 illustrated in FIG. 8, seen in a direction towards the storage 11 end E2 and towards the entrance 13a for the collection hole 15a to the guidance space.

The narrowing of the walls 11a, 11b in a direction towards the disc shaped collection sheet 15 surface 15b This provides, in FIGS. 8 and 9, that the compartment 11, proximate the housing top 12to may be larger than at the compartment bottom proximate the sheet surface 15b as e.g. illustrated in FIG. 9.

In embodiments of the present disclosure, the volume of the uppermost 25% of the storage compartment 11 proximate the housing 12 top 12to may be at least 10% such as at least 30% such as at least 50% larger than the volume of the lowermost 25% of the storage compartment 11 proximate the sheet 15 surface 15b at the storage bottom.

This provides that over time when spacers 2 are collected from the storage 11 by means of the hole 15a, the spacers in the storage 11 will be gradually guided towards the storage bottom at the sheet surface 15a, and the funnel shape may moreover provide that the spacers at the lower parts of the storage are guided towards the travel path of the collection opening as illustrated by dashed arrows in FIG. 9.

Gravity acts on the spacers 2 in the storage 11 and provides that the weight of the spacers 2 in the storage acts towards the sheet surface 15a, which may help, e.g. together with the funnel shape (if present), to increase the chance of collecting a spacer by the collection hole 15a.

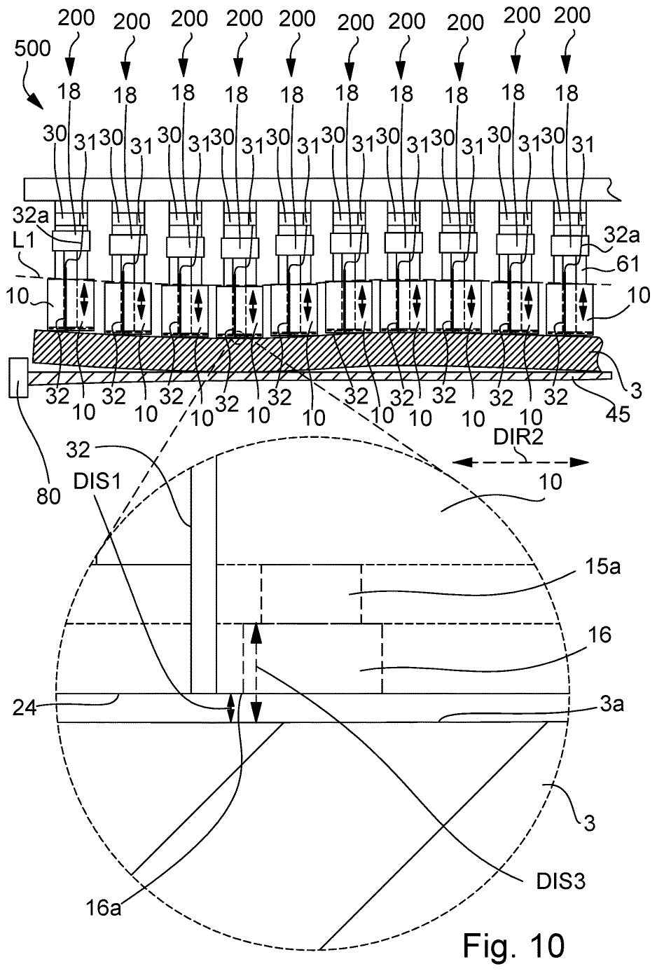

FIG. 10 illustrates schematically an embodiment of the present disclosure wherein a plurality of dispensers 10 of dispenser systems 200 are arranged in an array 500, in this case side by side, transverse to the movement direction of the glass sheet (or the array 500) in a direction along the glass sheet surface 3.

Hence, the dispensers 10 of the array may dispense a row of spacers, for example simultaneously, onto the glass sheet surface. This may e.g. increase manufacturing speed when compared to using only one or a few dispensers to place the spacers at the glass sheet surface 3a.

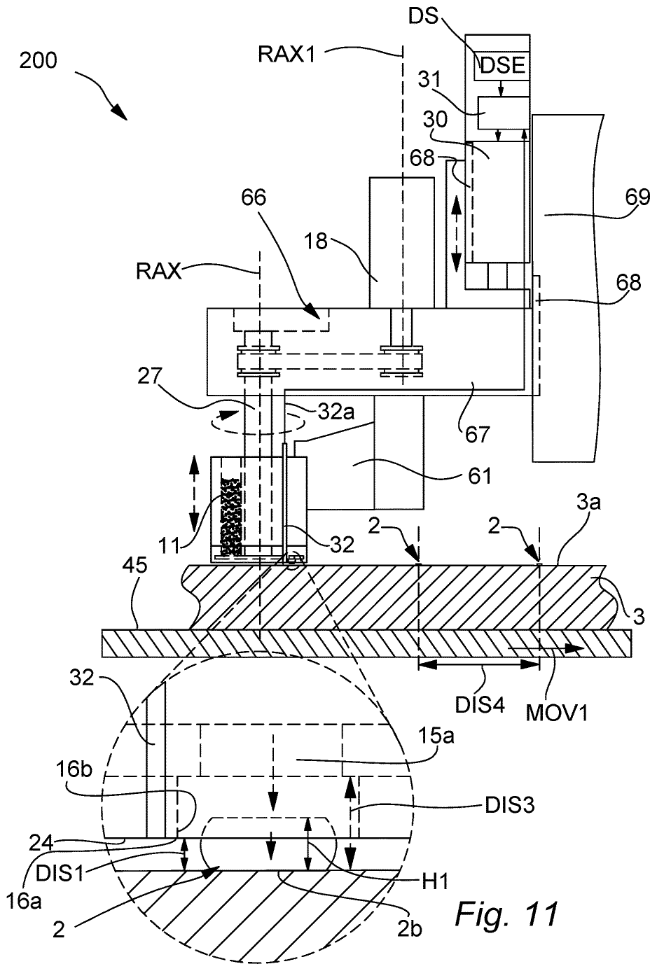

The dispensers are arranged e.g. side by side in a dispenser distribution direction DIR2 that may be transverse to the movement MOV 1 (see e.g. FIG. 11) direction with which a motor or the like provides a relative displacement between the array 15 and the glass sheet 3 along the glass sheet surface 3a.

The array 50 may in embodiments of the present disclosure comprise between 4 dispensers and 80 dispensers, such as between 4 dispensers and 50 dispensers, such as between 4 dispensers and 30 dispensers. Each dispenser may be part of/comprised in an individual spacer dispensing system 200.

The spacer dispensing systems 200 may each comprise a spacer storage 11, for example a spacer storage arranged in the housing 12 as previously described, and the storage 11 comprises a plurality of spacers 2. Moreover, the spacer dispensing system 200 may comprise a dispenser 10, such as a dispenser of the type described above in accordance with various embodiments. Each dispensing system 200 comprises a spacer outlet 16 for dispensing spacers 2 collected from the spacer storage 11, In the illustrated embodiment a spacer outlet 16 provided in a dispenser housing 12.

In FIG. 10, each dispensing system 200 also comprises a distance adjustment motor 30 configured to move the spacer outlet 16 of the respective system 200 towards and/or away from the glass sheet surface 3a. In other embodiments of the present disclosure, the motor 30 may be omitted, and the outlets may hence not be moved towards or away from the glass sheet surfaces, at least not individually.

Distance controllers 31 are configured to control distance adjustment motors 30 to move the spacer outlet 16 towards and/or away from the glass sheet surface 3a during the spacer placement sequence based on output 32a from a distance sensor 32. This distance control is configured so as to adapt the surface 3a to spacer outlet 16 distance DISI to the local surface topology of the major glass sheet surface 3 opposite to the spacer outlet 16 one or more times, such as continuously, during a spacer placement sequence.

It is generally understood that a spacer placement sequence comprises placing a plurality of spacers 2 at the major glass sheet surface 3a by means of the dispenser(s) 10. Here, the spacer placement sequence comprises providing relative movement between the glass sheet surface 3a and the spacer outlet 6 in a direction along the glass sheet surface by means of a displacement motor 80, such as an electrical motor, and distributing a plurality of spacers 2 from the spacer storage 11 with a mutual spacer distance DIS4 (see FIG. 11) on the glass sheet surface 3a by means of the dispenser 10 through the spacer outlet 16.

The glass sheet is placed on a support 45, such as conveying means, for example a movable table or plate, a conveyer band or chains, rollers and/or the like, e.g. so that the surface 3a extends horizontally, and the motor 80 moves the glass sheet relative to the systems 200. In other embodiments, the motor 80 may be configured to move the array 500/system(s) 200 instead.

In the example of FIG. 10, the array 500 may place/dispense, such as drop, a row of spacers 2 onto the surface, then the glass sheet 3 (or array) is moved a predetermined distance, a new spacer 2 row is dispensed and so on until the desired amount of spacers are distributed at the surface 3a. Instead of stepwise, predefined movement of the glass sheet or array, a continuous movement may also be provided and the dispensing of spacers may be timed according to the relative displacement speed along the surface 3a.

The distance control so as to control the outlet distance DIS1 may be provided to adapt to varying glass sheet topology.

For example, the glass sheet 3 may be a tempered glass sheet, for example a thermally tempered glass sheet. Such glass sheets may provide advantages with regards to strength, and tempered glass sheets may be cost efficient. However, for example thermally tempered glass may have a glass sheet surface 3a with an unevenness of at least 0.1 mm, such as at least 0.2 mm, for example at least 0.3 mm.

In some embodiments, the glass sheet 3, 4 surface 3a, 4a unevenness may even be equal to or larger than the spacer height H1.

The distance controller 31 help to provide that the dispenser outlet 16 can get close enough to the glass sheet surface 3a to reduce the risk of spacer 2 misplacement during the spacer placement sequence when arranging spacers s on the glass sheet surface.

For example, the distance setting may be set to e.g. 0.1 mm, and hence, the distance controller provides adjustment/adaption of the spacer outlet 16 to glass surface 3a distance during the spacer placement sequence so that the outlet is maintained substantially at 0.1 mm from the glass sheet surface during spacer dispensing in spite of the glass sheet surface being uneven.

In one or more embodiments of the present disclosure, the distance controller 21 controls the distance adjustment motor 30 to move the spacer outlet 16 towards and/or away from the glass sheet surface during the spacer placement sequence based on a distance setting DSE and output from a distance sensor.

In one or more embodiments of the present disclosure, distance sensor 32 may comprise an optical sensor, such as a fibre optic sensor, or an ultrasonic sensor or another suitable type of sensor.

The spacers 2 are placed one by one, consecutively, at the glass sheet surface 3a by means of the respective dispenser, see also FIG. 11. A relative movement between the glass sheet surface 3a and the spacer outlet in a direction along the glass sheet surface by means of a displacement motor is provided between each consecutive placement of a spacer by means of the dispenser.

The distance controller may comprise one or more hardware processors, such as one or more microcontrollers, Field-Programmable Gate Arrays (FPGA), Programmable Logic controllers (PLC), microprocessors and/or the like. For example, the hardware processor may comprise one or more general-purpose hardware processors.

Generally, a system controller (not illustrated in FIG. 10) comprising one or more hardware processors (such as one or more of the above mentioned types) may based on a computer implemented software program and control circuitry control the movement and/or movement speed of the displacement motor and the dispensing of spacers, e.g. in order to time the spacer dispensing and start/stop and/or movement speed of the displacement motor. The system controller may e.g. control one or more of the displacement motor 80, a drive motor 18, a vacuum pump 21d, a compressor for providing pressurized air a and or the like as described in this document based on a computer implemented software program in a data storage and possibly also one or more sensor input. Such sensor input may comprise be position information, speed information, input from sensors detecting if a spacer has been collected and/or dispensed, and/or the like.

In some embodiments of the present disclosure, the distance controller 31 and the system controller may be the same controller or may be provided by means of different hardware controllers, such as distributed hardware controllers.

For example, in some embodiments, the distance adjustment motor, such as a servo motor, may comprise a hardware controller and regulation circuitry, and may handle the distance control based on direct sensor input or sensor input suppled from another hardware controller. Such a controller may e.g. receive distance-setting input supplied from e.g. a separate hardware controller.

As can be seen in FIG. 10, the dashed line LI illustrates that the dispensers 10 have been adapted in height relative to the glass sheet surface, so that each outlet 16 has substantially the same distance DIS1 to the glass sheet surface 3a, and hence, the dispensers 10 are displaced/height adjusted individually relative to a horizontal plane (not illustrated).

In embodiments of the present disclosure, the distance controller(s) 31 maintains/provides a maximum distance DIS1 between the spacer outlet 16 and the glass sheet surface 3a of less than 0.6 mm, such as less than 0.3 mm, such as less than 0.2 mm based on the output 32a from the distance sensor 32, at least when the spacers 2 are delivered, such as dropped, onto the glass sheet surface 3a.

In one or more embodiments of the present disclosure, the distance controller(s) 31 may maintain a minimum distance between the spacer outlet and the glass sheet surface, such as a minimum distance of at least 0.05 mm, such as at least 0.1 mm during the spacer placement sequence.

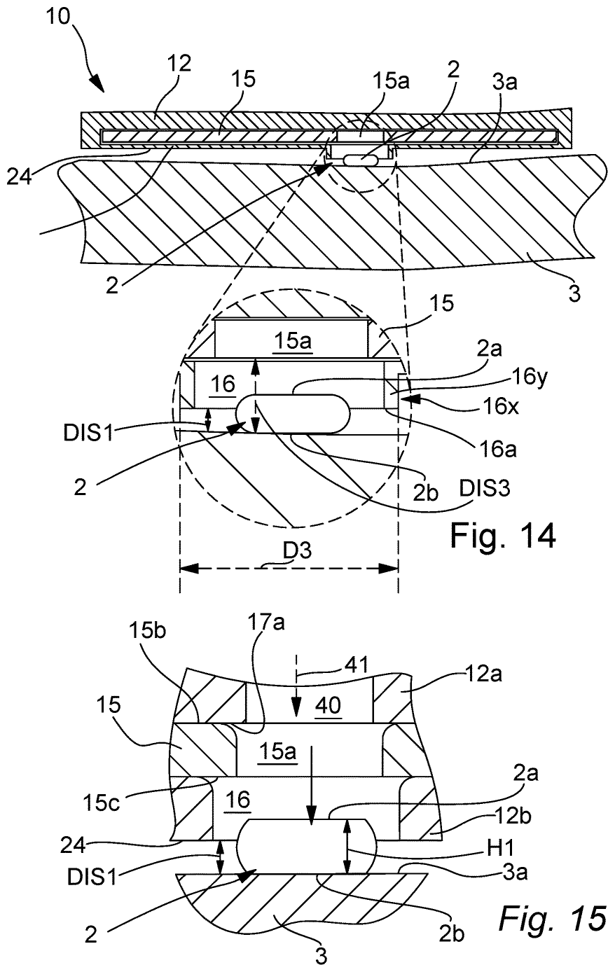

It is understood that the spacer outlet may comprise an outermost outlet surface 16a facing the glass surface 3a and being proximate the glass. In the embodiment of FIG. 10, this outlet surface 16a is provided by a major dispenser bottom part surface 24, but it may also be provided by a spacer nozzle outlet (see FIG. 14) having an outer diameter that is less than the diameter of a housing of the dispenser.

In several of the figures described above, the disc shaped collection sheet 15 is arranged at the lower fourth, such as the lower sixth, such as the lower eighth of the housing 12, proximate the bottom wall 24a of the housing.

In embodiments of the present disclosure, the distance DIS3 between the glass sheet surface 3a and the major surface 15c of the collection sheet 15 facing the glass sheet surface 3a may be less than 10 mm, such as less than 5 mm or less than 3 mm, such as less than 1 mm, at least while the spacer 2 is dropped towards the glass sheet surface. This distance DIS3 will vary together with the distance DISI upon distance adjustment by the motor 30.

In FIG. 10 (and FIG. 11) the distance controller 31 provides the control of the distance adjustment motor 30 to move the spacer outlet 16 towards and away from the glass sheet surface 3a by moving the housing 12 towards and away from the glass sheet surface 3a.

In one or more embodiments of the present disclosure, the horizontal distance between adjacent spacer outlets 16 in the spacer array 500 may be between 20 mm and 70 mm, such as between 25 mm and 45 mm. This In this case, the adjacent outlets 16 are aligned and abuts the same horizontal plane.

In one or more embodiments of the present disclosure, the horizontal distance between adjacent spacer outlets of more than 50% or more than 60% of the spacer outlets of the spacer dispensing array 500 may be between 20 mm and 70 mm, such as between 25 mm and 45 mm.

FIG. 11 illustrates schematically a dispensing system 200 according to further, various embodiments of the present disclosure.

The distance controller 31 comprises distance regulation circuitry. This may provide closed loop distance control, such as by means of one or more of Proportional, Integral and/or derivative (PID) control. This closed loop control is based on the output 32a from the distance sensor 32 and at least a distance setting DSE stored in a data storage DS during the spacer placement sequence. Naturally, other regulation settings may be stored in the data storage that may be used by the controller 31. The controller 31 hence may control the distance adjustment motor 30 based on the setting DSE and the sensor output 32a during the spacer placement sequence.

The distance controller 31 may monitor a distance representative of a distance DIS1 between the glass sheet surface 3a and the spacer outlet 16. For example, a predefined distance may be used for the monitoring, and this distance may e.g. be larger than the distance DIS1. This may e.g. be acceptable as long as a distance offset is known.

In one or more embodiments of the present disclosure, the distance setting DSE comprises one or more distance set points such as a distance target setting or a distance range setting representing a desired distance.

The distance sensor 32 may in embodiments of the present disclosure monitor the distance DIS1 between the glass sheet surface 83a and the spacer outlet 16 directly or indirectly.

The dispenser housing 10 is attached to a dispenser holding part 61 of the dispenser system 200. The dispenser holding part 61 is attached to or integrated in a height adjustable movable frame part 67. This part 67 that can be displaced vertically by the motor 31 relative to a fixed frame part 69. The movable frame part 67 is connected to, such as attached to, the fixed frame part 69 by means of a displaceable connection such as a rail solution, an actuator and/or the like 68. The movable frame part 67 may thus hang directly or indirectly from the fixed frame part 69. The fixed frame part may in embodiments of the present disclosure comprise a plurality of dispensing systems 200, such as an array 500 as previously described.

The drive motor 18 may as illustrated, in embodiments of the present disclosure, be attached to the movable frame part 67.

FIG. 11 moreover discloses an embodiment of the present disclosure, wherein the rotation axis RAX1 of the drive motor 18 is displaced, in this embodiment displaced parallel, relative to the rotation axis RAX. Hence, the dispenser system 200 may comprise an interconnecting drive arrangement 66 comprising one or more of a chain drive, belt drive, a toothed wheel system such as a gearing system and/or the like which transfers the rotary motion of the motor 18 to the collection sheet 15 through the shaft 27. The dispenser 10 is in FIG. 11 placed below a movable frame part 67.

FIG. 11 illustrates a further embodiment of the present disclosure, wherein the distance controller 31 controls the distance DIS1 between the glass sheet surface 3a and the spacer outlet 16 to be less than the spacer height H1 of the spacers 2 (H1>DIS1), at least while the spacers 2 are delivered to, such as dropped onto, the glass sheet surface 3a by the dispenser. A wall surface or an edge/corner 16b of the dispenser 10, which encloses the dispenser 10 outlet 16, prevents the dispensed spacer 2 from rolling, bouncing or the like beyond the outer periphery described by the dispenser opening 16. The spacer outlet opening size and/or shape may thus defines define the maximum limit for a possible spacer movement and displacement of the spacer during dispensing the spacer, for example until the spacer rests as desired on the glass sheet surface.

During the spacer placement sequence, the distance controller 31 may hence lift the dispenser(s) away from the glass sheet surface 3a, the displacement motor may then provide a (e.g. predefined) relative displacement MOV1 between the spacer outlet(s) 16 and the glass sheet, The outlet(s) 16 may then be lowered again by the distance controller 31 so that the DIS1 between the glass sheet surface 3a and the spacer outlet 16 is less than the spacer height Hl of the spacers 2 (H1>DIS1) while the spacers 2 are delivered to, such as dropped onto, the glass sheet surface 3a by the dispenser. This may continue until all spacers 2 have been placed on the major glass sheet surface 3a in the spacer placement sequence.

It is to be understood the dispenser 10 used in the system(s) 200 according to various embodiments of the present disclosure where individual distance control is provided by one or more controllers 31 as e.g. described above in relation to FIGS. 10 and/or 11, may in embodiments of the present disclosure be of the rotary type as e.g. described according to various embodiments above and/or further below. However, in other embodiments of the present disclosure, the dispensers 11 used in the system(s) 200 where for example distance control is provided may be of another type such as of the reciprocating collection member/sheet dispenser type or another type.

The distance sensor 32 may in embodiments of the resent disclosure be attached to the dispenser housing, and hence move together with the housing when the motor 30 displaces the housing towards and away from the glass sheet surface 3a.

In some embodiments, the sensor 32 may be arranged in the housing 12 of the dispenser 10. In other embodiments it may be attached to/at the outside of the dispenser 10 housing. In still further embodiments of the present disclosure, the sensor 32 may be attached directly or indirectly to the height adjustable movable frame part 67 for example attached to the dispenser holding part 61.

In FIG. 10, the spacer dispensing array 500 comprises a plurality of spacer dispensing systems 200, for example a plurality of systems 200 as illustrated in FIG. 11. A distance controller 31 provides an individual adjustment of the spacer outlet 16 of the dispenser 10 of the respective spacer dispensing system 200 of the dispensing array in a direction towards and/or away from the glass sheet surface 3a. This is based on output 32 from a plurality of distance sensors 32 during the spacer placement sequence. For example,, each dispensing system 200 may comprise its own sensor assigned to provide sensor output for use as a regulation parameter for the dispenser comprised in that system.

As can be seen from FIG. 10 the plurality of spacer dispensing systems 200 of the array 500, such as all spacer dispensing systems 200 of the array 500, may each comprises an individual distance controller 31 for providing distance regulation of the spacer output 16 of the respective system. wherein the individual distance controller 31 may hence individually, directly or indirectly, monitor the distance DIS1 between the glass sheet surface 3a and the spacer outlet 16 of the dispenser 10 of the respective individual spacer dispensing system 200 based on output from a distance sensor 32a. Each individual distance controller 31 may hence in embodiments of the present disclosure individually control the/an individual distance adjustment motor 30 to move the spacer outlet 16 of the dispenser 10 of that spacer dispensing system 200 towards and/or away from the glass sheet surface 3a, for example during the spacer placement sequence.

The individual distance adjustment by means of a distance controller may be based on sensor output 32a from an individual distance sensor 32 assigned each spacer dispensing system 200. In other embodiments, sensor output from a single sensor 32 may be used as input for regulating spacer outlets 16 of two or more systems. For example, adjacent dispensers may be placed close enough so that a single sensor input may be suable for providing spacer outlet 16 to glass sheet surface 3a distance control. The reason for this may be that the surface variation of the surface 3a may not vary so much per distance, and/or the outlet may not be arranged so close DIS1 to the surface 3a during dispensing, that the surface variation within the spacer distance DIS4 may be critical or become an issue. Hence, for example, in some embodiments, the sensor output 32a from a single sensor 32 may be used for, for example common, distance regulation of two or more adjacent dispenser outlets of the array 500, such as for example between two and six, such as between two and four, for example between 2 and 3, adjacent distance outlets (16). This regulation may be provided by e.g. providing a single motor 30 for regulating outlet 16 to glass sheet surface 3a distance of a plurality of spacer outlet 16 of adjacent dispensers 10 during the dispensing sequence. In such embodiments (not illustrated), these dispensers may be attached to and moved by means of a common movable frame part 67.

In one or more embodiments of the present disclosure, the spacer outlets 16 of the dispensing systems 200 are arranged in a line extending transverse to, such as perpendicular to, the direction of the relative movement MOV1 between the glass sheet surface and the spacer outlet along the glass sheet surface provided by means of a displacement motor 80. In other embodiments, the outlets may be e.g. arranged staggering transverse to, such as perpendicular to, the direction of the relative movement MOV1.

Generally, in one or more embodiments of the present disclosure, the distance DIS4 between adjacent dispensed spacers on the glass sheet surface 3a along the movement direction MOV, such as between more than 50% or more than 60%, such as more than 90% of the dispensed spacers 2 may be between 20 mm and 70 mm, such as between 25 mm and 45 mm.

Generally, in one or more embodiments of the present disclosure, the distance DIS4 between adjacent dispensed spacers on the glass sheet surface 3a transverse to the movement direction MOV, such as between more than 50% or more than 60%, such as more than 90% of the dispensed spacers 2 may be between 20 mm and 70 mm, such as between 25 mm and 45 mm.

Generally, the distance DIS4 between more than 60%, such as more than 90% or more than 95% of all the dispensed adjacent spacers 2 on the glass sheet surface 3a may in one or more embodiments of the present disclosure be between 20 mm and 70 mm, such as between 25 mm and 60 mm, such as between 25 mm and 45 mm.

It is to understood that in other embodiments of the present disclosure, no distance adjustment may be provided by means of the distance controller during the spacer placement sequence. Hence, for example, the spacer outlet(s) 16 may be maintained a predefined distance from the support 45 (at least corresponding to the glass sheet thickness+spacer height+a smaller distance for clearance). A distance controller may hence adapt the distance DIS1 to fit the glass sheet height and spacer height, but may not provide adjustment during the spacer placement sequence as such. The smaller distance for clearance may in embodiments of the present disclosure be at least half the spacer height H1 (H½) or at least H1×2. It may however in embodiments be less than H1×30 such as less than H1×20 or less than H1×10 or less than H1×5.

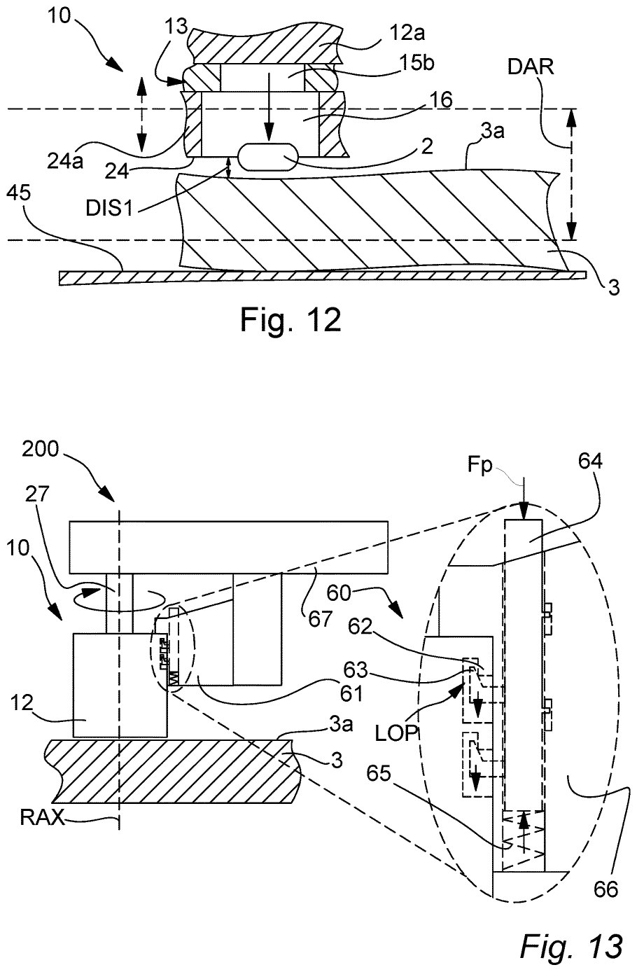

FIG. 12 illustrates schematically an embodiment of the present disclosure, wherein the distance controller 31 is configured to control the distance adjustment motor 30 to move the spacer outlet 16 within a predefined distance DIS1 adjustment range DAR based on the output 32a from the distance sensor 32 during the spacer placement sequence. The distance adjustment range DAR may in embodiments of the present disclosure be at least 0.5 mm, such as at least 1.5 mm, such as at least 10 mm.

The distance adjustment range DAR may in embodiments of the present disclosure be between 0.3 mm and 100 mm, such as between 0.5 mm and 60 mm, such as between 1 mm and 10 mm.

The distance adjustment resolution enabled by the controller 31 and the mechanical and electrical setup (see e.g. 30, 68, 67 of FIG. 11) for moving the outlet 16 towards and/or away from the glass sheet may be less than 0.15 mm such as 0.1 mm or less, such as less than 0.08 mm or less than . 05 mm. Hence, for example for a distance adjustment resolution of 0.1 mm, the minimum movement the distance adjustment system and the outlet 16 can provide towards and away from the glass sheet surface 3a is 0.1 mm. It may be preferred that the sensor 32 provides a measurement sensitivity that is adapted to the distance adjustment range.

The distance controller 31 may comprise analog and/or digital control circuitry. For example, an analog circuity may be used for the sensor 32 output 32a, and an analog-to-digital (ADC) converter may provide transformation of the measured information into a digital signal. The ADC may be adapted to fit the desired distance DIS1 adjustment range DAR and/or desired distance adjustment resolution or vice versa.

FIGS. 11 and 13 illustrates schematically embodiments of the present disclosure wherein the housing 12 of the dispenser 10 is attached to a dispenser holding part 61 of the dispenser system 200. The holding part 61 holds/fixates the housing 12 in a fixed, un-rotational position and the shaft 27 hence rotates the collection disc 15 inside the housing. If the height adjustment 31 is provided in embodiments of the present disclosure as e.g. described above, the holding part 61 may be attached to or be integrated in adjustable movable frame part 67. The dispenser holding part 61 is separate to a shaft 27 for rotating the disc shaped collection sheet 15 and/or the housing 12 around the rotation axis RAX.

Generally, in one or more embodiments of the present disclosure, the distance DIS1 between the spacer outlet 16 and the glass sheet surface 3a may be less than 0.3 mm, such as less than 0.2 mm, for example 0.15 mm or less while the spacer is dispensed towards the glass sheet surface.

FIG. 13 illustrates a further embodiment of the present disclosure, wherein a quick release locking system 60 is provided for enabling quick release of the housing 12 from the system 200. In FIG. 13, the quick release locking system is a spring 65 loaded locking system where the quick release locking system 60 comprises an actuation member 64 to be operated to actuate the locking system 60.

The spring-loaded locking system comprises one or more springs 65. In FIG. 13 the system comprises a compression spring, but it is understood that it in other embodiments may be or comprise a torsion spring and/or extension spring. The spring(s) 65 may e.g. be a metal spring and/or a coil spring.

The locking system 60 may be configured for tool-less mounting and dismounting of the dispenser. For example, releasing of one or more screws or bolts by means of a screwdriver or a spanner may not be necessary. the quick release locking system 60 comprises one or more movable locking parts such as locking bolts 63, that is/are spring loaded by the spring 65. The locking bolt(s) 63 is/are configured to be moved between a locking position/state LOP (as illustrated) and an unlocking position/state. In the locking position/state LOP, the locking bolt(s) 63 provides an attachment of the housing 12 of the dispenser 22 to the dispenser holding part 61 by engaging an engagement member 62 such as a strike part 62 of the housing 12. In other embodiments, the dispenser, such as the housing 12, may comprise the spring loaded member 64.

In the unlocking position, the one or more movable locking bolts 63 disengages the engagement member 62 and thereby provides a release of the housing 12 of the dispenser 22 so as to enable removing the dispenser 10 housing 12 from the dispenser holding part 61. In FIG. 13, the engagement member 62 is integrated in the housing, but the housing may also in other embodiments comprise a separate part that is attached to the housing 12 which comprises the engagement member 62.

The actuation member 64 is configured to be pushed by means of a force (Fp), such as by hand or a pushing tool, to move the one or more movable locking bolts 63, between the locking position LOP and the unlocking position. In FIG. 12, this movement will be a linear movement, but in other embodiments it may additionally or alternatively comprise a rotational movement of the actuation member 54 to switch between the locking position LOP and the unlocking position/state.

FIG. 14 illustrates schematically a spacer outlet of the dispenser 10 according to embodiments of the present disclosure, where the dispenser outlet comprises a dispenser outlet nozzle 16x with a nozzle wall 16y extending from the dispenser towards the surface 3a. The nozzle wall 16y may e.g. be annular. The nozzle 16x wall 16y has an outer width D3, such as diameter, that is less than the outer housing width D2 (see e.g. FIG. 1) of the dispenser 10. For example, the outer outlet width D3 may be less than 1/10, such as less than 1/20, such as less than 1/30 of the housing width D2.

The distance DIS1 (see e.g. FIG. 10) between the spacer outlet 16 and the glass sheet surface 3a may thus be defined between that outermost outlet surface 16a provided by the nozzle wall 16y that is proximate the glass sheet surface 3a, and the glass sheet surface 3a opposite the outlet 16. The distance DIS3 between the glass sheet surface 3a and the major surface 15c of the collection sheet 15 facing the glass sheet surface 3a may, in some embodiments of the present disclosure, despite the presence of the nozzle 16x be less than 10 mm, such as less than 5 mm, for example less than 3 mm, or less than 1 mm.

It is generally understood that in some embodiments of the present disclosure, the spacer outlet 16 and/or the collection hole 15a may be un-chamfered at the edge transition between a major surface of the wall 24a and/or the sheet surface(s) 15c, 15b and the respective opening 15a, 16. This is e.g. illustrated in some of the figures described above.

FIG. 15 illustrates schematically an embodiment of the present disclosure wherein both the collection hole 15a and the outlet 16 are chamfered. The chamfering is, for the collection sheet 15, in FIG. 15, provided at the edge transition between the major surface 15b and the surface enclosing the collection hole.

A chamfering may additionally or alternatively (not illustrated) be provided at the edge transition between the major surface 15c and the surface enclosing the collection hole.

In FIG. 15, the chamfering is provided between the major surface of the bottom wall 24a facing the collection sheet 15, and the surface enclosing the spacer outlet 16 hole.

However, it is understood that in other embodiments, the spacer outlet 16 and/or the collection hole 15a may be chamfered, for example at the edge transition between a major surface of the wall 24a and/or the sheet surface(s) 15c, 15b and the respective opening 15a, 16. The outlet 16 may additionally or alternatively (not illustrated) be chamfered at the transition between surface 16a and the wall surface 24.

FIG. 15 illustrates a further embodiment of the present disclosure, wherein the dispenser 10 comprises a fluid outlet 40 for pressurized gas such as air. This fluid outlet 40 is may e.g. be arranged opposite to the spacer outlet 16 as illustrated. Pressurized gas is provided e.g. by means of a compressor (not illustrated) through the fluid outlet 40 in the housing 12 in order to provide a blowing force onto the collected spacer 2 in the collection hole to help the collected spacer leave the collection hole 15a and the outlet 16. The housing may comprise an air inlet for the pressurized air, e.g. at the top part 12a of the housing 12 (see previous figures), and an air duct/path may lead towards the outlet 40, such as an outlet nozzle, for the pressurized air.

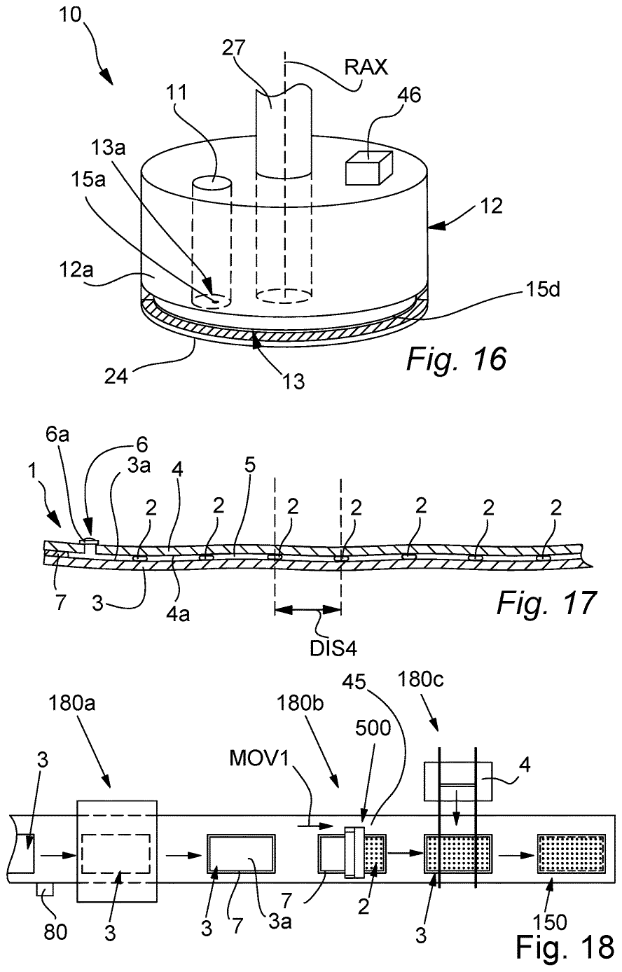

FIG. 16 illustrates schematically a spacer dispenser 10 comprising a vibrator 46 according to embodiments of the present disclosure. The vibrator 45 is controlled by a hardware controller to vibrate (e.g. a central system controller or a distributed controller of at a dispensing station). This provides that at least a part of the dispenser 10, such as the dispenser housing and/or the collection sheet 15 vibrates. This may in embodiments of the present disclosure help to increase the chance of a spacer moving into the collection hole. The vibrations may be provided by the vibrator 46 while the collection hole moves through/swipes the storage 11 bottom. Additionally or alternatively, the vibrations may provide that the spacers 2 are “shaken” and moves inside the storage to chance e.g. orientation. The vibrations provided by the vibrator 46 may in embodiments of the present disclosure be above 1 Hz, such as above 100 Hz, such as above 1000 Hz. The vibrations provided by the vibrator 46 may in embodiments of the present disclosure be between 0.5 Hz and 10000 Hz, such as between 1 Hz and 1000 Hz, for example between 5 Hz and 500 Hz or between 50 Hz and 1000 Hz.

The vibrator 46 may in embodiments of the present disclosure comprise a motor with an unbalanced mass such as an unbalanced flywheel. I other embodiments of the present disclosure, the vibrator 46 may be of the Linear Resonant Actuator (LRA) vibrator type.

In FIG. 16, the vibrator is illustrated as being attached to the housing. In other embodiments, it may e.g. be attached to the shaft 27.

FIG. 17 illustrates a further embodiment of the present disclosure, wherein the spacer storage compartment 11 has a circular shape as opposed to the previously described elongated shape. the spacer storage compartment 11 may in further embodiments of the present disclosure comprise another shape such as a polygonal shape, for example a rectangular shape, a triangular shape, a hexa-or pentagonal shape or the like. In still further embodiments, the compartment 11 may have a tapering shape in a direction towards the spacer exit 13a.

FIG. 17 illustrates schematically a vacuum insulated glass (VIG) unit 1 according to embodiments of the present disclosure.

The VIG unit 1 comprises the first glass sheet 3a having a first major surface 3a, and a second glass sheet 4 comprising a second major surface 4a. These major glass sheet surfaces 3a, 4a faces each other and the evacuated gap 5. The spacers 2 arranged on the surface 3a by means of the dispensing system(s) 200 comprising the dispenser 10 according to various embodiments described above are placed in the gap 5.

The glass sheets 3, 4 are sealed together at the periphery of the glass sheets 3, 4 with the plurality of dispensed spacers arranged between the major surfaces 3a, 4a in the gap 5. The sealing together of the first and second glass sheets may comprise use of an edge seal material 7 such as a solder glass edge seal material or a solder metal edge seal, or it may comprise fusing the glass sheets directly together. In some embodiments, the sealing together may comprise locally heating at least at the edge seal location, or heating the entire VIG unit assembly to a desired temperature in e.g. a furnace. The sealing together of the glass sheet 3, 4 edges may provide a fused, rigid edge seal. Other airtight edge seal solutions may alternatively be provided.

The glass sheets 3, 4 may be annealed glass sheets or tempered glass sheets, such as thermally tempered glass sheets. One or both glass sheets 3,4 may have a thickness between 1 mm and 6 mm, such as between 2 mm and 4 mm, for example between 2,5 mm and 3,5 mm including both end points. The glass sheets 3, 4 may be of the same or different thickness.

The gap 5 has been evacuated to a reduced pressure. In embodiments of the present disclosure, the pressure in the gap 5 may be below 0.05 mbar, such as below 0.005 mbar, such as 0.003 or 0.001 mbar or below. This may be obtained by means of an evacuation pump (not illustrated. For this evacuation of the gap, the pump may have been connected directly or indirectly to an evacuation outlet 6, and after the evacuation, the evacuation outlet 6 is sealed by a sealing 6a, such as at least partly by means of a solder material. In FIG. 17, the evacuation outlet 6 is illustrated in a glass sheet, in other embodiments, the evacuation outlet may be provided in the edge seal material or between the edge seal material and one of the glass sheets 3, 4. In some embodiments, the evacuation of the gap 5 may be provided by means of a suction cup arranged to cover an evacuation opening 6. In other embodiments, the evacuation may be provided inside an evacuation chamber, such as where the entire VIG unit assembly is placed inside the evacuation chamber. In some situations, the sealing of the gap and/or fusing at the edges by an edge seal may also be obtained in such a vacuum chamber.

The spacers 2 placed by means of the dispenser(s) 10 maintains a distance between the glass sheet surfaces 3a, 4a across the evacuated gap when the gap has been evacuated. The distance between the glass sheet surfaces 3a, 4a may in embodiments of the present disclosure be 0.5 mm or below, such as 0.3 mm or below, for example 0.2 mm or below.

The evacuation of the gap 5 may in embodiments of the present disclosure be provided by means of one or more one or more of: a vacuum chamber, such as a vacuum chamber containing the entire VIG unit assembly therein, one or more vacuum pumps in communication with the gap, for example by means of a suction cup. Additionally, one or more getters may be arranged in the gap to provide further pressure reduction in the gap and/or to maintain vacuum integrity.

FIG. 18 illustrates schematically a manufacturing line for a VIG unit according to embodiments of the present disclosure. The first glass sheet 3 first enters a first station 180a where edge seal material 7 such as solder glass edge seal material or metal solder edge seal material is provided to the upwardly facing major surface 3a.

Then the glass sheet 3a is moved to a spacer placement station 180b where one or more spacer dispensers 10, such as a dispenser system array 500 as previously described, dispenses spacers onto the major surface 3a. This is provided so that the spacers 2 are provided with a mutual distance DIS4 in rows and/or columns on the glass sheet surface 3a, or in another desired pattern. The relative movement MOV1 may be provided by means of a motor 80 as e.g. previously described. The previously described spacer placement sequence to place the spacers 2 at the surface 3a may be provided at the station 180b.

At glass pairing station 180c, the glass sheets 4 and 3 are paired by placing the second glass sheet 4 on top of the first glass sheet 3 to cover the spacers 2. The glass sheet 4 may e.g. rest on the edge seal material 7. The glass pairing station may comprise automation systems such as one or more of a robotic arm, one or more linear displacement members, one or more rails and/or the like for transporting the glass sheet 4 to the position opposite the surface 3a and lowering the glass sheet towards the surface 3a.

After this, the edge seal material 7 of the VIG unit assembly 150 may be heated and the gap is evacuated to a reduced pressure. It is understood that the edge seal material, if even needed, may be placed/applied subsequent to placing the spacers at station 18a instead. It may even in some embodiments be provided in an evacuation chamber or be omitted if the glass sheets are fused directly together by an glass sheet 3, 4 edge melting operation.

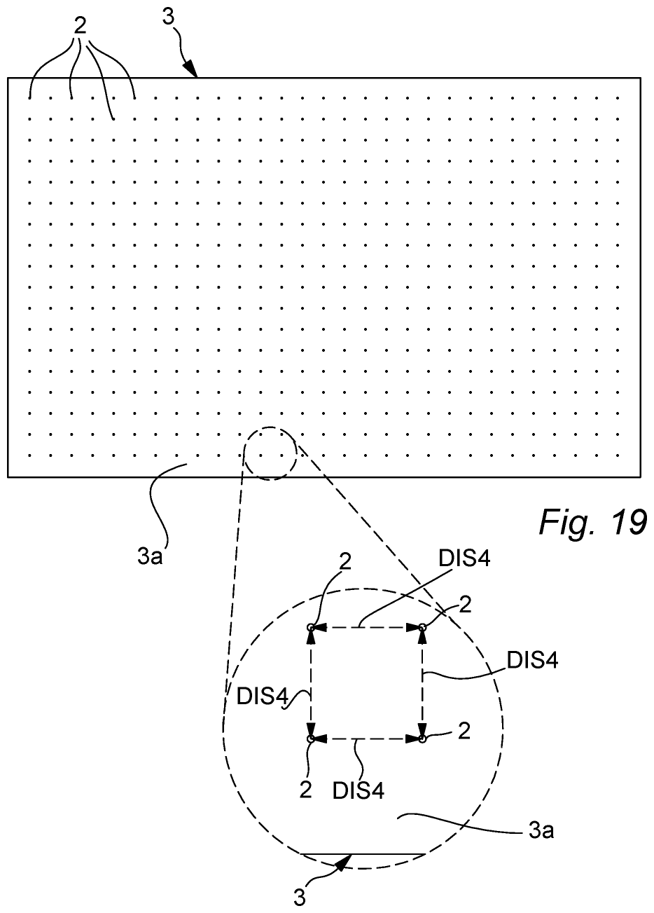

FIG. 19 illustrates a glass sheet 3 having a major glass sheet surface 3a that has been subjected to a spacer placement sequence provided by means of one or more dispensers 10, 500 described according to various embodiments above. In this example, the glass sheet has been provided with a full set of spacers 2 compared to the glass sheet surface 3a area. In the example of FIGS. 19, 18×29 spacers2 =522 spacers have been placed to sufficiently cover the glass sheet surface to provide load distribution between the spacers 2 when the gap evacuation is provided.

In FIG. 19, the spacers 2 are placed in a rectangular pattern in rows and columns. In the example of FIG. 19, if an array (see e.g. FIG. 10) of dispensers 10 is provided, the array may comprise at least 18 dispenser systems 200. If smaller glass sheets than the illustrated is provided, then fewer dispensers may be used in the array. If larger glass sheets are to be used, the array may in embodiments of the present disclosure comprise even more dispensers, or the array may in embodiments of the present disclosure be moved to arrange further spacers along a row than the number of dispensers in the array allows. In some embodiments, the array may comprise more than 19 dispensers, such as more than 30 dispensers or the like.

It is understood that if smaller glass sheets 3 are then to be supplied with spacers in a spacer placement sequence, and hence the number of dispensers in the array is larger than the number of spacers to be arranged in e.g. a row, the number of used dispensers 10 of the array may be reduced so that some of the dispensers are unused for that glass sheet.

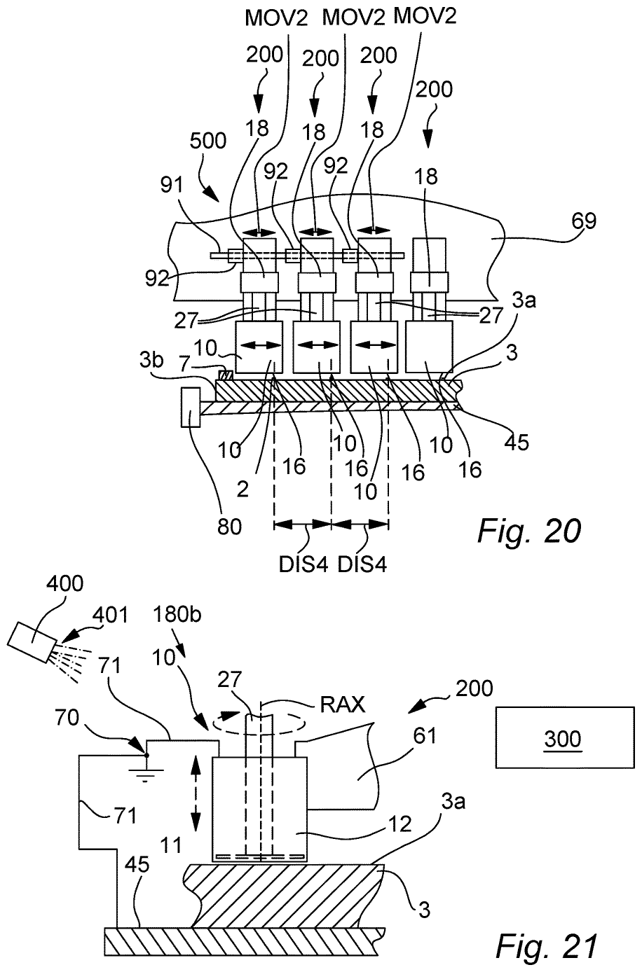

FIG. 20 illustrates an embodiment of the present disclosure, wherein one or more dispensers 10 in a dispenser array 500 may be configured to be displaced horizontally MOV2 relative to the adjacent dispenser(s) 10 of the array 500.

The dispensing systems 200 are attached to a fixed frame part 69, such as a beam or plate, by means of or through a displacement arrangement 91 such as a rail arrangement, a linear actuator such as a spindle, piston solution and/or the like. This displacement arrangement 91 is configured to support the system 200 during horizontal displacement MOV2 relative to the frame.

The displacement direction MOV2 allowed/enabled by the displacement arrangement 91 is a relative movement between the glass sheet surface 3a and the spacer outlet 6 of the respective dispenser 10 in a movement direction MOV2 along the glass sheet surface 3a, for example substantially horizontally. The movement direction MOV2 is transverse to, such as perpendicular to, the movement direction MOV1 (see e.g. FIG. 11 or FIG. 18) provided by means of the displacement motor 80, such as an electrical motor.

A displacement motor 92, such as an electrical motor, provides the movement MOV2 of the dispensing system 200 relative to the fixed frame part 69, which movement MOV2 is guided by the displacement arrangement 91.

This arrangement 91, 92 enables adaption of the distance between adjacent dispensers 10 of the array 500 and thereby adaption of the distance (may correspond to distance DIS4) between the adjacent spacer outlets 16 of two adjacent dispensers 10. This will adapt the distance DIS4 between dispensed spacers 2.

Hence, if a glass sheet 3 is to be supplied with spacers 2, the width of the glass sheet may in some embodiments of the present disclosure not fit fully with the desired spacer distance DIS4. As one example, the glass sheet width defined between parallel glass sheet edges 3b (or distance between parallel stripes/strips of edge seal material 7) may not be dividable by the desired spacer distance DIS4 to give a whole number. In that case, adaption of the horizontal distance between one or more adjacent outlets 16 may be provided by the arrangement 91, 92, to assure that there will not be a too large distance difference DIS4 between the adjacent spacers. E.g. to obtain improved load distribution on the spacers and/or to obtain less visual noticeability of distance (DIS4) variations from humans looking at the VIG unit with the plurality of dispensed spacers 2 laid/provided by means of the dispenser(s) 10. In FIG. 3, three motors 92 provides individual adaption of the horizontal distance between three dispensers 10. This may be provided for one or both sides of the array 50. In some embodiments, all of the dispensers in the array may be adjustable MOV2 horizontally and sideways relative to the frame part 69 by means of the arrangement of one or more displacement arrangements 91 and one or a plurality of displacement motors 92. In some embodiments, less than half, such as less than 25% such as less than 10% or less than 5% of the dispensers 10 of the array 500 may be individually displaceable sideways relative to the frame arrangement 69a by means of an arrangement 91, 92. In certain embodiments, just one or two, e.g. the outermost dispensers 10 in the array 500 at one or both ends/sides of the array 500 may be displaceable sideways MOV2.

In some embodiments of the present disclosure, the movement MOV2 transverse to movement MOV1 (see FIG. 11) may be provided by allowing the dispenser itself 10, or the outlet (by e.g. rotating the housing 12) to be displaced horizontally towards and/or away from the adjacent dispenser 10 to chance spacer outlet 16 distance between adjacent spacers. Thereby, the distance DIS4 between some of the spacers 2 may be reduced or increased. It is generally understood that in some embodiments of the present disclosure, distance adjustment towards ad away from the glass sheet surface 3a by means of a distance controller as e.g. previously described may also be enabled or provides in an array as illustrated in FIG. 20. In other embodiments, such distance adjustment by one or more controllers 31 may be omitted.

FIG. 21 illustrates schematically static charge reduction according to various embodiments of the present disclosure. In FIG. 21, the dispenser 10, such as the housing 12 and/or collection sheet 15, is/are connected directly or indirectly to ground by means of a grounding connection 70, such as e.g. by means of a grounding wire 71 or the like. In additional or alternative embodiments, the grounding connection may be provided through conducting bearings and/or the like, and through the shaft 27. Hence, for example, the grounding may be provided by means of one or more electric wires 71 from a frame part of the dispensing system and to the grounding connection 70, such as from a frame part 69 and/or 67 as previously described. In other embodiments, the housing 12 may comprise a grounding wire connection terminal at e.g. the upper 12a or lower 12b part of the housing (see e.g. FIGS. 1a and/or 1b) for fastening or soldering a ground connection wire.

FIG. 21 illustrates a further embodiment of the present disclosure, wherein the transportation support 45 is connected directly or indirectly to ground 70, such as by means of one or more wires 72, and/or by means of bearings, metal brushes and/or the like. The ground connection 70 may as illustrated in still further embodiments be a common ground connection for the dispenser/dispensing system 200 and the transportation/support equipment 45 in order to reduce static charge between the glass sheet 3 and the dispensing system 200, such as the dispenser 10. Such grounding connection(s) 70, 71 and/or 72 and thereby reduction in static charge may e.g. help to reduce spacer dispensing and/or placing issues.

FIG. 21 illustrates a further embodiment of the present disclosure where an ionizer device 400 (one or more may be provided) is provided at a spacer dispensing station 180b comprising one or more dispensers 10 such as an array 500 of spacer dispensers as previously described. The ionizer/ionizing device 400 provides ions of controlled polarity towards the dispensing system 200 such as towards the dispenser(s) 10, and/or towards the glass sheet 3. The ions of controlled polarity may additionally or alternatively be provided towards the glass sheet handling system 45. The ionizer(s) 400 may thereby change the electrostatic potential at/in the glass sheet/handing system 45 and/or dispensing system such as the dispenser 10. The ionizing device(s) 400 may provide a pressurized flow of ions. For example, the ionizing device(s) 400 may comprise one or more ionizing bars each comprising one or more flow outlet(s) arranged so as to provide at least one line of flow outlet extending towards one or more of the glass sheet 3, dispensing system, handing system/support and/or the like. The properties of the ion flow from the ionizer bar(s) 400, e.g. charge properties, flow direction, operating length and/or the like provided by the ionizing/ionizer bar(s) may be controlled individually by one or more settings of the ionizer bar. In one or more embodiments, the ionizer bar flow outlets comprises one or a plurality of nozzles 401.

FIG. 21 illustrates a further embodiment of the present disclosure, wherein, for example in addition or as an alternative to the grounding connection 70 and/or ionizer device(s) 400, the spacers 2 may be dispensed by the dispenser 10 while the relative humidity of the ambient air surrounding the dispenser 10 is above 40%, such as above 50%, for example between 40% and 90% or between 40% and 70%. In some embodiments, the relative humidity may be determined substantially at atmospheric pressure and/or at an ambient temperature between 15°C. and 30° C., such as between 18° C. and 23° C., such as at 20° C. This may be obtained by means of a humidity control system 300 which provides/controls a relative humidity of the ambient air near the dispenser 10 and glass sheet 3. In some embodiments, the humidity control system 300 may be configured to introduce water into the ambient air surrounding the VIG unit assembly 1 through one or more discharge openings of one or more water discharge arrangements of the humidity control system 300.

One or more of the ionizer device(s) 400, humidity control system 30 and/or the grounding connection 70 may together or alone reduce and/or maintain a difference in electrostatic charge potential between the glass sheet 3 and the dispensing system 200, such as between the between the glass sheet 3 and the one or more dispensers (10) or array 500 to be below a maximum allowed voltage value. This maximum allowed voltage value may in embodiments of the present disclosure be 10 kV, such as 8 kV, such as 5 kV or 2 kV or 1 kV.

One or more of the ionizer device(s) 400, humidity control system 30 and/or the grounding connection 70 may together or alone reduce and/or maintain a difference in electrostatic charge potential between the glass sheet 3 and the dispensing system 200, such as between the between the glass sheet 3 and the one or more dispensers (10) or array 500 to be below 10 kV, such as below 5kV, such below 2 kV. In certain embodiments, the maximum voltage allowed between the glass sheet 3 and the dispensing system 200, such as between the between the glass sheet 3 and the one or more dispensers (10) or array 500 may be below 1kV such as below 0.5 kV.

The one or more ionizing device(s) 400, one or more humidity control system(s) 300 and/or one or more grounding connections 70, 71, 72 may be considered a charge modulation system, or considered comprised in a charge modulation system for controlling the electrostatic charge potential between the glass sheet 3 (and/or glass sheet handling system 45) and the dispensing system 200, such as between the glass sheet 3 (and/or glass sheet handling system 45) and the one or more dispensers (10) or array 500 to be below a maximum allowed voltage value as e.g. disclosed above.

In one or more embodiments, for example the ionizer bar may be omitted, and e.g. only the grounding connection(s) 70 and/or humidity control may be used.

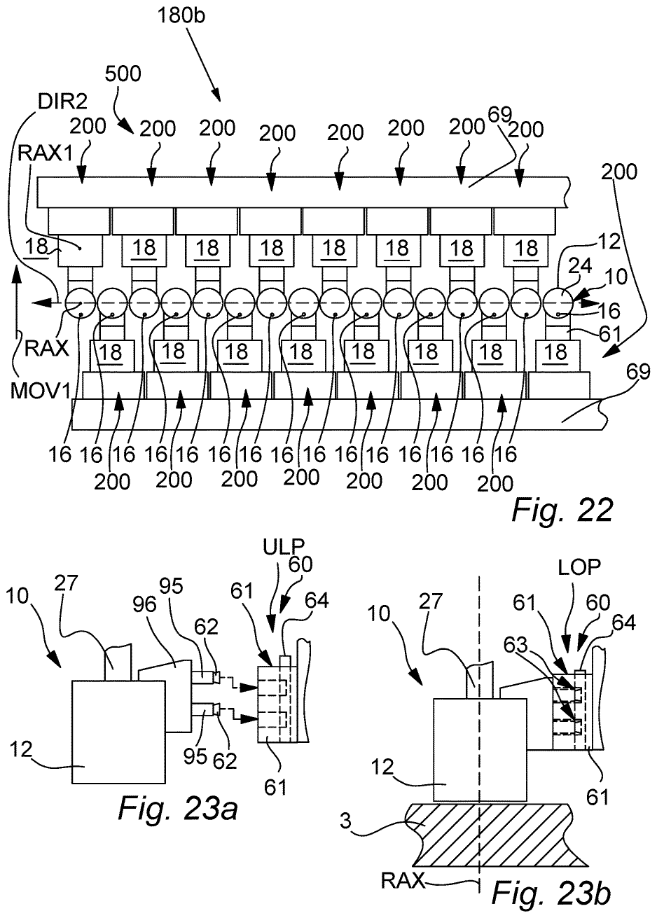

FIG. 22 illustrates schematically a dispensing array comprising a plurality of dispensing systems 200 according to embodiments of the present disclosure. In FIG. 22, the array 500 comprises 16 dispensing systems 200, but fewer or more may be provided in the array 500. FIG. 22 is seen towards the bottom surfaces 24 of the dispenser 10. As can be seen, the dispenser comprises a dispenser housings 12 (for figure clarity, not all features are assigned a reference number), such as housing 12 for providing e.g. dust protection and/or the like as e.g. previously disclosed in relation to one or more of the figures described above.

The spacer outlet 16 may as illustrated, in embodiments of the present disclosure, be arranged in the respective dispenser housing bottom surface 24, As can be seen from fig. figure, the outlets 16 may be aligned on a line, so that they 10 dispenses a row of spacers (se e.g. FIG. 19) if dispensing simultaneously and/or if the glass sheet 3 (not illustrated in FIG. 22) is kept stationary/still during spacer 2 dispensing.

FIG. 22 moreover illustrates an embodiment of the present disclosure (see also FIG. 11), wherein the rotation axis RAX1 of the drive motor 18 is displaced, in the present example displaced parallel relative to the rotation axis RAX for providing a relative rotation between the housing 12 and the collection disc 15 (not illustrated in FIG. 22).

Hence, the dispenser system 200 may comprise an interconnecting drive arrangement 66 comprising one or more of a chain drive, belt drive, a toothed wheel system such as a gearing system and/or the like which transfers the rotary motion of the motor 18 to the collection sheet 15 through the shaft 27 which rotates around the axis RAX. An interconnecting drive arrangement (see e.g. ref. 66 of FIG. 11) may comprise one or more of a chain drive, belt drive, a toothed wheel system such as a gearing system and/or the like which transfers the rotary motion of the motor 18 around the axis RAX1 to a shaft or the like for rotating the collection sheet 15 inside the housing 12 (or for rotating the housing 12) around an axis RAX. Axes RAX1 and RAX may be parallel as illustrated, or they may be non-parallel, or even perpendicular, dependent on the drive system 18, 66 setup. In certain other embodiments (not illustrated in FIG. 22, see e.g. FIG. 1b), the axes RAX and RAX1 may be coincident.

The drive arrangement comprising the drive motor 18, such as an electric motor, frame parts, such as height adjustable frame parts and/or the like if present (see e.g. FIGS. 10 and 11) may as illustrated in embodiments of the present disclosure be arranged staggered on opposing sides on the extension direction DIR2 line (see dashed double arrow line DIR2) of the dispenser array 500. One or more of the motor 18, frame arrangement and/or the like may in embodiments of the present disclosure be wider than the maximum width D2, such as the diameter (see e.g. fig. la) of the dispenser housing 12, But the staggering arrangement of these parts may provide more room/space for arranging such a drive arrangement 18 and/or the like in the spacer placement station. The staggering arrangement may additionally or alternatively enable that the dispensers 10 may be placed closer together.

FIGS. 23a and 23b Illustrates schematically a further embodiment of the present disclosure wherein the housing of the dispenser 10 is releasably attached to a dispenser holding part 61 of the dispenser system 200 by means of a quick release locking system 60. Here, the system is not spring loaded, but it may be in further embodiments of the present disclosure.

One or more actuation members 64 (in FIGS. 23a and 23b there is a single member 64) is arranged at the dispenser holding part 61, and is operateable to actuate the locking system 60. The quick release locking system 60 comprises one or more movable locking bolts/parts 63 that may e.g. be attached to or integrated in the actuation member 64. The actuation member 64 is configured to be moved between a locking position LOP and an unlocking position. For example by rotation and/or pushing directly by hand or by means of a tool such as a screwdriver or another suitable mechanical tool. The one or more movable locking bolts 63 in the locking position LOP provides an attachment of the housing 12 of the dispenser 10 to the dispenser holding part 61 through the interfacing part 96 by engaging one or more engagement members 62, in this case two engagement members 62.

The engagement members 62 in FIGS. 23a and 23b comprises two rods 95 attached to or integrated in at the dispenser housing 12, and the rods 95 may be guided into a bore or recess in the holding part 61 to engage with the actuation member and/or the locking bolts 63.

In FIGS. 23a and 23b, The dispenser comprises an interfacing part 96 comprising the rods 95, each rod comprising an engagement member 62, such as a conical part, one or more recesses and/or protrusions or the like for enabling and fastening of the dispenser 10 to the dispenser holding part 61 through the interfacing part 96 by means of the quick release locking system 60. The interfacing part 96 may in embodiments of the present disclosure be attached to the housing by means of one or more mechanical and/or chemical fasteners (not illustrated) or the interfacing part 96 may be unitary with the housing 12 of the dispenser, such as an upper housing part 12a (see e.g. FIG. 1a). The interfacing part 96 and/or the rods 95 may as illustrated, in embodiments of the present disclosure, extend from the housing. In other embodiments of the present disclosure (not illustrated), the dispenser holding part 61 may comprise the one or more rods 95 or the like, and the one or more actuation members 64 may instead be placed at or in the interfacing part 96.

The movable locking bolts/parts 63 in the unlocking position ULP disengages the engagement member 62 and thereby provides a release of the housing 12 of the dispenser 10. The actuation member 64 can be displaced, such as pushed and/or rotated, by means of a force, such as by hand or by means of a hand held tool or the like to move the one or more movable locking parts 63, between the locking position LOP (FIG. 23b) sand the unlocking position ULP (FIG. 23a).

It is generally understood that in one or more embodiments of the present disclosure, the rods 95 as illustrated in FIG. 23b and the locking parts 63 as illustrated in FIG. 13 may be considered different types of fastening parts for fastening the dispenser housing 12. Other types of fastening parts may also be used in further embodiments of the present disclosure. In one or more embodiments of the present disclosure, the quick release locking system comprises three or less fastening parts 63, 95, such as two or less fastening parts 63, 95 or just one fastening part 63, 95. This may enable faster housing release and/or replacement.

In embodiments of the present disclosure the actuation member 64 may require a rotation of the actuation member 64 less than 360°, such as less than 180°, for example less than 90° degrees around a rotation axis in order to either lock the dispenser 10 housing 12 in place by means of the locking system 60, or release the dispenser 10 for e.g. dispenser maintenance, spacer storage 11 filling and/or dispenser replacement. The actuation member may hence assure that the fastening part(s) is/are engaged and/or disengaged within such a rotation. In some embodiments of the present disclosure, a linear movement, such as a push or pull of the actuation member 64 may provide the engagement or disengagement of the fastening part(s). such a linear movement may in embodiments be an addition to or alternative to the mentioned rotation of the actuation member 64.

FIG. 24 is a microscopic picture of a spacer 2 made from a spherical precision steel ball that has been compressed in a press (not illustrated) or the like to shape the contact surface 2a, 2b by plastic deformation. This provides that the spacer width W1 (in the illustrated example 0.67 mm) is significantly larger than the spacer height H1 (0.2 mm). As can be seen, the compression of the steel ball provides that the convex side edge surfaces (2c, 2d) (imagined if looking at a cross section of the spacer), describes circular 97 arcs having non-coinciding centres C1, C2.

In other embodiments (not illustrated), ceramic balls or balls from another material may be processed, such as mechanically (for example by grinding) or chemically processed to have predefined and pre-shaped, such as flat, contact surfaces 2a, 2b. The convex side surfaces 2c, 2d may here describes minor circular arcs having a coinciding centre. In stull further embodiments, the spacers 2 may e.g. be cylindrical in shape and extend substantially linear between the surfaces 2a, 2b, or may have another shape.

It is generally understood that the spacers may be made from any suitable materials such as be made from, such as comprise or consist of metal, polymer material and/or ceramic.

In embodiments of the present disclosure, the maximum width W1, such as the maximum diameter, of the spacer 2 may be at least 2 times, such as at least 2.4 times or at least 2.8 times larger than the height HI of the spacer 2. In FIG. 24, the maximum width W1, such as the maximum diameter, of the spacer 2 is about 0.668/0.204=3.3 times larger than the height HI of the spacer 2.

In embodiments of the present disclosure, the maximum width W1, such as the maximum diameter, of the spacer 2 may be between 1.3 and 6 times, such as between 1.5 and 6 times, for example between 2 times and 4 times larger than the height HI of the spacer 2.

In some embodiments of the present disclosure, the maximum width W1, such as the maximum diameter of the spacer may be less than 0.8 mm, such as less than 0.6 mm, such as less than 0.4 mm. In certain embodiments of the present disclosure, the diameter of the spacer may be 0.3 mm or less.

In FIG. 24, the width W2 (such as diameter) of the contact surfaces 2a, 2b is approximately 0.87 times the maximum width W1 (such as diameter) of the spacer 2.

The compressive load on each of at least 50%, such as at least 70% of the spacers 2 in a VIG unit (see e.g. FIGS. 17 and 19) for a cylindrical spacer 2 or a spacer with curved outer side edge surfaces 2c and plane contact surface 2a, 2b as described previously, in a “square spacer grid” of 40×40 mm2 (i.e. distance of substantially 40 mm between neighbouring/adjacent spacers), may amount to at least 0.5 GPa, such as at least 0.8 GPa, such as substantially 1 GPa. In some embodiments, the compressive load on at least 80% or 90%, such as substantially all spacers may be between 0.5 GPa and 2 GPa, such as between 0.6 and 1.3 GPa.

It is generally understood that the tolerances for the spacers 200 in the spacer storage 11 and/or the distributed spacers may in embodiments of the present disclosure may be ±30 micron, such as ±20 micron, or ±10 micron or less. For example, spacer height Hl may be 0.2 mm with a ±30 micron, such as ±20 micron, or ±10 micron tolerance.

For example, maximum spacer width W1 may be for example 0.44 mm or 0.66 mm with a ±40 micron, such as ±20 micron, or ±10 micron tolerance. The tolerances of the spacer width W1 may in some embodiments of the present disclosure be less restrictive that the tolerance requirements to the spacer height H1.

It may be preferred that surfaces 2a, 2b and/of spacers are shaped/designed so as not allow to trap pockets of gasses between glass surface and pillar surface, and hence the contact surface 2a, 2b flatness may in embodiments of the present disclosure be substantially flat and/or comprise one or more grooves/furrows and/or the like to reduce the risk of trapping gasses in between the glass sheet surfaces 3a, 4a and the contact surfaces 2a, 2b.

Outgassing from the spacers 2 should be minimized. Particularly outgassing of non-getterable species should be avoided for example argon.

As can be seen from e.g. FIG. 1a, the collection sheet 15 in embodiments of the present disclosure may comprise a single sheet of material having a substantially continuous/constant thickness TH1 between the collection sheet centre and towards the collection sheet centre CDC.

FIG. 25 illustrates a collection sheet 15 according to further embodiments of the present disclosure, comprising a thickened part 15e at the collection sheet centre. In FIG. 25, the collection sheet 15 comprises a thickened part 15e placed with a distance DIS5 from the outer sheet boundary/periphery 15d, and the thickened part 15e has a centre that is coinciding with the centre CDC of the collection sheet 15 and the rotation axis RAX. The thickened part 15e may e.g. help to increase the structural integrity of the collection sheet 15. The thickness TH1 (see FIG. 1) may still be the same as disclosed previously at the area of the collection hole 15a, but the thickness of the entire collection sheet 15 may change/vary between the boundary/periphery 15d and the centre CDC. The thickened part 15e may in embodiments of the present disclosure be integrated/unitary with the part of the sheet 15 comprising the collection hole 15. In other embodiments, the thickened part 15e may be attached to the sheet 15 by mechanical and/or chemical fastening means. In some embodiments, the thickened part may additionally or alternatively provide the interface between the collection sheet and a shaft 27 (not illustrated in FIG. 25).

In embodiments of the present disclosure, the surface 17a part of the upper housing part 12 facing the thickened part 15e may be adapted to the shape and size of the thickened part. Hence, for the embodiment of the present disclosure, the surface 17a may have a concavely extending surface (not illustrated). In certain embodiments of the present disclosure, a vacuum channel or the like may be provided in a part of the thickened part 15e, for example in order to provide a vacuum path/duct interface between a shaft and the collection hole 15a.

FIGS. 26 and 27 illustrates schematically and in cross section different surface topologies of the contact surface(s) 2a, 2b of the spacers 2 according to embodiments of the present disclosure.

In FIG. 26, the surface structure of the contact surface 2a, 2b is provided due to the manufacturing method of the spacer. This may e.g. be provided by one or more of compressing, plastically deforming, moulding and/or sintering or the like of a suitable spacer material into a spacer comprising predefined flat contact surfaces. Here, the surface topology is to be considered flat, but some degree of surface variation may still be accepted. In FIG. 26, the opposite flat contact surfaces 2a, 2b has a surface shape, such as a surface roughness, that varies relative to a mean line per plane P1. In some embodiments, this variation may be less than ±30 micron, such as less than ±10 micron of the spacer height H1, relative to the mean line or mean plane P1 defined by the respective contact surface 2a, 2b. The mean line or plane may be defined by the average surface roughness of the respective spacer contact surface 2a, 2b. The surface roughness may e.g. be determined according to ISO 4287:1997 standard, or similar, and the contact surface variation may e.g. be an average, or arithmetic average, of surface height deviation/variation from the mean line p1. For example, this may be defined by a Ra roughness parameter.

FIG. 27 illustrates a contact surface 2a where a certain degree of surface variation of the surface 2a is intentionally provided by furrows in order to e.g. reduce capture of air/gas in between the glass sheet surface and contact surface of the spacer. However, this may still be considered a flat contact surface.

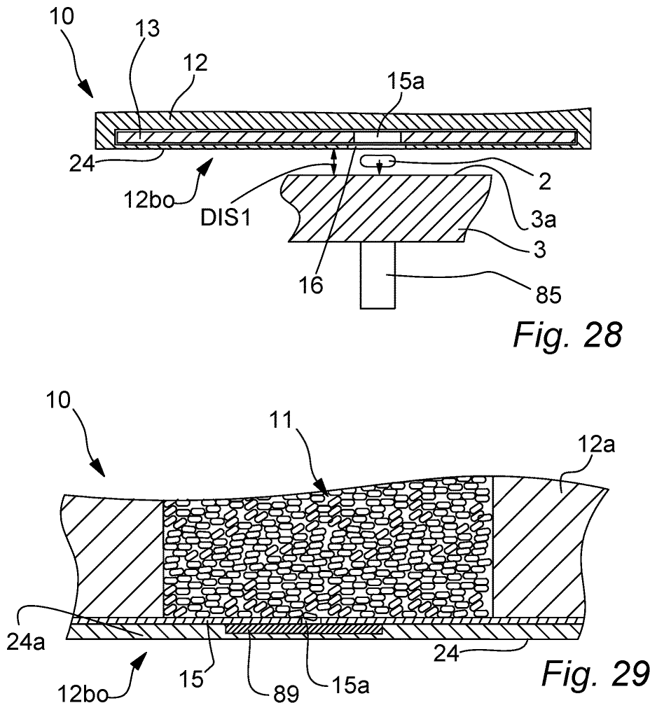

FIG. 28 illustrates schematically an embodiment of the present disclosure, wherein a spacer 2 maintaining arrangement 85 is configured to maintain a spacer 2 at the glass sheet surface 3a at a desired position when the spacer has been dispensed by the dispenser 10. In FIG. 28, the spacer position maintaining arrangement 85 comprises a magnet, and the spacer is designed to be magnetic enough to be maintained at the desired position by means of the dispenser. For example, the spacer 2 may comprise a ferromagnetic coating and/or the structural body of the spacer 2 may be made from or comprise a ferromagnetic material.

In some embodiments of the present disclosure, the transportation support 45 may comprise the spacer position maintaining arrangement 85 such as one or more magnets. In some embodiments the magnet(s), such as a magnet array, may be movable by a motor or another type of glass moving unit to provide a relative movement MOV1 between the glass sheet 3a and the dispenser along the glass sheet surface 3a.

In some embodiments, the spacer 2 maintaining arrangement 85 may be considered separate to the transportation support that may move the glass sheet into and away from the dispenser.

It is to be understood that in some embodiments, the spacer position maintaining arrangement 85 may comprise a plurality of magnets spaced apart according to the desired spacer distance (see e.g. FIG. 19). In some embodiments, if a dispenser array 500 as described according to various embodiments above is provided, a row or the like of a plurality of magnets may be placed beneath the glass sheet along the array direction DIR2 (see FIG. 22).

In some embodiments of the present disclosure, the glass sheet 3 may be placed above, such as on, magnets of the arrangement 85, and for example an array 500 of dispensers 10 may be moved relative to the glass sheet surface along the glass sheet surface to dispense a plurality of spacers 2, such as at positions opposite to magnets of the arrangement 85. In some embodiments, the magnets may be placed according to the desired pattern, such as a grid pattern, of spacers 2 (see FIG. 19).

In embodiments of the present disclosure, the device(s) comprising the magnet(s), such as the magnet(s) itself/themselves, may provide support for the glass sheet 3 during spacer dispensing.

In FIG. 28, the magnet 85 is arranged opposite to the major surface of the glass sheet 3 that faces away from the dispenser 10 and the major surface 3a receiving the spacer(s) 2, and the magnet(s) hence provides a magnetic field through the glass sheet 3 in order to maintain the spacer 2 in position.

In other embodiments of the present disclosure, the spacer maintaining arrangement 85 may comprise a template comprising holes or the like for maintaining the spacers in position.

It is understood that the spacer 2 maintaining arrangement 85 may be considered a temporary maintaining arrangement that may e.g. only be used until the spacers 2 have been placed and rests as desired on the surface 3a, hence, the spacer 2 maintaining arrangement 85 may e.g. not follow the individual glass sheet 3 through the further manufacturing steps for the VIG unit assembly, but may e.g. be placed and maintained at a spacer placement station of a VIG unit assembly manufacturing line.

FIG. 28 moreover illustrates a further embodiment of the present disclosure, wherein the distance between the spacer outlet 16 of the dispenser and the glass sheet surface 3a is larger than the spacer height HI (see e.g. spacer height HI in FIG. 2a). In embodiments of the present disclosure, the distance DIS1 may be at least 2 times the spacer height such as at least 4 times the spacer height. In Certain embodiments, the distance DIS1 may be between 1.5 and 10 times the spacer height H1, such as between 2 times and 5 times the spacer height H1.

In other embodiments of the present disclosure, the distance between the glass sheet surface for receiving a collected spacer from the dispenser and the spacer outlet may be less than the spacer height, at least while the spacer is dropped towards the glass sheet surface. In embodiments of the present disclosure, the distance DIS1 between the spacer outlet 16 and the glass sheet surface 3a may be less than 0.6 mm, such as less than 0.3 mm, such as less than 0.2 mm, at least when the spacers 2 are delivered, such as dropped, onto the glass sheet surface 3a.

FIG. 29 illustrates schematically an embodiment of the present disclosure, wherein a magnet attracts spacers 3 from the spacer storage 11 into the collection hole 15a. The spacers 2 in the storage 11 are in this embodiment magnetic, and the magnet 89 is placed opposite to the storage bottom, so that the collection sheet 15 is placed between the magnet 89 and the storage 11. The collection sheet 15 may in embodiments of the present disclosure not be magnetic, or may only comprise a limited amount of ferromagnetic material. When the collection hole 15a moves through the spacer storage 11 at the bottom of the spacer storage 11, the magnet 89 attracts spacers 2 from the storage 11 and into the collection hole 15a.

In some embodiments of the present disclosure, one or more magnets 89 may be arranged opposite to the storage 11 along at least 40%, such as at least 80% or at least 95% of the length of the collection hole's 15a traveling path (TPS-see FIG. 7) at the bottom of the spacer storage compartment 11. The magnet(s) 89 is/are in some embodiments placed opposite the collection hole at the traveling path.

The dispenser 10 may as illustrated comprise the magnet(s) 89, for example embedded in the bottom wall 24a. In some embodiments, the magnet(s) 89 may provide at least a part of the surface 17b of the dispenser wall facing towards the sheet 15. In some other embodiments (not illustrated), the magnet(s) 89 may be placed external to the housing 12.

It is generally to be understood that the VIG unit may e.g. be transparent to at least visible light.

In embodiments of the present disclosure, the manufactured VIG unit may be for use in a building window. In some embodiments, the building window may be a roof window. In other embodiments, the building window may be a vertical window such as a façade window. In some embodiments, the VIG unit when used in a building window may be laminated at one or both sides of the VIG unit by means of an interlayer and a further glass sheet. In other embodiments of the present disclosure, the VIG unit may be used for e.g. cooling furniture such as in a door of a refrigerator or freezer and/or for heating furniture such as in a door of an oven. The VIG unit to enable a view through the VIG unit towards the goods stored in the interior of the cooling or heating furniture.

### Items

The present disclosure is further described in the following items.

1. A method of manufacturing a vacuum insulating glass unit (VIG), the method comprising:
providing a first glass sheet (3),
dispensing a plurality of spacers (2) on a major surface (3a) of the provided glass sheet (3) by means of a dispenser (10) of a spacer dispensing system (200), wherein the dispenser (10) comprises:
   a housing (12) comprising a guidance space (13) placed between a first housing surface (17a) of an upper part (12a) of the housing (12) and a second housing surface (17b) of a bottom part (12b) of the housing (12),
   a spacer outlet (16) arranged at the bottom part (12b) of the housing (12),
   a collection sheet (15), wherein the collection sheet (15) comprises at least one collection hole (15a) extending between opposing major surfaces (15b, 15c) of the collection sheet (15), wherein the collection sheet (15) is arranged in the guidance space (13),
      wherein the dispensing of spacers (2) comprises:
      providing a relative movement between the collection sheet (15) and the housing (12) by means of a driver (18) so that the collection hole (15a) is arranged at the bottom of the spacer storage compartment (11) and collects a spacer (2) from a spacer storage (11), and
      providing a further, relative movement between the collection sheet (15) and the housing (12) to align the collected spacer (2) in the collection hole (15a) opposite to the spacer outlet (16) to deliver the collected spacer (2) to the spacer outlet (16) and towards the surface (3a) of the glass sheet (3),
      the method further comprising providing a second glass sheet (4),
      sealing together the first glass sheet (3) and the provided second (4) glass sheet at the periphery of the glass sheets (3, 4) with the plurality of dispensed spacers arranged between major surfaces (3a, 4a) of the glass sheets so that a gap is provided between the first and second glass sheets (3, 4), and
      evacuating the gap.

2. A method of manufacturing a vacuum insulating glass unit (VIG), the method comprising:
providing a first glass sheet (3),
dispensing a plurality of spacers (2) on a major surface (3a) of the provided first glass sheet (3) by means of a dispenser (10) of a spacer dispensing system (200), wherein the dispenser (10) comprises:
   a housing (12) comprising a guidance space (13) placed between an upper part (12a) of the housing (12) and a bottom part (12b) of the housing (12),
   a spacer outlet (16) arranged at the bottom part (12b) of the housing (12),
   a collection sheet (15) wherein the collection sheet (15) comprises at least one collection hole (15a) extending between opposing major surfaces (15b, 15c) of the collection sheet (15), wherein collection sheet (15) is arranged in the guidance space (13),
      wherein the dispensing of spacers (2) comprises:
      providing a relative rotational movement between the collection sheet (15) and the housing (12) around a rotation axis (RAX), such as by means of a drive motor (18), so that the collection hole (15a) collects a spacer (2) from a spacer supply, and
      providing a further, relative rotational movement between the collection sheet (15) and the housing (12) around the rotation axis (RAX) to align the collected spacer (2) in the collection hole (15a) opposite to the spacer outlet (16) to deliver the collected spacer (2) to the spacer outlet (16) and towards the surface (3a) of the glass sheet (3),
      the method further comprising
      providing a second glass sheet (4),
      sealing together the first glass sheet (3) and the provided second (4) glass sheet at the periphery of the glass sheets (3, 4) with the plurality of dispensed spacers arranged between major surfaces (3a, 4a) of the glass sheets so that a gap is provided between the first and second glass sheets (3, 4), and
      evacuating the gap.

3. A method of manufacturing a vacuum insulating glass unit (1), the method comprising:
providing a first glass sheet (3),
dispensing spacers (2) comprising predefined, pre-shaped contact surfaces (2a, 2b) on a major surface (3a) of the provided glass sheet (3) by means of a dispenser (10) of a spacer dispensing system (200), wherein the dispenser (10) comprises:
   a spacer storage compartment (11), comprising a plurality of said spacers (2), a housing (12) comprising a guidance space (13) placed between a first housing surface (17a) of an upper part (12a) of the housing (12) and a second housing surface (17b) of a bottom part (12b) of the housing (12),
   a spacer outlet (16) arranged at the bottom part (12b) of the housing (12),
   a disc shaped collection sheet (15) providing a bottom part of the spacer storage compartment (11), wherein the disc shaped collection sheet (15) comprises at least one collection hole (15a) extending between opposing major surfaces (15b, 15c) of the collection sheet (15), wherein the collection hole (15a) is a through hole and wherein the disc shaped collection sheet (15) is arranged in the guidance space (13),
      wherein the dispensing of spacers (2) comprises:
providing a relative rotational movement between the disc shaped collection sheet (15) and the housing (12) around a rotation axis (RAX) by means of a drive motor (18) so that the collection hole (15a) is arranged at the bottom of the spacer storage compartment (11) and thereby collects a spacer (2) from the bottom of the spacer storage compartment (11), and providing a further, relative rotational movement between the collection sheet (15) and the housing (12) around the rotation axis (RAX) to align the collected spacer (2) in the collection hole (15a) opposite to the spacer outlet (16) to deliver the collected spacer (2) to the spacer outlet (16) and towards the major surface (3a) of the glass sheet (3),
   wherein each of the plurality of spacers (2) in the spacer storage compartment (11) has a spacer height (H1) extending between the contact surfaces (2a, 2b) and wherein each of said spacers (2) has a spacer width (W1), wherein the guidance space (13) has a height (H2) which is less than 1.4 times the spacer height (H1), and wherein the height (H2) of the guidance space (13) is smaller than the spacer width (W1),
   the method further comprising providing a second glass sheet (4),
   sealing together the first glass sheet (3) and the provided second (4) glass sheet at the periphery of the glass sheets (3, 4) with the plurality of dispensed spacers arranged between major surfaces (3a, 4a) of the glass sheets so that a gap (5) is provided between the first and second glass sheets (3, 4), and
   evacuating the gap.

4. The method according to any of the preceding items, wherein one of the contact surfaces (2a, 2b) of the collected spacer (2) supports on and slides on a surface of the dispenser (10), such as on the second housing surface (17b), in the guidance space (13) during the further rotational movement.

5. The method according to any of the preceding items, wherein the collection sheet (15) comprises an upwardly facing first major surface (15b) and a downwardly facing, oppositely directed second major surface(15c), wherein the second housing surface (17b) covers at least 90%, such as at least 98% of the surface area of the second major surface (15c),
and/or wherein the first housing surface (17a) covers at least 40%, such as at least 60%, such as at least 75% of the surface area of the first major surface (15b) of the collection sheet (15).

6. The method according to any of the preceding items, wherein the collection sheet (15) has an outer maximum disc diameter (D1), and wherein the housing (12) has a width (D2), such as a diameter, that is larger than the disc diameter (D1).

7. The method according to item 6, wherein the housing (12) encloses at least 80% such as at least 95 % of the outer boundary (15d), such as periphery, of the collection sheet (15) by means of a wall (19) part, such as an annular wall part, arranged opposite to the outer boundary (15d) of the disc shaped collection sheet (15),
or
wherein the housing (12) fully encloses the outer boundary (15d), such as periphery, of the collection sheet (15) by means of a wall (19) part, such as an annular wall part, arranged opposite to the outer boundary of the disc shaped collection sheet (15).

8. The method according to any of the preceding items, wherein the housing (12) has a maximum width (D2), such as a maximum outer diameter, that is 50 mm or less, such as 40 mm or less, for example 30 mm or less.

9. The method according to any of the preceding items, wherein the dispenser (10) comprises a vacuum path (21a, 21b, 21c), such as one or more vacuum channels, connected to a vacuum pump (21d), wherein vacuum pump provides suction in the vacuum path so as to help a spacer (2) of the spacer storage compartment (11) to enter into the collection hole (15a).

10. The method according to item 9, wherein the housing (12) comprises a part of the vacuum path, such as a recessed channel, such as an elongated, curving channel, arranged to abut the guidance space to provide a fluid communication between the collection hole (15a) of the collection sheet (15) and a suction outlet of the housing connected to the vacuum pump (21d) when the collection hole (15a) is arranged at the bottom of the spacer storage compartment (11) to collect a spacer (2) from the bottom of the spacer storage compartment (11).

11. The method according to item 9 or 10, wherein the vacuum path comprises an elongated, curved vacuum channel (21b) extending around the rotation axis (RAX), such as at least 45° around the rotation axis, for example at least 80° around the rotation axis (RAX).

12. The method according to any of items 9-11, wherein the vacuum path comprises an elongated, curved vacuum channel (21b) extending less than 270° around the rotation axis (RAX), such as less than 190° around the rotation axis (RAX).

13. The method according to any of the preceding items, wherein the dispenser (10) comprises a sensor system comprising one or more sensors (22, 23), such as one or more optical sensors, configured to detect if a collected spacer (2) is present in the collection hole, and wherein the sensor system provides one or more sensor outputs (22a, 23a) comprising information of if a collected spacer (2) is present in the collection hole (15a).

14. The method according to item 13, wherein the sensor or sensors (22, 23) of the sensor system is/are arranged in and/or supported in the upper part (12a), such as in a bore or channel (22b, 23b) arranged opposite to a major surface (15b) of the collection sheet (15) facing away from the spacer outlet (16).

15. The method according to any of the preceding items, wherein the spacer height (H1) of the spacers (2) in the spacer storage compartment (11) is less than 0.4 mm, such as less than 0.25 mm, for example 0.2 mm or less.

16. The method according to any of the preceding items,
wherein the spacer width (W1), such as spacer diameter is larger than the spacer height (H1) and/or
wherein the maximum width (W1), such as the maximum diameter, of the spacers (2) is at least 2 times larger, such as at least 2.5 times larger than the height (H1) of the spacers (2), such as wherein the maximum width (W1), such as the maximum diameter, of the spacers (2) is between 2 times and 5 times, such as between 2 times and 4 times larger than the height HI of the spacer 2.

17. The method according to any of the preceding items, wherein the height (H2) of the guidance space (13) is less than 0.5 mm, such as less than 0.3 mm, and/or wherein the height (H2) of the guidance space (13) is less than 1.5 times, such as less than 1.3 times the thickness (TH1) of the collection sheet (15).

18. The method according to any of the preceding items, wherein one or more side wall surfaces (11a, 11b) enclosing the spacer storage compartment (11) narrows in a direction towards the collection sheet (15), and/or wherein the spacer storage compartment is funnel shaped.

19. The method according to any of the preceding items, wherein the length of the traveling path (TPS) of the collection hole (15a) at the bottom of the spacer storage compartment (11) is at least 0.9 times, such as at least 1.2 times, such as at least 1.8 times, the distance (DIS2) between the rotation axis (RAX) and the outer periphery of the dispenser housing (12).

20. The method according to any of the preceding items, wherein the spacer storage compartment (11) is elongated and extends partly around the rotation axis, such as wherein the spacer storage compartment (11) is arc shaped.

21. The method according to any of the preceding items, wherein the spacer storage compartment (11) is defined between opposing side wall surfaces (11a, 11b) of the housing (12), and wherein at least a side wall surface (11b) enclosing and facing a part of the spacer storage compartment (2) and which is placed proximate the rotation axis (RAX) is convexly shaped, such as wherein at least a part of the convexly shaped side wall surface (11b) is coaxial with the rotation axis (RAX)

22. The method according to any of items 19-21, wherein the spacer storage compartment (11) is arranged in, such as integrated in, such as milled into, the upper part (12).

23. The method according to any of the preceding items, wherein the rotational movement (a2) around the rotation axis (RAX) from the spacer storage compartment (11) to align the collected spacer (2) in the collection hole (15a) opposite to the spacer outlet (16) is at least 85°, such as at least at least 120°, for example at least 170°.

24. The method according to any of the preceding items, wherein the distance (DIS1) between the glass sheet surface (3a) for receiving a collected spacer (2) from the dispenser (10) and the spacer outlet (16) is less than the spacer height (H1), at least while the spacer (2) is dropped towards the glass sheet surface (3a).

25. The method according to any of the preceding items, wherein the collection sheet (5) is arranged at the lower fourth, such as the lower sixth, such as the lower eighth of the housing (12), proximate the bottom wall (24a) of the housing.

26. The method according to any of the preceding items, wherein the distance (DIS3) between the glass sheet surface (3a) and the major surface (15c) of the collection sheet (15) facing the glass sheet surface (3a) is less than 10 mm, such as less than 3 mm, such as less than 1 mm, at least while the spacer (2) is dropped towards the glass sheet surface (3a).

27. The method according to any of the preceding items, wherein the dispenser (10) comprises a fluid outlet (40) for pressurized gas, such as an outlet arranged opposite to the spacer outlet (16), wherein the pressurized gas is provided in order to provide a blowing force onto the collected spacer in the collection hole to help the collected spacer leave the collection hole.

28. The method according to any of the preceding items, the spacer outlet (16) and/or the collection hole (15a) is/are chamfered.

29. The method according to any of the preceding items, wherein a vibrator (45) is configured to vibrate at least a part of the dispenser (10), such as the housing (12) and/or the collection sheet (15).

30. The method according to any of the preceding items, wherein the spacers (2) comprises a side edge surface (2c, 2d) extending between the contact surfaces (2a, 2b), wherein the side edge surface (2c, 2d) is curved and convexly extending, such as bulging, between the contact surfaces (2a, 2b).

31. The method according to any of the preceding items, wherein the convex side edge surfaces (2c, 2d) each describes minor circular arcs having non-coinciding centres (C1, C2).

32. The method according to any of the preceding items, wherein the housing of the dispenser (10) is releasably attached to a dispenser holding part (61) of the dispenser system (200) by means of a locking system (60), such as quick release locking system, such as a spring (65) loaded locking system, and wherein the locking system (60) comprises an actuation member (64) to be operated to actuate the locking system (60), such as wherein the locking system (60) is configured for tool-less mounting and dismounting of the dispenser (10).

33. The method according to item 32, wherein the locking system (60) comprises one or more movable locking parts (63), such as spring(65) loaded locking parts (63), configured to be moved between a locking position (LOP) and an unlocking position,
wherein the one or more movable locking parts in the locking position (LOP) provides an attachment of the housing (12) of the dispenser (10) to the dispenser holding part (61) by engaging an engagement member (62) such as a strike part,
wherein the one or more movable locking parts (63) in the unlocking position disengages the engagement member (62) and thereby provides an release of the housing (12) of the dispenser (10) to enable removing the dispenser (10) from the dispenser holding part (61),
wherein the actuation member (64) is configured to be displaced, such as pushed and/or rotated, by means of a force (Fp), such as by hand, to move the one or more movable locking parts (63), between the locking position (LOP) and the unlocking position.

34. The method according to any of the preceding items, wherein the housing (12) of the dispenser (10) is attached to a dispenser holding part (61) of the dispenser system, and wherein (200) the dispenser holding part (61) is separate to a shaft (27) for rotating the collection sheet (15) or the housing (12) around the rotation axis (RAX).

35. The method according to any of the preceding items, wherein said height (H2) of the guidance space (13) is at least provided at the entrance (13a) for the collection hole (15) from the spacer storage compartment (11) to the guidance space (13), such as wherein the height (H2) is defined between an edge (28) of the housing (12) at said entrance (13a) of the collection hole (15) and towards the surface (15b) of the collection sheet (15) facing the spacer storage compartment (11).

36. The method according to item 35, wherein the guidance space (13) at the collection hole entrance (13a) to the guidance space (13) from the spacer storage compartment (11) which is less than 1.4 times the spacer height (H1), and wherein the height (H2) of the guidance space (13) is smaller than the spacer width (W1).

37. The method according to any of the preceding items, wherein the spacers (2) are dispensed by the dispenser (10) while the relative humidity of the ambient air surrounding the dispenser (10) is controlled (300) to be above 40%, such as above 50%, for example between 40% and 70%.

38. The method according to any of the preceding items, wherein said housing (12) and the collection sheet (15) are made from metal, wherein the dispenser (10), such as the housing (12) and/or collection sheet (15), is/are connected to ground by means of a grounding connection (70).

39. The method according to any of the preceding items, wherein a charge modulation system (400, 300, 70, 72, 73) reduces and/or maintains a difference in electrostatic charge potential between the glass sheet (3) and the dispensing system (200), such as between the between the glass sheet (3) and the dispenser (10) to be below 10 kV, such as below 5kV, such as below 2 kV.

40. The method according to any of the preceding items, wherein the dispenser (10) comprises a sensor system comprising one or more sensors (22, 23), such as one or more optical sensors, configured to detect if a collected spacer (2) is present in the collection hole, and wherein the sensor system provides one or more sensor outputs (22a, 23a) comprising information of if a collected spacer (2) is present in the collection hole (15a).

41. The method according to any of the preceding items, wherein a charge modulation system (400, 300, 70,72, 73) comprises one or more of:
A grounding connection (70, 71, 72)
One or more ionizer devices (400), such as one or more ionizer bars providing a flow of ions with controlled polarity towards the dispensing system (200) such as towards the dispenser(s) (10), and/or towards the glass sheet (3).
A humidity control system (300) maintaining the relative humidity of the ambient air surrounding the dispenser (10) above 40%, such as above 50%, for example between 40% and 70%,
   wherein the charge modulation system (200, 300, 70,72, 73) reduces and/or maintains a difference in electrostatic charge potential between the glass sheet (3) and the dispensing system (200), such as between the between the glass sheet (3) and the dispenser (10)

42. The method according to any of the preceding items, wherein said predefined, pre-shaped contact surfaces (2a, 2b) are flat, such as plane.

43. The method according to any of the preceding items, wherein said opposite flat contact surfaces (2a, 2b) has a surface shape, such as a surface roughness, that varies less than ±30 micron, such as less than ±10 micron of the spacer height (H1) relative to a mean line or mean plane (P1) defined by the respective contact surface (2a, 2b).

44. The method according to any of the preceding items, wherein a displacement motor (8) provides a relative movement (MOV1) between the glass sheet surface (3a) and the spacer outlet (16) in a direction along the glass sheet surface (3a).

45. The method according to any of the preceding items, wherein the dispensing of spacers (2) comprises providing a spacer placement sequence to place a plurality of spacers at the major glass sheet surface (3a) by means of the dispenser (10), wherein the spacer placement sequence comprises providing relative movement between the glass sheet surface (3a) and the spacer outlet (16) in a direction along the glass sheet surface by means of a displacement motor (80), and distributing a plurality of spacers (2) from the spacer storage (11) with a mutual spacer distance (DIS4) on the glass sheet surface (3a) by means of the dispenser (10) through the spacer outlet (16).

46. The method according to any of the preceding items, such as item 44 or 45, wherein a distance controller (31) controls a distance adjustment motor (30) to move the spacer outlet (16) towards and/or away from the glass sheet surface (3a) during the spacer placement sequence based on output (32a) from a distance sensor (32),
and/or
wherein the distance sensor (32) is attached to, such as arranged in, the housing (12) of the dispenser (10).

47. The method according to item 45 or 46, wherein the distance controller (31) controls the distance (DIS1) between the glass sheet surface (3a) and the spacer outlet (16) to be less than a spacer height (H1) of the spacers (2), at least while the spacers (2) are delivered to, such as dropped onto, the glass sheet surface (3a) by the dispenser.

48. The method according to any of the preceding items, wherein the distance controller (31) monitors a distance representative of a distance (DIS1) between the glass sheet surface (3a) and the spacer outlet (16) based on the output (32a) from the distance sensor (32) and a distance setting (DSE) during the spacer placement sequence, and controls the distance adjustment motor (30) based thereon during the spacer placement sequence.

49. The method according to any of the preceding items, wherein the spacers (2) in the spacer storage compartment (11) are randomly intermixed and/or randomly orientated.

50. The method according to any of the preceding items, wherein a spacer dispensing array (500) comprises a plurality of said spacer dispensing system (200), wherein a distance controller (31) provides an adjustment, such as an individual adjustment, of the spacer outlet (16) of the respective spacer dispensing system (200) of the dispensing array (500) in a direction towards and/or away from the glass sheet surface (3a) based on output (32) from a plurality of distance sensors (32) during the spacer placement sequence, such as by moving the dispenser housing (12) towards and/or away from the glass sheet surface.

51. The method according to any of the preceding items, wherein a spacer dispensing array (500) comprises a plurality of said dispensers (10), such as a plurality of said spacer dispensing system (200).

52. The method according to item 50 or 51, wherein the spacer outlets (16) of the dispensers (10) of the array (500) are distributed in a direction transverse to a direction of movement (MOV1) between the glass sheet (3) and the spacer dispensing array (500) along the glass sheet surface provided by a displacement motor along the glass sheet surface (3a).

53. The method according to any of the preceding items, wherein one or more dispensers (10) of the array (500) are displaced horizontally (MOV2) relative to one or more adjacent dispenser(s) (10) of the array (500) by means of a displacer (91, 92), such as in a direction transverse to the direction of the first movement (MOV1).

54. The method according to any of the preceding items, wherein the collection sheet (15) provides a bottom part of a spacer storage compartment (11) of the dispenser.

55. The method according to any of the preceding items, wherein the spacers (2) in the spacer storage compartment comprises predefined, pre-shaped contact surfaces (2a, 2b).

56. The method according to any of the preceding items, wherein the spacers (2) comprises opposing, plane, such as flat, contact surfaces (2a, 2b).

57. The method according to any of the preceding items, wherein the collection hole (15a) is a through hole.

58. The method according to any of the preceding items, wherein each of the plurality of spacers (2) in the spacer storage compartment (11) has a spacer height (H1) extending between the contact surfaces (2a, 2b) and wherein each of said spacers (2) has a spacer width (W1), wherein the guidance space (13) has a height (H2) which is less than 1.4 times the spacer height (H1), and/or wherein the height (H2) of the guidance space (13) is smaller than the spacer width (W1).

59. The method according to any of the preceding items, wherein the glass sheet(s) (3,4) is/are a thermally tempered glass sheet(3), for example a thermally tempered glass sheet, comprising a glass sheet surface (3a) unevenness of at least 0.1 mm, such as at least 0.2 mm, for example at least 0.3 mm.

60. The method according to any of the preceding items, wherein one or more magnets (89) attract a spacer (2) into the collection hole (15a) from the spacer storage compartment (11), such as wherein the dispenser comprises the one or more magnets (89), and where the collection sheet (15) is placed between the one or more magnets and the spacer storage compartment (11).

61. The method according to any of the preceding items, wherein a spacer maintaining arrangement (85) comprising one or more magnets maintains the dispensed spacer (2) in position at the glass sheet surface (3a), such as wherein the one or more magnets of the spacer maintaining arrangement (85) is arranged opposite to the major surface of the glass sheet (3) facing away from the dispenser (10) so that the glass sheet is placed between the spacer outlet (16) and the magnet (85).

62. Use according to any of the preceding items, wherein the collection sheet (15) is disc shaped.

63. Use of a dispenser (10) for dispensing spacers (2) comprising opposing, predefined contact surfaces (2a, 2b) on a surface (3a) of a glass sheet (3) during manufacturing of a vacuum insulating glass unit, wherein the dispenser (10) comprises:
a spacer storage compartment (11) comprising a plurality of said spacers (2),
a housing (12) comprising a guidance space (13) placed between a first housing surface (17a) of an upper part (12a) of the housing (12) and a second housing surface (17b) of a bottom part (12b) of the housing (12),
a spacer outlet (16) arranged at the bottom part (12b) of the housing (12),
a collection sheet (15) providing a bottom part of the spacer storage compartment (11), wherein the collection sheet (15) comprises at least one collection hole (15a) extending between opposing major surfaces (15b, 15c) of the collection sheet (15), wherein the collection hole (15a) is a through hole and wherein the collection sheet (15) is arranged in the guidance space (13),
   wherein a relative rotational movement between the collection sheet (15) and the housing (12) around a rotation axis (RAX) is configured to be provided, such as by means of a shaft, so that the collection hole (15a) is arranged at the bottom of the spacer storage compartment (11) and thereby collects a spacer (2) from the bottom of the spacer storage compartment (11), and
   wherein a further, relative rotational movement between the collection sheet (15) and the housing (12) around the rotation axis (RAX) is configured to be provided to align the collected spacer (2) in the collection hole (15a) opposite to the spacer outlet (16).

64. Use according to item 63, wherein each of the plurality of spacers (2) in the spacer storage compartment (11) has a spacer height (H1) extending between the contact surfaces (2a, 2b) and wherein each of said spacers (2) has a spacer width (W1), wherein the guidance space (13) has a height (H2) which is less than 1.4 times the spacer height (H1), and wherein the height (H2) of the guidance space (13) is smaller than the spacer width (W1).

65. Use according to item 63 or 64, wherein the collection sheet is disc shaped.

66. Use according to any of items 63 or 65, wherein said dispenser 10 is used so as to provide the method of any of items 1-62.

67. A dispenser (10) for dispensing spacers (2) on a surface (3a) of a glass sheet (3) during manufacturing of a vacuum insulating glass unit, wherein the dispenser (10) comprises:
a spacer storage compartment (11) for storing a plurality of said spacers (2),
a housing (12) comprising a guidance space (13) placed between a first housing surface (17a) of an upper part (12a) of the housing (12) and a second housing surface (17b) of a bottom part (12b) of the housing (12),
a spacer outlet (16) arranged at the bottom part (12b) of the housing (12),
a collection sheet (15) providing a bottom part of the spacer storage compartment (11), wherein the collection sheet (15) comprises at least one collection hole (15a) extending between opposing major surfaces (15b, 15c) of the collection sheet (15), wherein the collection hole (15a) is a through hole and wherein the collection sheet (15) is arranged in the guidance space (13),
   wherein the collection sheet (15) and the housing (12) is/are configured to be rotated relative to each other around a rotation axis (RAX), such as by means of a shaft, so that the collection hole (15a) is arranged at the bottom of the spacer storage compartment (11, and
   wherein a further, relative rotational movement between the collection sheet (15) and the housing (12) around the rotation axis (RAX) is configured to be provided to align the collection hole (15a) opposite to the spacer outlet (16).

68. A dispenser (10) according to item 67, wherein the spacers (2) comprises opposing, predefined contact surfaces (2a, 2b).

69. A dispenser (10) according to item 67 or 68, wherein each of the plurality of spacers (2) in the spacer storage compartment (11) has a spacer height (H1) extending between the contact surfaces (2a, 2b) and wherein each of said spacers (2) has a spacer width (W1), wherein the guidance space (13) has a height (H2) which is less than 1.4 times the spacer height (H1), and wherein the height (H2) of the guidance space (13) is smaller than the spacer width (W1).

70. A dispenser (10) according to any of items 67-69, wherein the collection sheet (15) is disc shaped.

71. A dispenser (10) according to any of items 67-70, wherein the collection sheet (15) has an outer maximum width, such as a disc diameter (D1), and wherein the housing (12) has a width (D2), such as a diameter, that is larger than the disc diameter (D1).

72. A dispenser (10) according to any of items 67-71, wherein the collection sheet (15) comprises a first major surface (15b) and an oppositely directed second major surface(15c), wherein the second housing surface (17b) covers at least 90%, such as at least 98% of the surface area of the second major surface (15c).

73. A dispenser (10) according to any of items 67-72, wherein the collection sheet (15) comprises a first major surface (15b) and an oppositely directed second major surface(15c), wherein the first housing surface (17a) covers at least 40%, such as at least 60%, such as at least 75% of the surface area of the first major surface (15b) of the collection sheet (15).

74. A dispenser (10) according to any of items 67-73, wherein one or more side wall surfaces (1la, 11b) enclosing the spacer storage compartment (11) narrows in a direction towards the collection sheet (15), such as wherein at least a part of the spacer storage compartment (11) is funnel shaped.

75. A dispenser (10) according to any of items 67-74, wherein the length of a traveling path (TPS) of the collection hole (15a) at the bottom of the spacer storage compartment (11) is at least 0.9 times, such as at least 1.2 times, such as at least 1.8 times, the distance (DIS2) between the rotation axis (RAX) and the outer periphery of the dispenser housing (12).

76. A dispenser (10) according to any of items 67-75, wherein the spacer storage compartment (11) is elongated and extends partly around the rotation axis (RAX), such as wherein the spacer storage compartment (11) is arc shaped.

77. A dispenser (10) according to any of items 67-76, wherein the rotational movement (a2) around the rotation axis (RAX) from the spacer storage compartment (11) so as to align the collected spacer (2) in the collection hole (15a) opposite to the spacer outlet (16) is at least 85°, such as at least at least 120°, for example at least 170°.

78. A dispenser (10) according to any of items 67-77, wherein the dispenser is for use in a method according to any of the preceding items.

79. A dispenser (10) according to any of items 67-78, wherein the housing (12) of the dispenser (10) is releasably attached to a dispenser holding part (61) of a dispenser system (200) by means of a locking system (60), such as a spring (65) loaded locking system, and wherein the locking system (60) comprises an actuation member (64) to be operated to actuate the locking system (60), such as wherein the locking system (60) is configured for tool-less mounting and dismounting of the dispenser (10).

80. A dispenser (10) according to any of items 67-79, wherein the dispenser (10) comprises a sensor system comprising one or more sensors (22, 23), such as one or more optical sensors, configured to detect if a collected spacer (2) is present in the collection hole, and wherein the sensor system provides one or more sensor outputs (22a, 23a) comprising information of if a collected spacer (2) is present in the collection hole (15a).

81. A dispenser (10) according to any of items 67-80, wherein the housing (12) encloses at least 80% such as at least 95 % of the outer boundary (15d), such as periphery, of the collection sheet (15) by means of a wall (19) part, such as an annular wall part, arranged opposite to the outer boundary (15d) of the collection sheet (15).

82. A dispenser (10) according to any of items 67-81, wherein the housing (12) fully encloses the outer boundary (15d), such as periphery, of the collection sheet (15) by means of a wall (19) part, such as an annular wall part, arranged opposite to the outer boundary of the collection sheet (15) such as disc shaped collection sheet.

83. A dispenser (10) according to any of items 67-82, wherein the dispenser is used in a method according to any if items 1-62.

84. Use of a dispenser according to any of items 67-83 for dispensing, such as individually dispensing, a plurality of spacers on a major glass sheet surface, wherein said spacers (2) are collected one by one from the spacer storage compartment (11).

85. Use of a dispenser according to any of items 67-83, wherein the spacers in the spacer storage compartment (11) are randomly intermixed and/or randomly orientated.

86. Use of a dispenser according to any of items 67-83, wherein the spacers in the spacer storage compartment (11) comprises pre-shaped contact surfaces (2a, 2b), such as substantially plane contact surfaces,

87. Use of a dispenser according to any of items 67-83, wherein the spacers in the spacer storage compartment (11) have a spacer width (W1) that is larger than the spacer height (H1).

88. Use of a dispenser according to any of items 67-83, wherein the dispenser collects a spacer from the spacer storage compartment (11) one by one and brings it into a predefined orientation prior to dispensing the spacer through the spacer outlet (16).

89. A method according to any of items 1-61, wherein spacers (2) are individually collected from the spacer storage compartment (11) by means of the collection hole and brought into a predefined orientation prior to dispensing the spacer through the spacer outlet (16).

In general, it is to be understood that the present disclosure is not limited to the particular examples described above but may be adapted in a multitude of varieties within the scope of the present disclosure as specified in e.g. the claims and/or items. Accordingly, for example, one or more of the described and/or illustrated embodiments above may be combined to provide further embodiments of the present disclosure.

1. A method of manufacturing a vacuum insulating glass unit, the method comprising:
providing a first glass sheet,
dispensing a plurality of spacers comprising predefined, pre-shaped contact surfaces on a major surface of the provided glass sheet by means of a dispenser of a spacer dispensing system, wherein the dispenser comprises:
a spacer storage compartment comprising a plurality of said spacers, a housing comprising a guidance space placed between a first housing surface of an upper part of the housing and a second housing surface of a bottom part of the housing,
a spacer outlet arranged at the bottom part of the housing,
a collection sheet providing a bottom part of the spacer storage compartment, wherein the collection sheet comprises at least one collection hole extending between opposing major surfaces of the collection sheet, wherein the collection hole is a through hole and wherein the collection sheet is arranged in the guidance space
wherein the dispensing of spacers comprises:
providing a relative, rotational movement between the collection sheet and the housing around a rotation axis by means of a drive motor so that the collection hole is arranged at the bottom of the spacer storage compartment and thereby collects a spacer from the bottom of the spacer storage compartment,
providing a further, relative rotational movement between the collection sheet and the housing around the rotation axis to align the collected spacer in the collection hole opposite to the spacer outlet to deliver the collected spacer to the spacer outlet and towards the major surface of the glass sheet,
wherein each of the plurality of spacers in the spacer storage compartment has a spacer height extending between the contact surfaces and wherein each of said spacers has a spacer width wherein the guidance space has a height which is less than 1.4 times the spacer height, and wherein the height of the guidance space is smaller than the spacer width,
the method further comprising providing a second glass sheet,
sealing together the first glass sheet and the provided second glass sheet at the periphery of the glass sheets with the plurality of dispensed spacers arranged between major surfaces of the glass sheets so that a gap is provided between the first and second glass sheets, and
evacuating the gap.

2. The method according to claim 1, wherein the collection sheet comprises an upwardly facing first major surface and a downwardly facing, oppositely directed second major surface, wherein the second housing surface covers at least 90%, of the surface area of the second major surface, and
wherein the first housing surface covers at least 40%, of the surface area of the first major surface of the collection sheet.

3. The method according to claim 1, claims, wherein the collection sheet has an outer maximum disc diameter, and wherein the housing has a width, that is larger than the disc diameter.

4.-5. (canceled)

6. The method according to claim 1, wherein the dispenser comprises a sensor system comprising one or more sensors configured to detect if a collected spacer is present in the collection hole and wherein the sensor system provides one or more sensor outputs comprising information of if a collected spacer is present in the collection hole.

7.-14. (canceled)

15. The method according to claim 1, wherein the spacers are dispensed by the dispenser while the relative humidity of the ambient air surrounding the dispenser is controlled to be above 40%.

16. The method according to claim 1, wherein said housing and the collection sheet are made from metal, wherein the housing and collection sheet are connected to ground by means of a grounding connection.

17. The method according to claim 1, wherein said predefined, pre-shaped contact surfaces are flat,
and
wherein the spacer width is larger than the spacer height.

18. (canceled)

19. The method according to claim 1, wherein the collection sheet is disc shaped.

20. The method according to claim 1, wherein a spacer dispensing array comprises a plurality of said dispensers.

21.-24. (canceled)

25. The method according to claim 1, wherein said height of the guidance space is at least provided at the entrance for the collection hole from the spacer storage compartment to the guidance space.

26. The method according to claim 1, wherein the height of the guidance space is defined between an edge of the housing at said entrance of the collection hole and towards the surface of the collection sheet facing the spacer storage compartment.

27. (canceled)

28. The method according to claim 1, wherein the height of the guidance space at the collection hole entrance is smaller than the spacer width.

29. The method according to claim 1, wherein the dispenser comprises a fluid outlet for pressurized gas, wherein the pressurized gas is provided in order to provide a blowing force onto the collected spacer in the collection hole to help the collected spacer leave the collection hole.

30. (canceled)

31. The method according to claim 1, wherein the spacers in the spacer storage compartment are randomly orientated.

32. The method according to claim 1, wherein the thickness of the collection sheet is within ±15% of the spacer height.

33.-34. (canceled)

35. Use of a dispenser for dispensing spacers comprising opposing, predefined contact surfaces on a surface of a glass sheet during manufacturing of a vacuum insulating glass unit, wherein the dispenser comprises:
a spacer storage compartment comprising a plurality of said spacers,
a housing comprising a guidance space placed between a first housing surface of an upper part of the housing and a second housing surface of a bottom part of the housing,
a spacer outlet arranged at the bottom part of the housing,
a collection sheet providing a bottom part of the spacer storage compartment, wherein the collection sheet comprises at least one collection hole extending between opposing major surfaces of the collection sheet, wherein the collection hole is a through hole and wherein the collection sheet is arranged in the guidance space
wherein a relative rotational movement between the collection sheet and the housing is configured to be provided around a rotation axis, so that the collection hole is arranged at the bottom of the spacer storage compartment and thereby collects a spacer from the bottom of the spacer storage compartment, and
wherein a further, relative rotational movement between the collection sheet and the housing around the rotation axis is configured to be provided to align the collected spacer in the collection hole opposite to the spacer outlet and wherein the collection sheet is disc shaped.

36.-42. (canceled)

43. Use according to of claim 35, wherein the housing encloses at least 80% of the outer boundary of the collection sheet by means of a wall part, arranged opposite to the outer boundary of the collection sheet, and wherein the housing fully encloses the outer periphery of the collection sheet.

44. (canceled)

45. Use according to claim 35, wherein the dispenser is used in a method according to claim 1.

46. A dispenser for dispensing spacers on a surface of a glass sheet during manufacturing of a vacuum insulating glass unit, wherein the dispenser comprises:
a spacer storage compartment for storing a plurality of said spacers,
a housing comprising a guidance space placed between a first housing surface of an upper part of the housing and a second housing surface of a bottom part of the housing,
a spacer outlet arranged at the bottom part of the housing,
a collection sheet providing a bottom part of the spacer storage compartment, wherein the collection sheet comprises at least one collection hole extending between opposing major surfaces of the collection sheet, wherein the collection hole is a through hole and wherein the collection sheet is arranged in the guidance space,
wherein the collection sheet and the housing is/are configured to be rotated relative to each other around a rotation axis, so that the collection hole is arranged at the bottom of the spacer storage compartment, and
wherein a further, relative rotational movement between the collection sheet and the housing around the rotation axis is configured to be provided to align the collection hole opposite to the spacer outlet, and
wherein the housing encloses at least 80% of the outer boundary of the collection sheet by means of a wall part arranged opposite to the outer boundary of the collection sheet.

47. The dispenser according to claim 46, wherein the housing fully encloses the outer boundary of the collection sheet by means of a wall part arranged opposite to the outer boundary of the collection sheet.
